(19) United States
(12) Patent Application Publication
(10) Pub. No.: US 2018/0240130 A1
(43) Pub. Date: Aug. 23, 2018

(54) SYSTEM, INFORMATION MANAGEMENT METHOD, AND INFORMATION PROCESSING APPARATUS

(71) Applicants: Kazunori TAKATSU, Kanagawa (JP); Kazunori SUGIMURA, Kanagawa (JP); Minami OGAWA, Tokyo (JP)

(72) Inventors: Kazunori TAKATSU, Kanagawa (JP); Kazunori SUGIMURA, Kanagawa (JP); Minami OGAWA, Tokyo (JP)

(73) Assignee: Ricoh Company, Ltd., Tokyo (JP)

(21) Appl. No.: 15/962,389

(22) Filed: Apr. 25, 2018

Related U.S. Application Data
(63) Continuation of application No. 14/061,846, filed on Oct. 24, 2013.

(30) Foreign Application Priority Data
Oct. 31, 2012 (JP) 2012-240771
Oct. 31, 2012 (JP) 2012-240772
Oct. 31, 2012 (JP) 2012-240773

(51) Int. Cl. G06Q 30/00

(52) U.S. Cl. CPC G06Q 30/018

(57) ABSTRACT

A system includes a service providing system that provides a service to be linked with an apparatus; and a license information issuance system that issues and manages license information not associated with any service subscriber. The service providing system includes a first registration unit that receives an organization registration request including first license information from a terminal device operated by a user of an organization, and registers the organization and the user when the first license information in the organization registration request is not associated with any service subscriber; and a second registration unit that receives a service registration request including second license information from the terminal device operated by the registered user, and registers a service corresponding to the second license information to allow the organization to use the service, when the second license information in the service registration request is not associated with any service subscriber.

### CROSS-REFERENCE TO RELATED APPLICATIONS

The present application is a continuation application of U.S. patent application Ser. No. 14/061,846 filed on Oct. 24, 2013, and is based upon and claims the benefit of priority of Japanese Patent Application No. 2012-240771 filed on Oct. 31, 2012, Japanese Patent Application No. 2012-240772 filed on Oct. 31, 2012, and Japanese Patent Application No. 2012-240773 filed on Oct. 31, 2012, the entire contents of which are incorporated herein by reference.

### BACKGROUND OF THE INVENTION

### 1. Field of the Invention

An aspect of this disclosure relates to a system, an information management method, and an information processing apparatus.

### 2. Description of the Related Art

Japanese Laid-Open Patent Publication No. 2009-230422, for example, discloses a license file issuing apparatus, an image processing apparatus, a license file issuing method, and an application install method that make it possible to customize an application for each user by using a license of the application.

The license file issuing apparatus includes a reception unit that receives a license file issuance request, and a license file issuing unit that, in response to the license file issuance request, issues a license file including license information of an application of the image processing apparatus and customization information related to customization of the application.

The image processing apparatus includes a reception unit that receives the license file, an extracting unit that extracts the license information and the customization information from the license file, and an installation unit that installs the application based on the extracted license information and customization information.

In recent years, a type of system, where an apparatus such as a multi-function peripheral is linked with a Web application or a server application such as a cloud service, has been the subject of attention. It is becoming more and more important to efficiently provide such type of system.

Generally, a contract for a service to be linked with an apparatus is made between a sales company of an apparatus and a user when the apparatus is sold to the user. In other words, a contract for a service to be linked with an apparatus is made via a sales channel of the apparatus.

However, a business operation system of a sales company is generally not linked with a service providing system that provides services. For this reason, it is not easy for the service providing system to obtain information regarding a contract made by the sales company with the user. Here, it is not practical to make a person at the sales company register the information regarding the contract in the service providing system.

Thus, with related-art technologies, it is difficult to register, in a service providing system, information necessary to provide a service to a user (e.g., information regarding a contract made by a sales company with a user).

Another aspect of this disclosure relates to an information processing apparatus, a system, and an information registration method.

Japanese Laid-Open Patent Publication No. 2006-79598, for example, discloses an access control system that determines whether an access request is made by an authorized user.

In the related-art access control system, a service center generates an access URL including an access-authorized user address, a resource identifier, and a valid condition that are encrypted using a key. When an access request with the access URL is received from a user, the service center determines whether the valid condition included in the access URL is satisfied. When the valid condition is satisfied, the service center sends a password to the access-authorized user address included in the access URL.

The service center receives a password entered by the user, and determines whether the entered password matches the password sent to the access-authorized user address. When the entered password matches the password sent to the access-authorized user address, the service center allows access to a resource identified by the resource identifier included in the access URL.

In recent years, it has been a popular trend to use a server on a public network instead of a server on a private network such as an office network. For example, cloud services have become widely used.

It is becoming more and more important to efficiently and globally provide such services on a public network. Here, a contract for a service to be linked with an apparatus is generally made between a sales company of the apparatus and a user when the apparatus is sold to the user. Also, a sales company generally supports a user to introduce a contracted service. However, because different methods and procedures are used in different countries and regions to sell apparatuses and support users to introduce services, it is difficult to efficiently provide global services.

Another aspect of this disclosure relates to an information processing apparatus, a system, and an information providing method.

Japanese Laid-Open Patent Publication No. 2005-135369, for example, discloses a method for displaying a character string in various natural languages, i.e., a method for localization.

Japanese Laid-Open Patent Publication No. 2005-135369 also discloses a processing apparatus that makes it possible to easily and flexibly perform localization. The processing apparatus includes a resource acquisition unit that selects a first resource data group for each program component from one or more first resource data groups stored in a storage unit based on first resource information set for the program component, and obtains resource data from the selected first resource data group based on the first resource information; and a resource reproduction unit that reproduces the obtained resource data for the program component.

In the related-art processing apparatus, the first resource data groups are separated from application programs so that the first resource data groups can be easily edited even by a normal user, who is not a developer, without using a development environment.

Japanese Laid-Open Patent Publication No. 2005-258690, for example, discloses a technology that enables an information processing apparatus such as a personal computer to obtain, from a peripheral device such as a network device, information expressed in a language used in the information processing apparatus by using a common template regardless of what language is used in the information processing apparatus.

In recent years, it has been a popular trend to use a server on a public network instead of a server on a private network such as an office network. For example, cloud services have become widely used. It is becoming more and more important to globally provide such services on a public network.

However, because desired services vary depending on countries, contracts and introduction of services have to be done individually by, for example, sales companies of apparatuses. For this reason, it is difficult to efficiently and globally provide services.

### SUMMARY OF THE INVENTION

In an aspect of this disclosure, there is provided a system including a service providing system that provides a service to be linked with an apparatus, and a license information issuance system that issues and manages license information not associated with any service subscriber. The service providing system includes a first registration unit that receives an organization registration request including first license information from a terminal device operated by a user of an organization, and registers the organization and the user when the first license information in the organization registration request is not associated with any service subscriber; and a second registration unit that receives a service registration request including second license information from the terminal device operated by the registered user, and registers a service corresponding to the second license information to allow the organization to use the service, when the second license information in the service registration request is not associated with any service subscriber.

### BRIEF DESCRIPTION OF THE DRAWINGS

FIG. 1 is a drawing illustrating an exemplary configuration of a system;

FIG. 2 is a block diagram illustrating an exemplary hardware configuration of a computer system;

FIG. 3 is a block diagram illustrating an exemplary functional configuration of a terminal device;

FIG. 4 is a block diagram illustrating an exemplary functional configuration of a service providing system;

FIG. 5 is a table illustrating exemplary organization management information;

FIG. 6 is a table illustrating exemplary user management information;

FIGS. 7A and 7B are tables illustrating exemplary license management information;

FIG. 8 is a table illustrating exemplary service management information;

FIG. 9 is a block diagram illustrating an exemplary functional configuration of a portal service application;

FIG. 10 is a table illustrating exemplary URL information;

FIG. 11 is a flowchart illustrating an exemplary process performed by a system;

FIG. 12 is a sequence chart illustrating details of step S1 in FIG. 11;

FIG. 13 is a sequence chart (1/4) illustrating details of step S3 in FIG. 11;

FIG. 14 is a drawing illustrating an exemplary top screen;

FIG. 15 is a drawing illustrating an exemplary terms-of-service screen;

FIG. 16 is a drawing illustrating an exemplary initial registration screen;

FIG. 17 is a drawing illustrating an exemplary initial registration confirmation screen;

FIG. 18 is a sequence chart (2/4) illustrating details of step S3 in FIG. 11;

FIG. 19 is a drawing illustrating an exemplary email transmission confirmation screen;

FIG. 20 is a sequence chart (3/4) illustrating details of step S3 in FIG. 11;

FIG. 21 is a drawing illustrating an exemplary organization registration screen;

FIG. 22 is a drawing illustrating an exemplary organization registration confirmation screen;

FIG. 23 is a sequence chart (4/4) illustrating details of step S3 in FIG. 11;

FIG. 24 is a drawing illustrating an exemplary organization registration completion screen;

FIG. 25 is a sequence chart (1/2) illustrating details of step S4 in FIG. 11;

FIG. 26 is a drawing illustrating an exemplary contracted service registration screen;

FIG. 27 is a drawing illustrating an exemplary terms-of-service screen;

FIG. 28 is a sequence chart (2/2) illustrating details of step S4 in FIG. 11;

FIG. 29 is a drawing illustrating an exemplary configuration of a system;

FIG. 30 is a block diagram illustrating an exemplary hardware configuration of a computer system;

FIG. 31 is a block diagram illustrating an exemplary functional configuration of a terminal device;

FIG. 32 is a block diagram illustrating an exemplary functional configuration of a service providing system;

FIG. 33 is a table illustrating exemplary organization management information;

FIG. 34 is a table illustrating exemplary user management information;

FIG. 35 is a table illustrating exemplary license management information;

FIG. 36 is a block diagram illustrating an exemplary functional configuration of a portal service application;

FIG. 37 is a table illustrating exemplary URL information;

FIG. 38 is a flowchart illustrating an exemplary process performed by a system;

FIG. 39 is a sequence chart (1/4) illustrating details of the process of FIG. 38;

FIG. 40 is a drawing illustrating an exemplary top screen;

FIG. 41 is a drawing illustrating an exemplary terms-of-service screen;

FIG. 42 is a drawing illustrating an exemplary initial registration screen;

FIG. 43 is a drawing illustrating an exemplary initial registration confirmation screen;

FIG. 44 is a sequence chart (2/4) illustrating details of the process of FIG. 38;

FIG. 45 is a drawing illustrating an exemplary email transmission confirmation screen;

FIG. 46 is a sequence chart (3/4) illustrating details of the process of FIG. 38;

FIG. 47 is a drawing illustrating an exemplary organization registration screen;

FIG. 48 is a drawing illustrating an exemplary organization registration confirmation screen;

FIG. 49 is a sequence chart (4/4) illustrating details of the process of FIG. 38;

FIG. 50 is a drawing illustrating an exemplary organization registration completion screen;

FIG. 51 is a drawing illustrating an exemplary configuration of a system;

FIG. 52 is a block diagram illustrating an exemplary hardware configuration of a computer system;

FIG. 53 is a block diagram illustrating an exemplary functional configuration of a terminal device;

FIG. 54 is a block diagram illustrating an exemplary functional configuration of a service providing system;

FIG. 55 is a table illustrating exemplary organization management information;

FIG. 56 is a table illustrating exemplary user management information;

FIG. 57 is a table illustrating exemplary license management information;

FIG. 58 is a table illustrating exemplary service management information;

FIG. 59 is a block diagram illustrating an exemplary functional configuration of a portal service application;

FIG. 60 is a sequence chart illustrating an exemplary process performed by a system;

FIG. 61 is a drawing illustrating an exemplary top screen;

FIG. 62 is a drawing illustrating an exemplary service list screen;

FIG. 63 is a drawing illustrating another exemplary service list screen;

FIG. 64 is a sequence chart illustrating another exemplary process performed by a system;

FIG. 65 is a drawing illustrating an exemplary contracted service update screen; and

FIG. 66 is a drawing illustrating an exemplary terms-of-service screen.

### DESCRIPTION OF THE PREFERRED EMBODIMENTS

Preferred embodiments of the present invention are described below with reference to the accompanying drawings.

### First Embodiment

### <System Configuration>

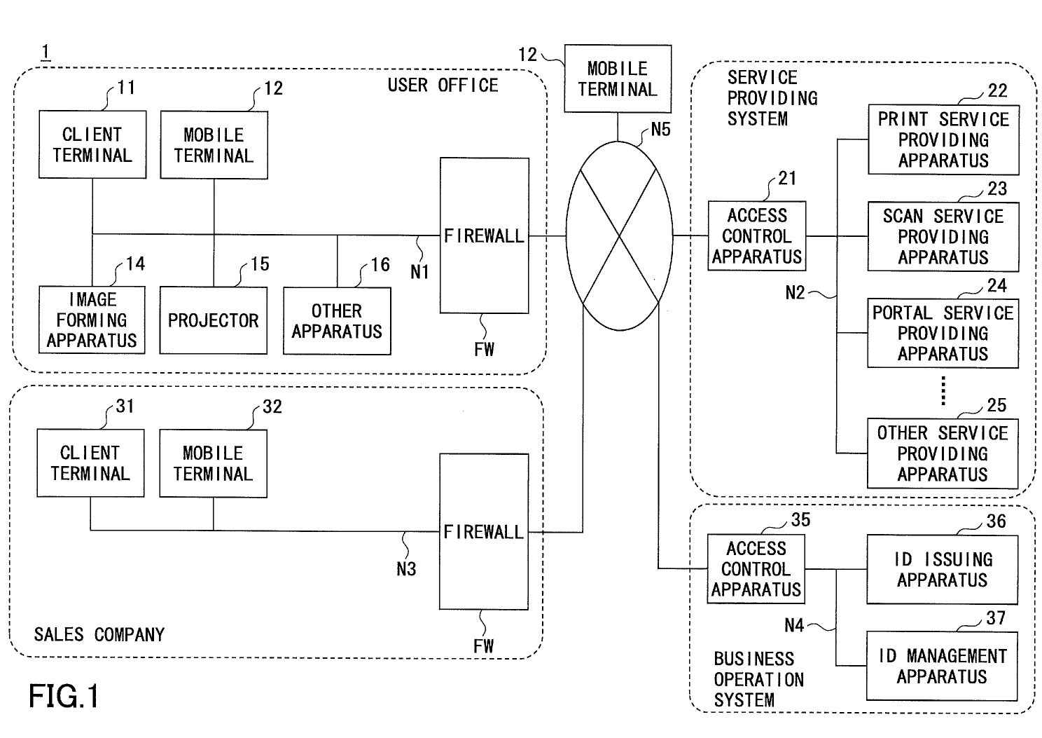

FIG. 1 is a drawing illustrating an exemplary configuration of a system 1 according to a first embodiment. As illustrated by FIG. 1, the system 1 may include a network N1 in a user office, a network N2 of a service providing system that provides, for example, cloud services, a network N3 in a sales company, a network N4 of a business operation system used by the sales company, for example, to manage contracts, and a network N5 such as the Internet.

The network N1 and the network N5 are connected to each other via a firewall FW provided for the network N1. The firewall FW is installed at a connecting point between the network N1 and the network N5 to detect and block unauthorized access.

The network N2 and the network N5 are connected to each other via an access control apparatus 21 provided for the network N2. The access control apparatus 21 maintains security of the network N2.

The network N3 and the network N5 are connected to each other via a firewall FW provided for the network N3. The firewall FW is installed at a connecting point between the network N3 and the network N5 to detect and block unauthorized access.

The network N4 and the network N5 are connected to each other via an access control apparatus 35 provided for the network N4. The access control apparatus 35 maintains security of the network N4.

The network N1 is a private network behind the firewall FW. A client terminal 11, a mobile terminal 12, an image forming apparatus 14 such as a multifunction peripheral, a projector 15, and an other apparatus 16 such as an electronic blackboard may be connected to the network N1.

The client terminal 11 is an example of a terminal device. The client terminal 11 may be implemented, for example, by an information processing apparatus (or a computer system) where a general-purpose operating system (OS) is installed. The client terminal 11 includes a wireless communication unit and/or a wired communication unit. Examples of the client terminal 11 include a tablet personal computer (PC) and a notebook PC that a user can operate.

The mobile terminal 12 is also an example of a terminal device. The mobile terminal 12 includes a wireless communication unit and/or a wired communication unit. Examples of the mobile terminal 12 include a smartphone, a cell phone, a tablet PC, and a notebook PC that a user can carry.

The image forming apparatus 14 may be any apparatus that includes an image forming function or performs an image forming process. The image forming apparatus 14 includes a wireless communication unit and/or a wired communication unit. Examples of the image forming apparatus 14 include a multifunction peripheral, a copier, a scanner, a printer, and a laser printer. The projector 15 projects an image. The projector 15 includes a wireless communication unit and/or a wired communication unit.

In the example of FIG. 1, one client terminal 11, one mobile terminal 12, one image forming apparatus 14, one projector 15, and one other apparatus 16 are connected to the network N1. However, two or more of each type of apparatus may be connected to the network N1.

The network N2 is connected via the access control apparatus 21 to the network N5 such as the Internet. The access control apparatus 21, a print service providing apparatus 22, a scan service providing apparatus 23, a portal service providing apparatus 24, and an other service providing apparatus 25 may be connected to the network N2. In the system 1 of FIG. 1, the access control apparatus 21, the print service providing apparatus 22, the scan service providing apparatus 23, the portal service providing apparatus 24, and the other service providing apparatus 25 constitute the service providing system.

The access control apparatus 21 controls processes for logging into services such as a print service provided by the print service providing apparatus 22, a scan service provided by the scan service providing apparatus 23, a portal service provided by the portal service providing apparatus 24, and a service provided by the other service providing apparatus 25.

The access control apparatus 21, the print service providing apparatus 22, the scan service providing apparatus 23, the portal service providing apparatus 24, and the other service providing apparatus 25 may be implemented by one or more information processing apparatuses (or computer systems).

In other words, the print service providing apparatus 22, the scan service providing apparatus 23, the portal service providing apparatus 24, and the other service providing apparatus 25 may be implemented by one computer or two or more computers.

A part of the services provided by the service providing system may be provided by an apparatus on a network other than the network N2. Also, one or more of the service providing apparatuses of the service providing system may be connected to a network other than the network N2. Two or more mobile terminals 12 may be present in the system 1, and one or more of the mobile terminals 12 may be connected to a network other than the network N1 in the user office. In the example of FIG. 1, one mobile terminal 12 is connected to the network N1 and one mobile terminal 12 is connected to the network N5 such as the Internet.

The network N3 is a private network behind the firewall FW. A client terminal 31 similar to the client terminal 11 and a mobile terminal 32 similar to the mobile terminal 12 may be connected to the network N3. In the example of FIG. 1, one client terminal 31 and one mobile terminal 32 are connected to the network N3. However, two or more client terminals 31 and two or more mobile terminals 32 may be connected to the network N3.

The network N4 is connected via the access control apparatus 35 to the network N5 such as the Internet. An ID issuing apparatus 36 and an ID management apparatus 37 may be connected to the network N4. In the system 1 of FIG. 1, the access control apparatus 35, the ID issuing apparatus 36, and the ID management apparatus 37 constitute the business operation system.

The access control apparatus 35 controls access, for example, from the client terminal 31 and the mobile terminal 32 of the sales company to the ID issuing apparatus 36 and the ID management apparatus 37. The ID issuing apparatus 36 issues organization IDs, registration codes, and service IDs in response to an issuance request. The ID management apparatus 37 manages the organization IDs, the registration codes, and the service IDs issued by the ID issuing apparatus 36.

The access control apparatus 35, the ID issuing apparatus 36, and the ID management apparatus 37 may be implemented by one or more information processing apparatuses (or computer systems). In other words, the access control apparatus 35, the ID issuing apparatus 36, and the ID management apparatus 37 may be implemented by one computer or two or more computers.

A part of the functions provided by the business operation system may be provided by an apparatus on a network other than the network N4. Two or more mobile terminals 32 may be present in the system 1, and one or more of the mobile terminals 32 may be connected to a network other than the network N3.

In the system 1 of FIG. 1, the ID issuing apparatus 36 of the business operation system issues, for example, organization IDs, registration codes, and service IDs for each country or region in response to an issuance request. The ID management apparatus 37 manages the organization IDs, the registration codes, and the service IDs as stock for each country or region.

The organization IDs and the registration codes being managed as stock are not yet associated with groups such as companies or departments. The organization IDs and the registration codes not associated with groups are used, for example, by administrators of groups, for which contracts are made, to register the groups (or organizations) at the portal service.

The service IDs being managed as stock are already associated with services such as the print service and the scan service, but are not yet associated with groups such as companies or departments. Multiple service IDs are issued for each service. The service IDs not associated with groups are used, for example, by administrators of groups, for which contracts are made, to activate (or validate) services.

When a contract is made with a group, a person at the sales company (an employee such as a sales person of the sales company) provides an organization ID, a registration code, and a service ID being managed as stock by the ID management apparatus 37 to an administrator of the group. Thus, in the system 1 of FIG. 1, organization IDs, registration codes, and service IDs are issued and managed as stock without being associated with groups, and are used for sales management at the business operation system of the sales company.

The administrator accesses a portal site of the service providing system, and enters the organization ID and the registration code provided by the sales company and an email address on the portal site. The service providing system determines whether the organization ID and the registration code entered by the administrator have been issued by the ID issuing apparatus 36 and are valid. When the organization ID and the registration code are valid, the service providing system sends, to the entered email address, a temporary URL (organization registration URL) that is used to continue a process.

When receiving the temporary URL, the administrator accesses the temporary URL and enters information such as an administrator account to register the group at the portal service. The organization ID and the registration code provided from the stock to the administrator are associated with a group such as a company or a department at this timing.

Thus, in the system 1 of FIG. 1, an organization ID and a registration code are provided from stock to an administrator of a group such as a company or a department, and are used by the administrator to register the group at the portal service. When the administrator registers the group at the portal service using the organization ID and the registration code, the organization ID and the registration code provided from the stock are associated with the group. Thus, the system 1 of FIG. 1 eliminates the need for a person at the sales company to associate organization IDs and registration codes provided from the stock with groups such as companies and departments.

The administrator then logs into the portal site with a generated account, and enters the service ID provided by the sales company. The service providing system determines whether the entered service ID has been issued by the ID issuing apparatus 36 and thereby determines whether the service ID is valid. When the service ID is valid, the service providing system activates a service associated with the service ID.

Thus, in the system 1 of FIG. 1, the administrator logs into the portal site and then activates a service using the service ID. This configuration makes it possible to associate the service ID provided from the stock with the organization ID associated with the group. The service providing system can also report, to the business operation system, association information indicating association among organization IDs, service IDs, and groups.

As described above, the system 1 of FIG. 1 provides a mechanism that allows an administrator (or a user) of a group, which has made a contract for a service(s) with a sales company, to register information necessary to use the service in a service providing system without requesting a person at the sales company to register the information. In other words, the system 1 of FIG. 1 makes it possible to easily register information necessary to use a service while using an existing sales channel and an existing business operation system.

### <Hardware Configuration>

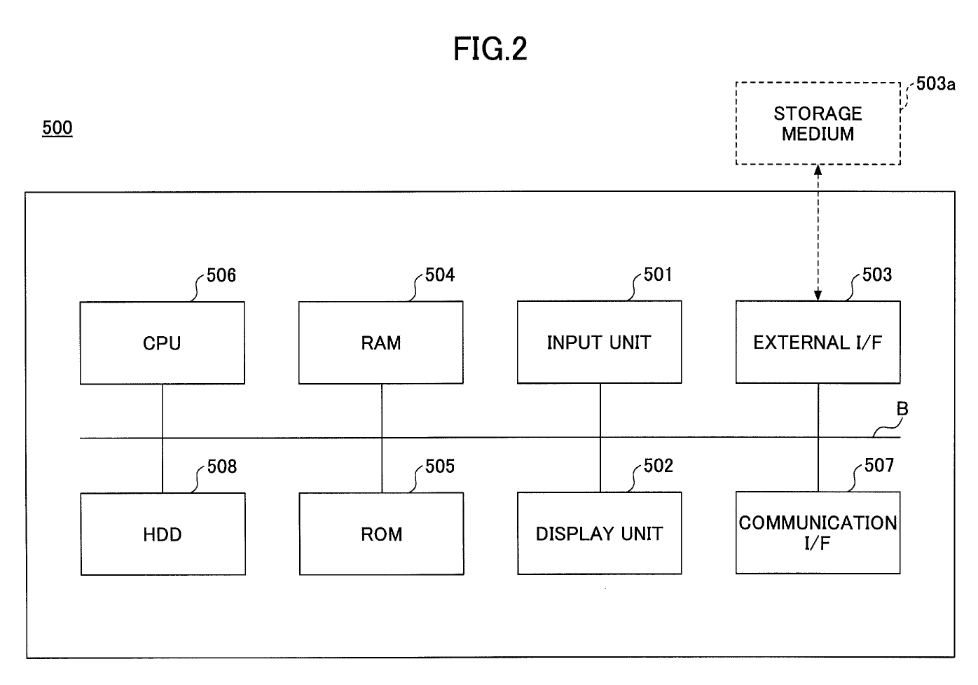

Each of the client terminal 11, the mobile terminal 12, the access control apparatus 21, the print service providing apparatus 22, the scan service providing apparatus 23, the portal service providing apparatus 24, and the other service providing apparatus 25 may be implemented by a computer system with a hardware configuration as described by FIG. 2. Also, each of the client terminal 31, the mobile terminal 32, the access control apparatus 35, the ID issuing apparatus 36, and the ID management apparatus 37 may be implemented by a computer system with a hardware configuration as described by FIG. 2.

FIG. 2 is a block diagram illustrating an exemplary hardware configuration of a computer system 500. As illustrated by FIG. 2, the computer system 500 may include an input unit 501, a display unit 502, an external I/F 503, a random access memory (RAM) 504, a read only memory (ROM) 505, a central processing unit (CPU) 506, a communication I/F 507, and a hard disk drive (HDD) 508 that are connected to each other via a bus B.

The input unit 501 includes, for example, a keyboard, a mouse, and a touch panel, and is used by a user to input instructions (or operation signals) to the computer system 500. The display unit 502 displays, for example, processing results of the computer system 500.

The communication I/F 507 is an interface for connecting the computer system 500 to one or more of the networks N1 through N5. The computer system 500 can perform data communications with other apparatuses via the communication I/F 507.

The HDD 508 is a non-volatile storage device for storing various programs and data. For example, the HDD 508 stores basic software or an operating system (OS) for controlling the entire computer system 500, and application software for providing various functions on the OS. The HDD 508 may manage the stored programs and data using a file system and/or a database (DB).

The external I/F 503 is an interface between the computer system 500 and an external device such as a storage medium 503a. The computer system 500 can read and write data from and to the storage medium 503a via the external I/F 503. The storage medium 503a may be implemented by, for example, a flexible disk, a compact disk (CD), a digital versatile disk (DVD), a secure digital (SD) memory card, or a universal serial bus (USB) memory.

The ROM 505 is a non-volatile semiconductor memory (storage unit) that can retain programs and data even when power is turned off. For example, the ROM 505 stores programs and data such as a basic input/output system (BIOS) that is executed when the computer system 500 is turned on, and system and network settings of the computer system 500. The RAM 504 is a volatile semiconductor memory (storage unit) for temporarily storing programs and data.

The CPU (processor) 506 loads programs and data from storage units (e.g., the HDD 508 and the ROM 505) into the RAM 504 and executes the loaded programs to control the computer system 500 and to implement various functional units of the computer system 500.

With the hardware configuration of the computer system 500, the client terminal 11, the mobile terminal 12, the access control apparatus 21, the print service providing apparatus 22, the scan service providing apparatus 23, the portal service providing apparatus 24, and the other service providing apparatus 25 can perform various processes described later. Also, the client terminal 31, the mobile terminal 32, the access control apparatus 35, the ID issuing apparatus 36, and the ID management apparatus 37 can perform various processes described later with the hardware configuration of the computer system 500.

### <Software Configuration>

### [Terminal Device]

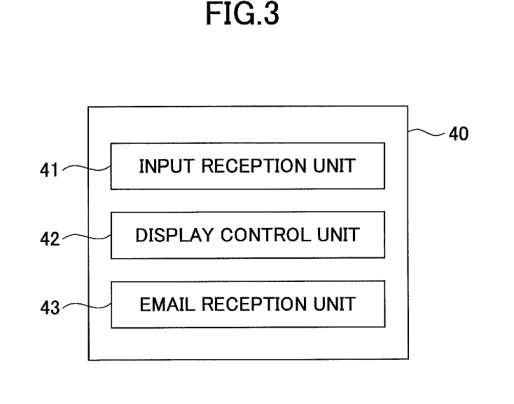

Each of terminal devices such as the client terminal 11, the mobile terminal 12, the client terminal 31, and the mobile terminal 32 may include functional units (or processing blocks) as described by FIG. 3. FIG. 3 is a block diagram illustrating an exemplary functional configuration of a terminal device 40.

The terminal device 40 executes a program(s) and thereby implements an input reception unit 41, a display control unit 42, and an email reception unit 43. The input reception unit 41 receives instructions and information from the user via the input unit 501. For example, the user enters instructions and information by touching the touch panel or operating the keyboard. The display control unit 42 controls display of information on the display unit 502. The email reception unit 43 receives email messages via the communication I/F 507.

### [Service Providing System]

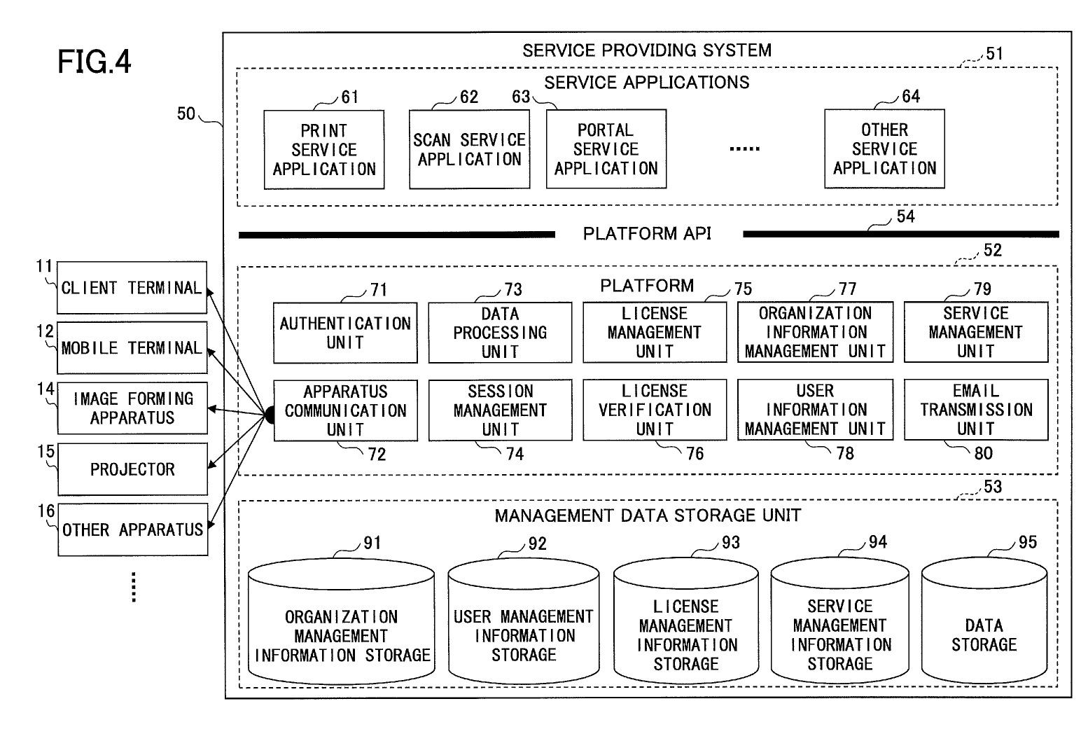

The service providing system of the first embodiment may include functional units (or processing blocks) as illustrated by FIG. 4. FIG. 4 is a block diagram illustrating an exemplary functional configuration of a service providing system 50. The service providing system 50 of FIG. 4 implements service applications 51, a platform 52, a management data storage unit 53, and a platform API (application programming interface) 54 by executing programs.

In the example of FIG. 4, the service applications 51 include a print service application 61, a scan service application 62, a portal service application 63, and one or more other service applications 64 (which are hereafter expressed in the singular form for brevity). The print service application 61 provides a print service. The scan service application 62 provides a scan service. The portal service application 63 provides a portal service. The other service application 64 provides any other service.

The platform API 54 is an interface that enables the service applications 51 such as the print service application 61, the scan service application 62, the portal service application 63, and the other service application 64 to use the platform 52. In other words, the platform API 54 is a predefined interface that enables the platform 52 to receive requests from the service applications 51, and may be implemented by functions or classes. When the service providing system 50 is implemented by (or distributed to) multiple information processing apparatuses, a Web API that is accessible via a network may be used as the platform API 154.

In the example of FIG. 4, the platform 52 includes an authentication unit 71, an apparatus communication unit 72, a data processing unit 73, a session management unit 74, a license management unit 75, a license verification unit 76, an organization information management unit 77, a user information management unit 78, a service management unit 79, and an email transmission unit 80.

The authentication unit 71 performs authentication in response to a login request from the business operation system and office equipment such as the client terminal 11. The “office equipment” is a generic term indicating any one of the client terminal 11, the mobile terminal 12, the image forming apparatus 14, the projector 15, and the other apparatus 16.

The apparatus communication unit 72 communicates with the office equipment and the business operation system. The data processing unit 73 performs data processing in response to requests from the service applications 51. The session management unit 74 manages sessions with the office equipment and the business operation system.

The license management unit 75 manages license management information. The license verification unit 76 prevents unauthorized use of licenses based on the license management information. The organization information management unit 77 manages organization management information. The user information management unit 78 manages user management information. The service management unit 79 manages service management information. The email transmission unit 80 transmits email messages.

The management data storage unit 53 includes, for example, an organization management information storage 91, a user management information storage 92, a license management information storage 93, a service management information storage 94, and a data storage 95.

The organization management information storage 91 stores organization management information. The user management information storage 92 stores user management information. The license management information storage 93 stores license management information. The service management information storage 94 stores service management information. The data storage 95 stores other data.

The platform 52 includes common functions or basic functions that are common to and used by the multiple service applications 51. In the first embodiment, the authentication unit 71, the apparatus communication unit 72, the data processing unit 73, the session management unit 74, the license management unit 75, the license verification unit 76, the organization information management unit 77, the user information management unit 78, the service management unit 79, and the email transmission unit 80 belong to the platform 52. The functions of these units of the platform 52 are made public to the service applications 51 via the platform API 54.

In other words, the service applications 51 can use the functions of these units that are made public by the platform API 54. Services provided by the service providing system 50 may be used from the client terminal 11, the mobile terminal 12, the image forming apparatus 14, and the projector 15, and may also be used from other systems and apparatuses such as a conference system, an IC recorder, and a digital camera.

The classification of or the hierarchical relationship among the software components (or functional units) and the storages of the service providing system 50 illustrated by FIG. 4 is just an example, and such classification is not essential to implement the first embodiment. That is, as long as the office equipment such as the client terminal 11, the mobile terminal 12, the image forming apparatus 14, and the projector 15 can be linked with the service applications 51, the hierarchical relationship among the software components and the storages of the service providing system 50 may be determined freely.

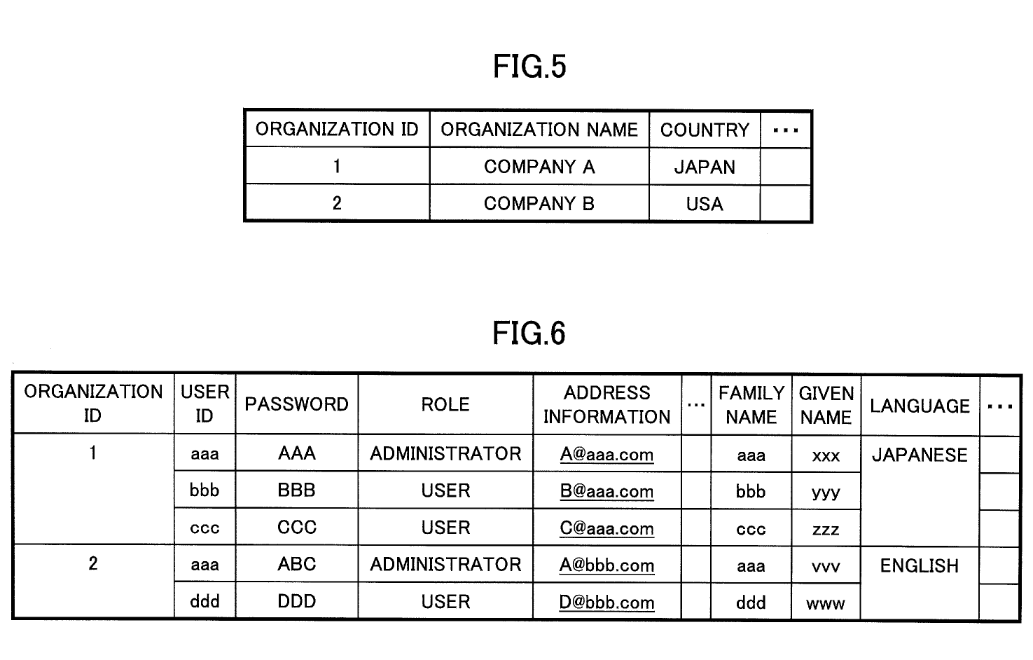

FIG. 5 is a table illustrating exemplary organization management information. The organization management information of FIG. 5 includes data items (or fields) such as an organization ID, an organization name, and a country. The organization ID is information for uniquely identifying a group such as a company or a department. The organization ID is not necessarily information for identifying an “organization”. For example, the organization ID may be information for identifying a contract. The organization name is a name of a group. The country indicates a country or a region where a service is used.

FIG. 6 is a table illustrating exemplary user management information. The user management information of FIG. 6 includes data items (or fields) such as an organization ID, a user ID, a password, a role, address information, a family name, a given name, and a language. In the user management information, records are grouped by (or associated with) organization IDs. The user ID and the password are used to identify a user at the service providing system 50. The user ID may be represented by a user name. The password may be omitted.

Also, an electronic medium (e.g., an IC card) carried by the user may be used in place of the user ID. User IDs and passwords associated with the same organization ID are unique. On the other hand, the same user ID and password may be used for multiple users associated with different organization IDs. The role is information for identifying a “role” (e.g., administrator or end user) of the user. The address information indicates an email address of the user. One or more sets of address information may be contained in each record. The family name and the given name are those of the user. The language indicates a language used by the user.

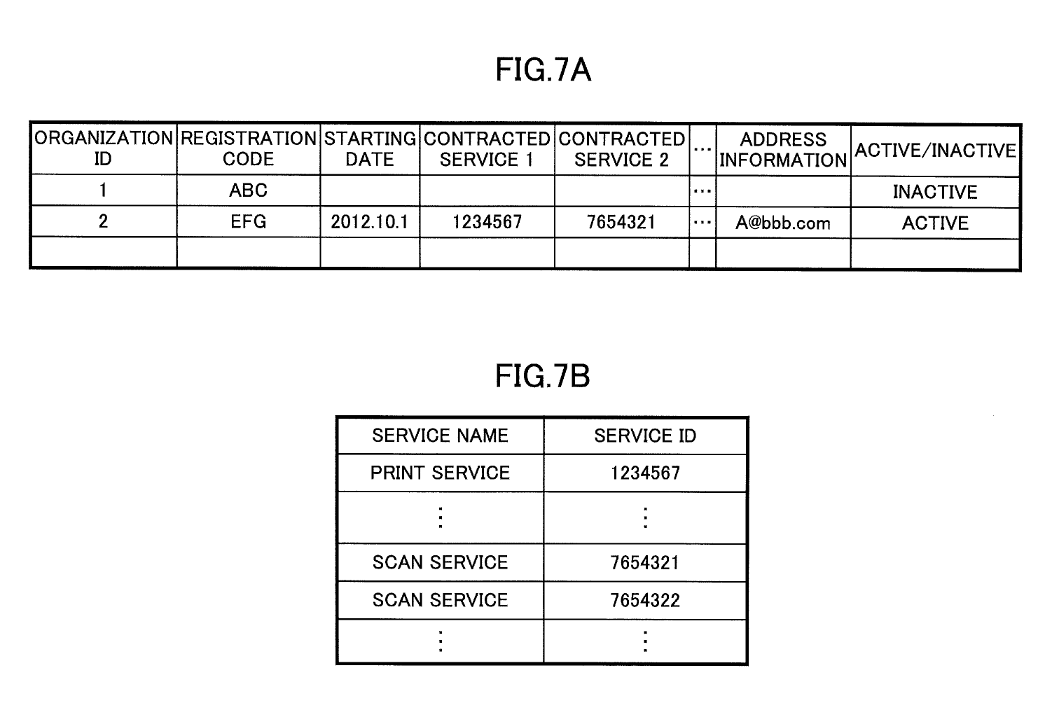

FIGS. 7A and 7B are tables illustrating exemplary license management information. The license management information of FIG. 7A includes data items (or fields) such as an organization ID, a registration code, a starting date, one or more contracted services, address information, and active/inactive information. The license management information of FIG. 7B includes data items (or fields) such as a service name and a service ID.

Organization IDs and registration codes being managed as stock at the business operation system are stored as the license management information of FIG. 7A. Service IDs being managed as stock at the business operation system are stored as the license management information of FIG. 7B.

In a record identified by an organization ID “1” in the license management information of FIG. 7A, fields for the starting date, the contracted service(s), and the address information are blank. This indicates that the organization ID “1” and the corresponding registration code “ABC” in the record have not been used yet to register a group (or organization) such as a company or a department at the portal service.

The starting date indicates a date when an organization (or group) is registered at the portal service by an administrator of the organization. The contracted service is information for identifying a service that is contracted (or subscribed) and activated by the administrator of the organization. The address information indicates an email address of the administrator of the organization. The active/inactive information indicates whether the organization has been registered at the portal service by the administrator (“active” indicates that the organization has been registered and “inactive” indicates that the organization has not been registered).

Thus, organization IDs and registration codes being managed as stock at the business operation system are registered in association with each other in the license management information of FIG. 7A. Initially, the registered organization IDs and registration codes are not associated with starting dates, contracted services, and address information. The license management unit 75 can determine whether an organization ID and a registration code are valid by referring to the license management information of FIG. 7A.

The license management information of FIG. 7B associates service names with service IDs issued by the business operation system. The license management unit 75 can determine whether a service ID is valid and identify a service corresponding to the service ID by referring to the license management information of FIG. 7B.

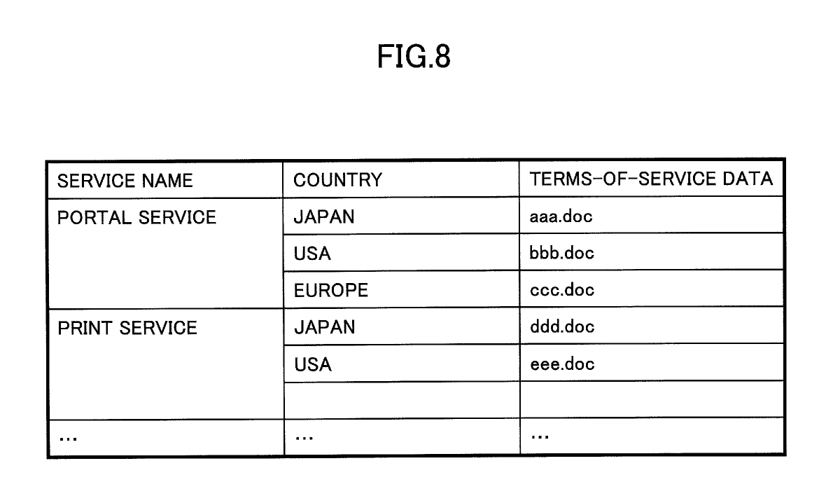

FIG. 8 is a table illustrating exemplary service management information. The service management information of FIG. 8 includes data items (or fields) such as a service name, a country, and terms-of-service data. Each record of the service management information of FIG. 8 contains a service name, a country, and terms-of-service data that are associated with each other. The terms-of-service data is used to display terms of service.

### [Portal Service Application]

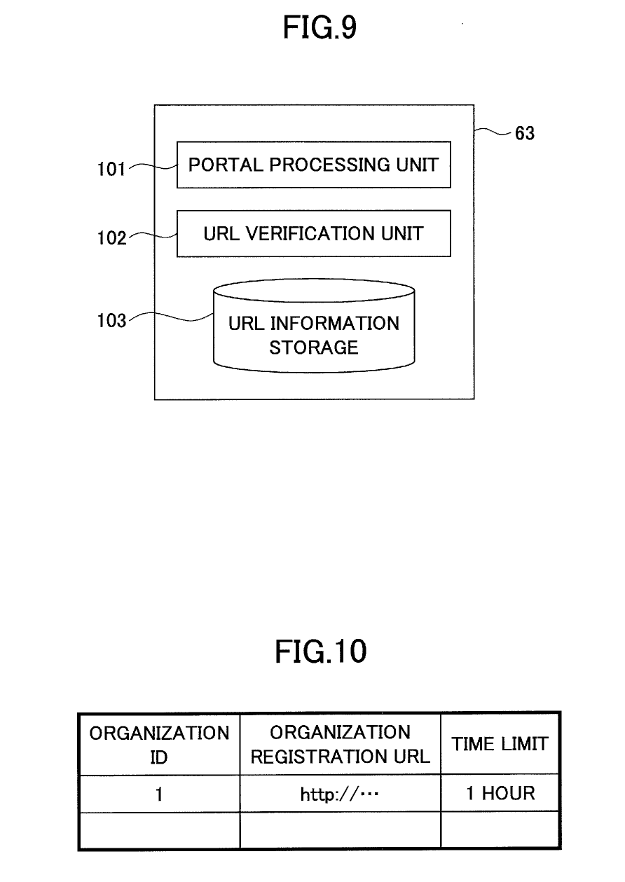

The portal service application 63 may include functional units (or processing blocks) as illustrated by FIG. 9. In other words, the portal service application 63 causes the computer system 500 to function as a portal processing unit 101, a URL verification unit 102, and a URL information storage 103.

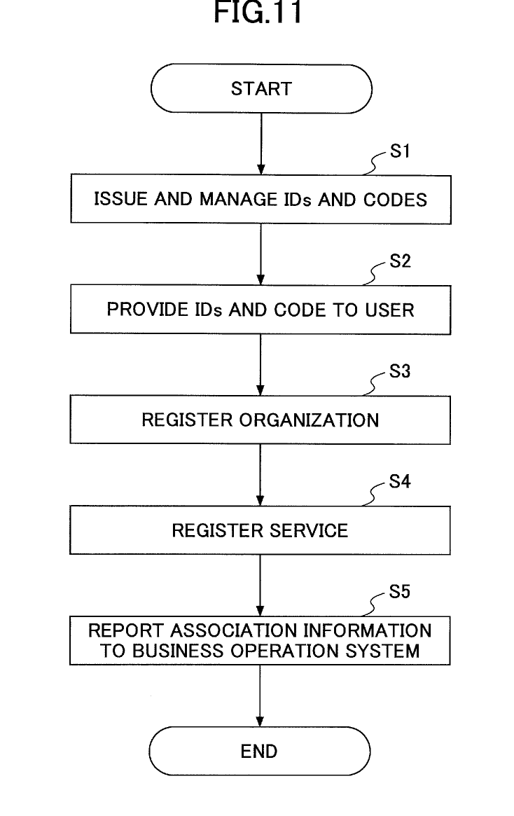

The portal processing unit 101 performs processes related to the portal service. Processes performed by the portal processing unit 101 are described later. The URL verification unit 102 generates an organization registration URL and stores the generated organization registration URL as URL information in the URL information storage 103. When the terminal device 40 accesses an organization registration URL, the URL verification unit 102 verifies the accessed organization registration URL based on the URL information stored in the URL information storage 103. FIG. 10 is a table illustrating exemplary URL information stored in the URL information storage 103.

The URL information of FIG. 10 includes data items (or fields) such as an organization ID, an organization registration URL, and a time limit. The organization registration URL is used by the administrator to access an organization registration page from the terminal device 40. The time limit indicates a period of time for which the organization registration URL is valid. The URL information of FIG. 10 associates the organization ID, the organization registration URL, and the time limit with each other.

### <Processes Performed by System 1>

Exemplary processes performed by the system 1 are described below. FIG. 11 is a flowchart illustrating an exemplary process performed by the system 1. At step S1 of FIG. 11, the ID issuing apparatus 36 of the business operation system issues organization IDs, registration codes, and service IDs for each country or region in response to an issuance request. The ID management apparatus 37 manages the organization IDs, the registration codes, and the service IDs issued by the ID issuing apparatus 36 as stock for each country or region.

The organization IDs and the registration codes being managed as stock by the ID management apparatus 37 are not yet associated with groups (or organizations) such as companies or departments. The service IDs being managed as stock by the ID management apparatus 37 are already associated with services such as the print service and the scan service, but are not yet associated with groups. A service ID may indicate, in addition to a service, information about a contract such as the number of pieces of office equipment and the number of users that use the service.

The organization IDs, the registration codes, and the service IDs being managed as stock at the business operation system are sent at predetermined intervals (e.g., every other day) to the license management unit 75 of the service providing system 50. The license management unit 75 updates the license management information based on the organization IDs, the registration codes, and the service IDs received from the business operation system without associating them with organizations.

At step S2, when a contract is made with an organization, a person at the sales company provides an organization ID, a registration code, and a service ID(s) being managed as stock by the ID management apparatus 37 to an administrator of the organization according to the contents of the contract. The organization ID, the registration code, and the service ID may be provided, for example, via mail, email, facsimile, or hand delivery to the administrator of the organization.

At step S3, the administrator of the organization accesses a portal site of the service providing system 50 from the terminal device 40, and registers the organization and the administrator at the portal service using the organization ID and the registration code provided by the sales company and an email address. Details of step S3 are described later. As a result of step S3, an account for the administrator of the organization is generated at the service providing system 50. With the generated account, the administrator of the organization can log into the service providing system 50.

At step S3, the administrator of the organization logs into the portal site of the service providing system 50 using the generated account, and activates a service(s) using the service ID provided by the sales company, i.e., registers the service at the portal service. Details of step S4 are described later. As a result of step S4, the organization ID and the service ID provided from the stock are associated with each other by the license management unit 75.

At step S5, the service providing system 50 reports, to the business operation system, association information indicating association among the organization ID, the service ID, and the group registered at the portal service. Association information indicating association among organization IDs, service IDs, and organizations registered at the portal service is reported to the ID management apparatus 37 of the business operation system at predetermined intervals (e.g., every other day).

Details of steps in the flowchart of FIG. 11 are described below.

### [Step S1]

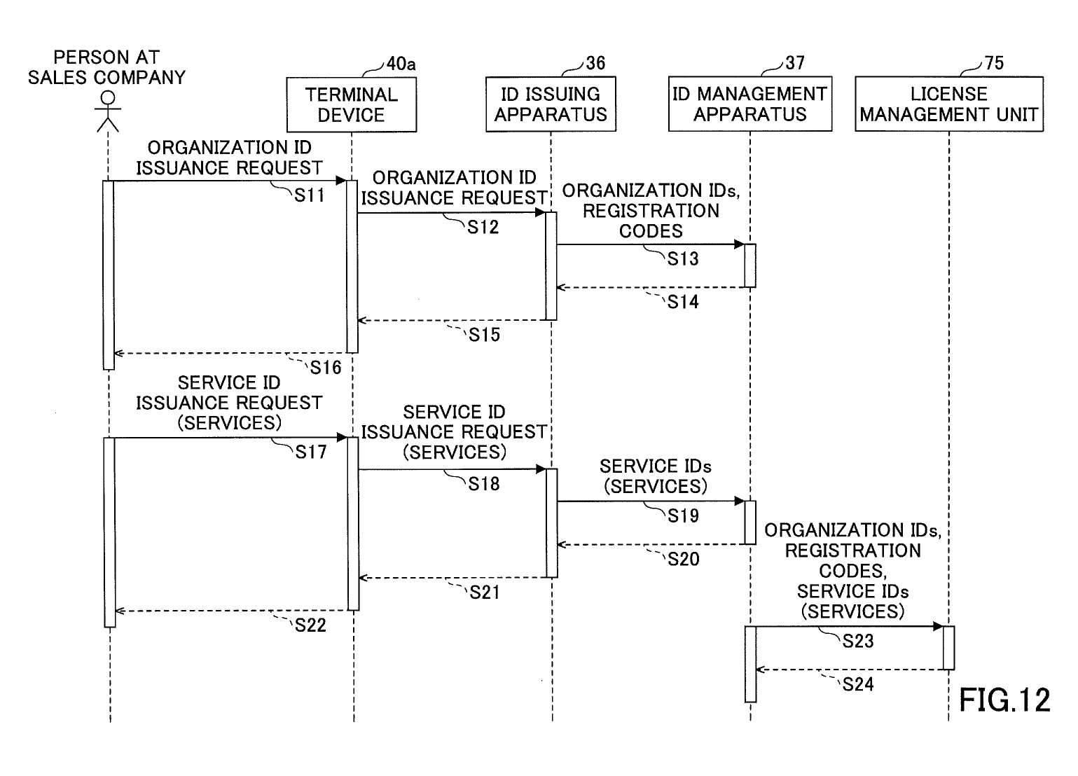

FIG. 12 is a sequence chart illustrating details of step S1 in FIG. 11. At step S11 in FIG. 12, a person who manages organization IDs and service IDs at the sales company operates a terminal device 40a such as the client terminal 31 or the mobile terminal 32 of the sales company to issue an organization ID issuance request. At step S12, the terminal device 40a sends the organization ID issuance request to the ID issuing apparatus 36 of the business operation system.

At step S13, the ID issuing apparatus 36 issues organization IDs and registration codes for each country or region in response to the organization ID issuance request. The ID issuing apparatus 36 sends the issued organization IDs and registration codes to the ID management apparatus 37. The ID management apparatus 37 manages the organization IDs and the registration codes received from the ID issuing apparatus 36 as stock for each country or region. Through steps S14 to S16, a response is sent to the person at the sales company.

At step S17, the person at the sales company operates the terminal device 40a to specify services and issue a service ID issuance request for the specified services. At step S18, the terminal device 40a sends the service ID issuance request for the specified services to the ID issuing apparatus 36 of the business operation system.

At step S19, the ID issuing apparatus 36 issues service IDs for the specified services for each country or region in response to the service ID issuance request. The ID issuing apparatus 36 sends the issued service IDs to the ID management apparatus 37.

The ID management apparatus 37 manages the service IDs received from the ID issuing apparatus 36 as stock for each country or region. Through steps S20 to S22, a response is sent to the person at the sales company. At this stage, the organization IDs, the registration codes, and the service IDs being managed as stock by the ID management apparatus 37 are not yet associated with organizations such as companies or departments.

At step S23, the ID management apparatus 37 sends the organization IDs, the registration codes, and the service IDs being managed as stock to the license management unit 75 of the service providing system 50 at predetermined intervals (e.g., every other day). Step S23 may be performed when information being managed by the ID management apparatus 37 is updated. Also, step S23 may be performed when the ID management apparatus 37 is polled by the license management unit 75. At step S24, a response is sent to the ID management apparatus 37.

With the process illustrated by FIG. 12, it is possible to issue and manage a stock of organization IDs, registration codes, and service IDs that are not associated with organizations such as companies and departments. A person at the sales company can obtain an organization ID, a registration code, and a service ID from the stock according to a normal inventory control method. Also with the process of FIG. 12, it is possible to report the organization IDs, the registration codes, and the service IDs being managed at the business operation system to the service providing system 50.

### [Step S3]

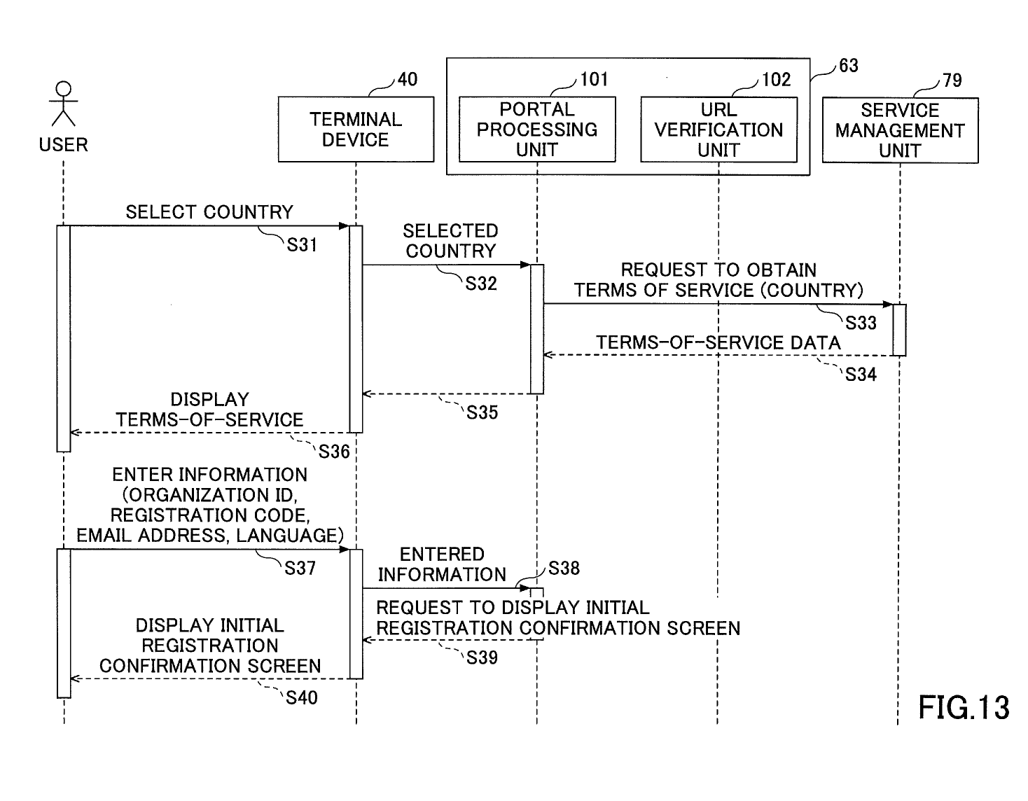

Details of step S3 of FIG. 11 are described below with reference to multiple sequence charts. FIG. 13 is a sequence chart (1/4) illustrating details of step S3 in FIG. 11. After an organization ID and a registration code are provided by a person at the sales company to an administrator of an organization, the administrator accesses the portal site of the service providing system 50 from the terminal device 40. Then, the portal processing unit 101 of the portal service application 63 of the service providing system 50 requests the terminal device 40 to display a top screen 1000.

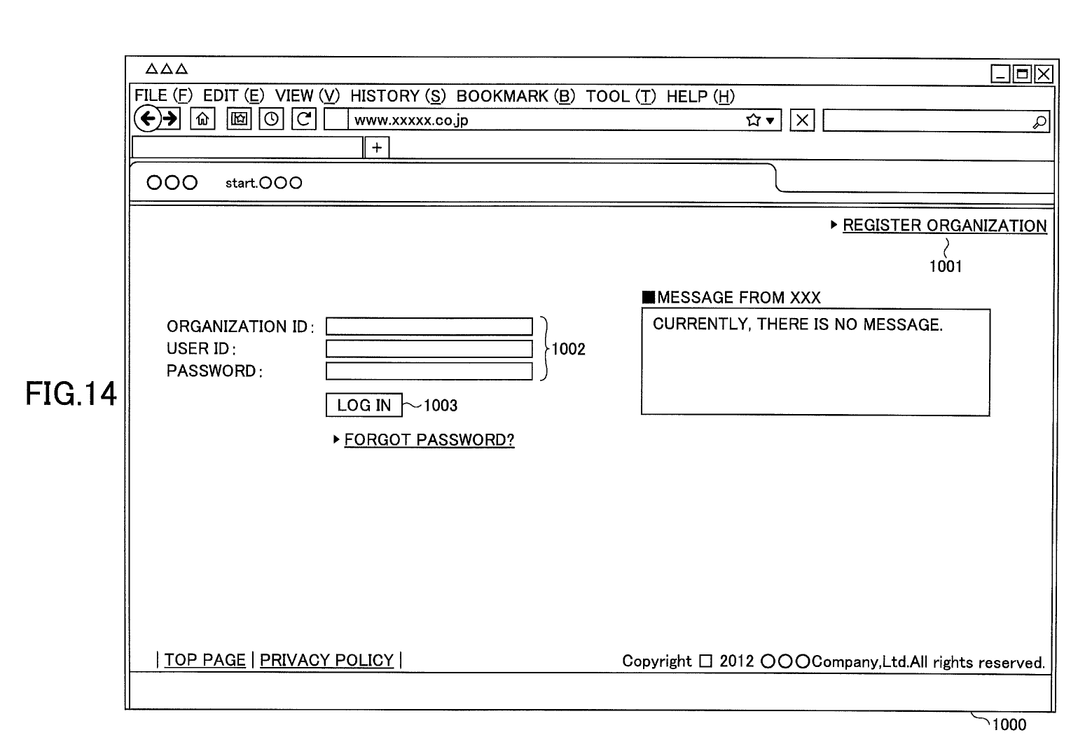

FIG. 14 is a drawing illustrating an exemplary top screen. The top screen 1000 includes a link 1001 to a site for registering an organization, an input field 1002 for entering an organization ID, a user ID, and a password used to log into the portal service application 63, and a Login button 1003. The display control unit 42 of the terminal device 40 displays the top screen 1000 on the display unit 502.

The administrator operates the input unit 501 of the terminal device 40 to click (or select) the link 1001 on the top screen 1000 to move to a site for registering an organization. When the link 1001 is clicked, the portal processing unit 101 of the portal service application 63 of the service providing system 50 requests the terminal device 40 to display a terms-of-service screen 1010.

Here, an administrator or a user registered in the user management information storage 92 can log into the portal service application 63 of the service providing system 50 by entering an organization ID, a user ID, and a password in the input field 1002 and clicking the Login button 1003.

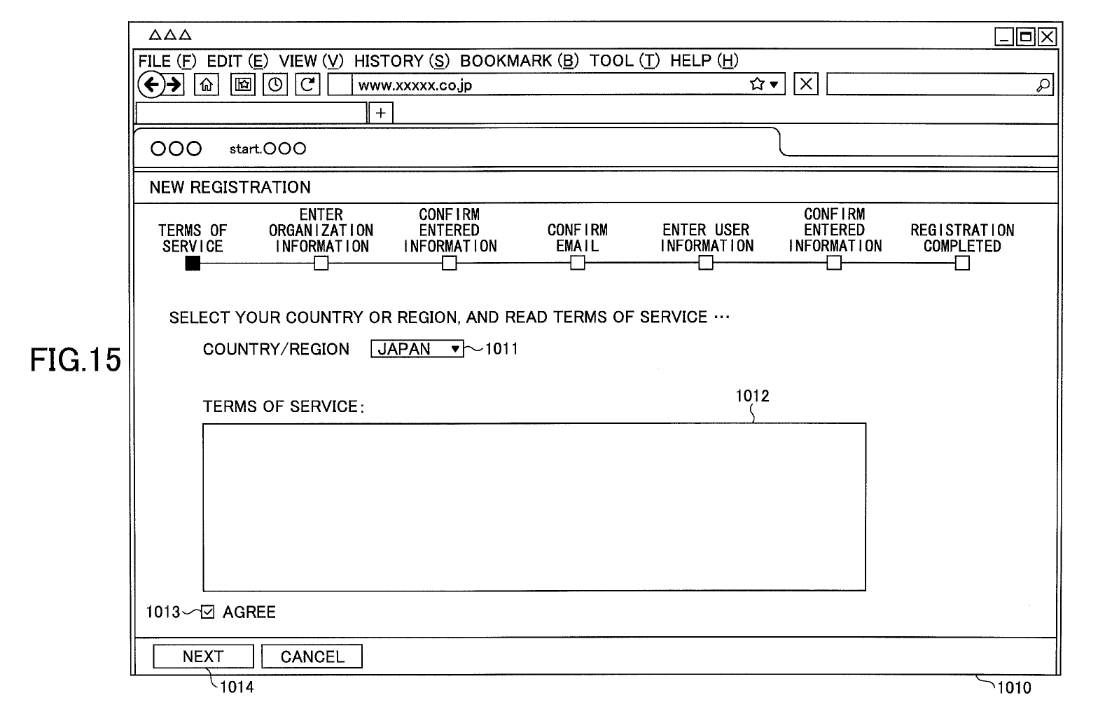

FIG. 15 is a drawing illustrating an exemplary terms-of-service screen. The terms-of-service screen 1010 includes a selection field 1011 for selecting a country or region where a service is used, a terms-of-service field 1012 for displaying terms of service, a check box 1013 used to indicate agreement to the terms of service, and a Next button 1014 to display a next screen.

At step S31, the display control unit 42 of the terminal device 40 displays the terms-of-service screen 1010 on the display unit 502. The administrator operates the input unit 501 of the terminal device 40 to select a country or a region (here, it is assumed that a country is selected) from the selection field 1011 on the terms-of-service screen 1010. At step S32, the terminal device 40 reports the country selected on the terms-of-service screen 1010 to the portal processing unit 101 of the portal service application 63.

At step S33, the portal processing unit 101 requests the service management unit 79 to obtain terms-of-service data corresponding to the selected country. The service management unit 79 refers to the service management information stored in the service management information storage 94 and obtains terms-of-service data associated with the selected country. At step S34, the portal processing unit 101 obtains the terms-of-service data associated with the selected country from the service management unit 79.

At step S35, the portal processing unit 101 requests the terminal device 40 to display the terms-of-service screen 1010 on which terms of service are displayed in the terms-of-service field 1012 based on the terms-of-service data associated with the selected country. The display control unit 42 of the terminal device 40 displays, on the display unit 502, the terms-of-service screen 1010 on which the terms of service are displayed in the terms-of-service field 1012 based on the terms-of-service data associated with the selected country. At step S36, the administrator checks the terms of service displayed in the terms-of-service field 1012.

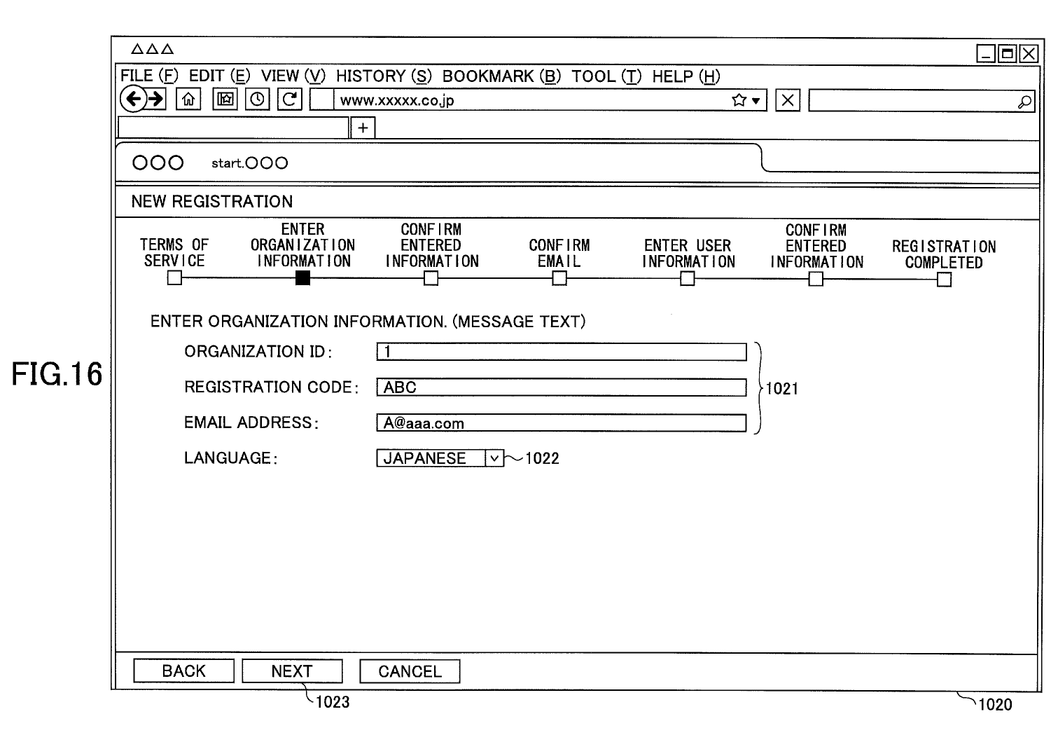

The administrator can display an initial registration screen 1020 on the display unit 502 by selecting the check box 1013 to indicate agreement to the terms of service and pressing the Next button 1014. FIG. 16 is a drawing illustrating an exemplary initial registration screen.

The initial registration screen 1020 includes an input field 1021 for entering an organization ID, a registration code, and an email address, a selection field 1022 for selecting a language, and a Next button 1023 to display a next screen.

At step S37, the display control unit 42 of the terminal device 40 displays the initial registration screen 1020 on the display unit 502. The administrator operates the input unit 501 of the terminal device 40 to enter an organization ID, a registration code, and an email address in the input field 1021 on the initial registration screen 1020 and to select a language from the selection field 1022, and then presses the Next button 1023 to display a next screen. At step S38, the terminal device 40 reports the organization ID, the registration code, the email address, and the language entered and selected on the initial registration screen 1020 to the portal processing unit 101 of the portal service application 63.

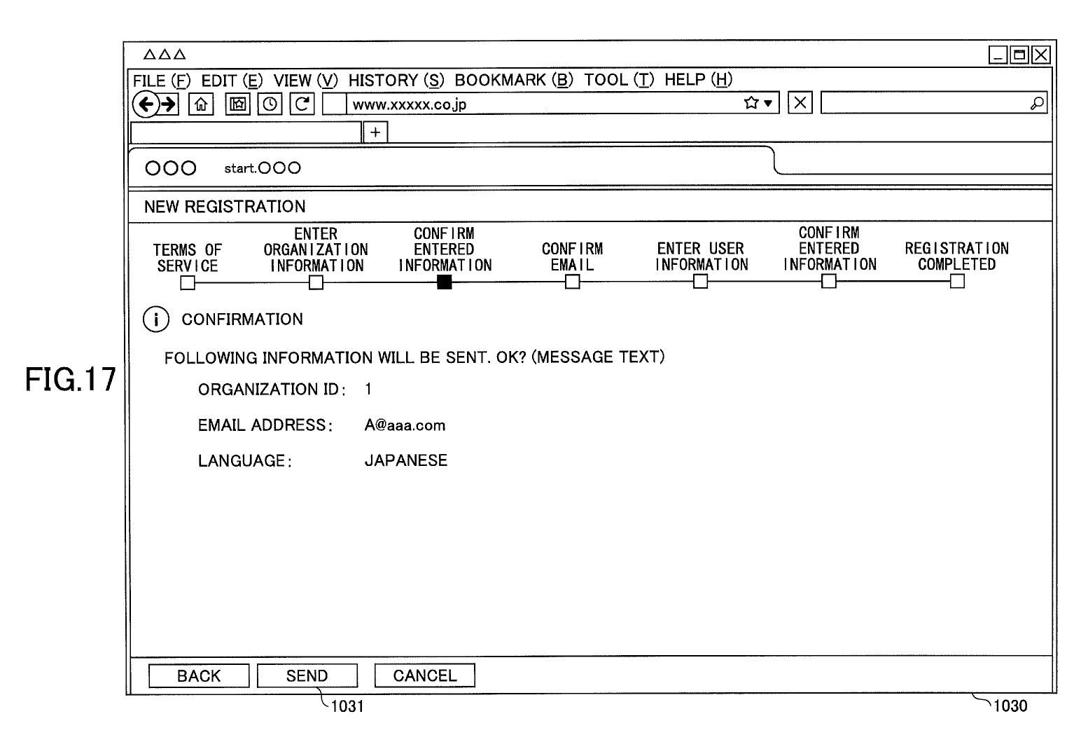

At step S39, the portal processing unit 101 requests the terminal device 40 to display an initial registration confirmation screen 1030. FIG. 17 is a drawing illustrating an exemplary initial registration confirmation screen. The initial registration confirmation screen 1030 displays the organization ID, the email address, and the language entered and selected on the initial registration screen 1020 of FIG. 16, and includes a Send button 1031.

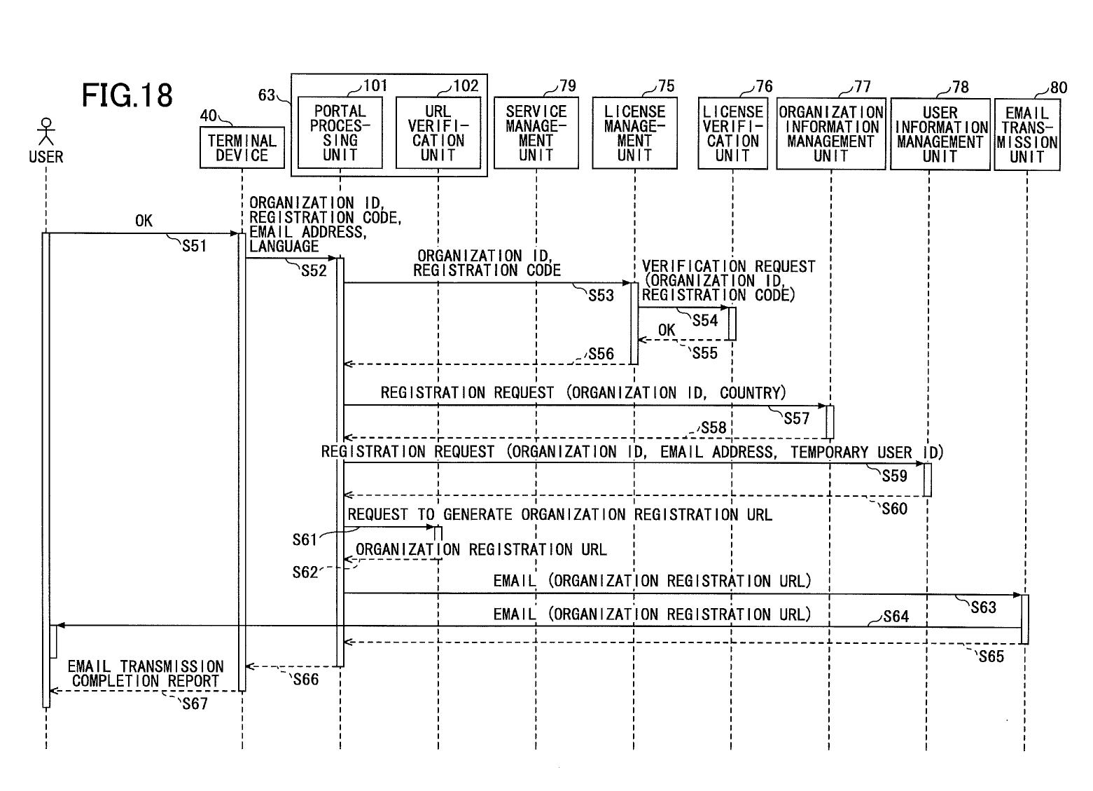

At step S40, the display control unit 42 of the terminal device 40 displays the initial registration confirmation screen 1030 on the display unit 502. On the initial registration confirmation screen 1030, the administrator confirms the organization ID, the email address, and the language entered and selected on the initial registration screen 1020, and presses the Send button 1031. FIG. 18 is a sequence chart (2/4) illustrating details of step S3 in FIG. 11. FIG. 18 includes a step of pressing the Send button 1031 and subsequent steps.

At step S51, on the initial registration confirmation screen 1030, the administrator confirms the organization ID, the email address, and the language entered and selected on the initial registration screen 1020, and presses the Send button 1031.

When the Send button 1031 is pressed, the terminal device 40 reports, at step S52, the organization ID, the registration code, the email address, and the language entered and selected on the initial registration screen 1020 to the portal processing unit 101 of the portal service application 63. This report may be referred to as an “initial registration request”.

At step S53, the portal processing unit 101 of the portal service application 63 requests the license management unit 75 to verify the organization ID and the registration code reported from the terminal device 40. At step S54, the license management unit 75 requests the license verification unit 76 to verify the organization ID and the registration code. The license verification unit 76 determines that the organization ID and the registration code reported from the terminal device 40 are valid when the organization ID and the registration code are stored in association with each other in a record (see FIG. 7A) of the license management information storage 93 and the active/inactive field of the record is “inactive”.

Here, it is assumed that the organization ID and the registration code reported from the terminal device 40 are valid. At step S55, the license verification unit 76 reports to the license management unit 75 that the organization ID and the registration code are valid. At step S56, the license management unit 75 reports to the portal processing unit 101 that the organization ID and the registration code are valid.

At step S57, the portal processing unit 101 requests the organization information management unit 77 to register the organization ID and the country reported from the terminal device 40. The organization information management unit 77 stores the organization ID and the country reported from the terminal device 40 in association with each other in the organization management information storage 91. At step S58, the organization information management unit 77 sends a response to the portal processing unit 101.

At step S59, the portal processing unit 101 requests the user information management unit 78 to register the organization ID and the email address reported from the terminal device 40 and a temporary user ID. The user information management unit 78 stores the organization ID and the email address reported from the terminal device 40 and the temporary user ID in association with each other in the user management information storage 92. At step S60, the user information management unit 78 sends a response to the portal processing unit 101.

At step S61, the portal processing unit 101 requests the URL verification unit 102 to generate an organization registration URL. The URL verification unit 102 generates an organization registration URL and stores URL information as illustrated by FIG. 10 in the URL information storage 103. At step S62, the portal processing unit 101 receives the organization registration URL from the URL verification unit 102.

At step S63, the portal processing unit 101 generates an email message including the organization registration URL, and requests the email transmission unit 80 of the platform 52 to send the email message. At step S64, the email transmission unit 80 sends the email message including the organization registration URL to the email address reported from the terminal device 40. At step S65, the email transmission unit 80 sends a response to the portal processing unit 101. At step S66, the portal processing unit 101 sends a response to the terminal device 40.

Then, at step S67, the display control unit 42 of the terminal device 40 displays an email transmission confirmation screen 1040 on the display unit 502, and reports to the administrator that the transmission of the email message to the email address entered at step S37 has been completed.

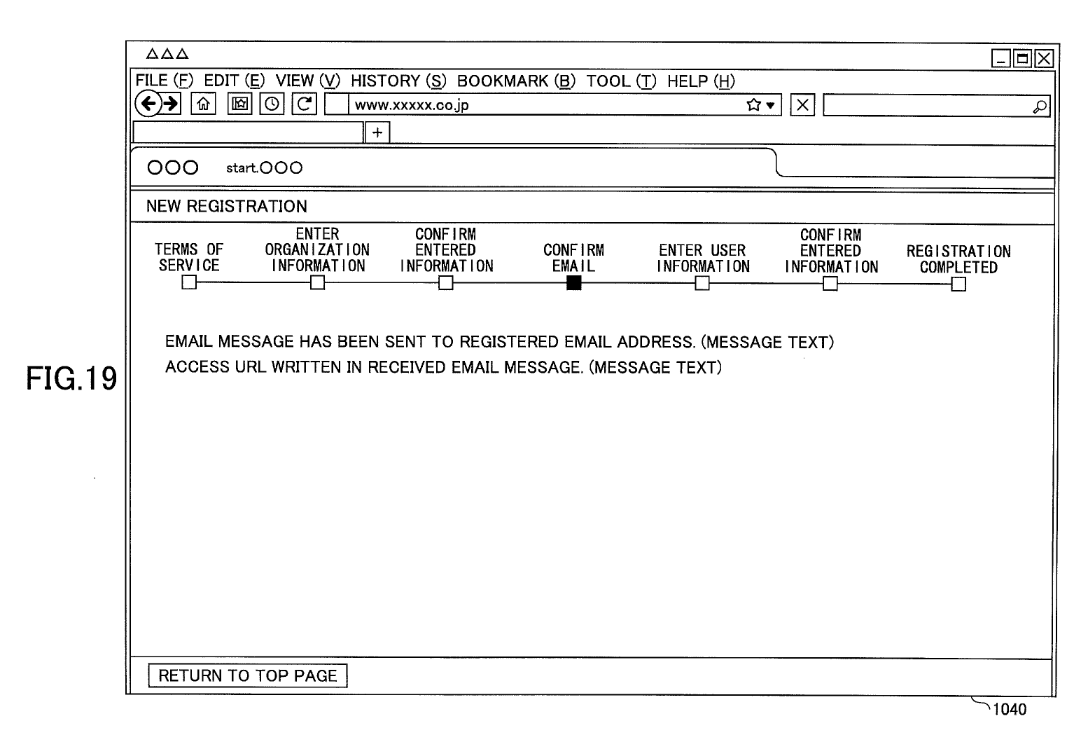

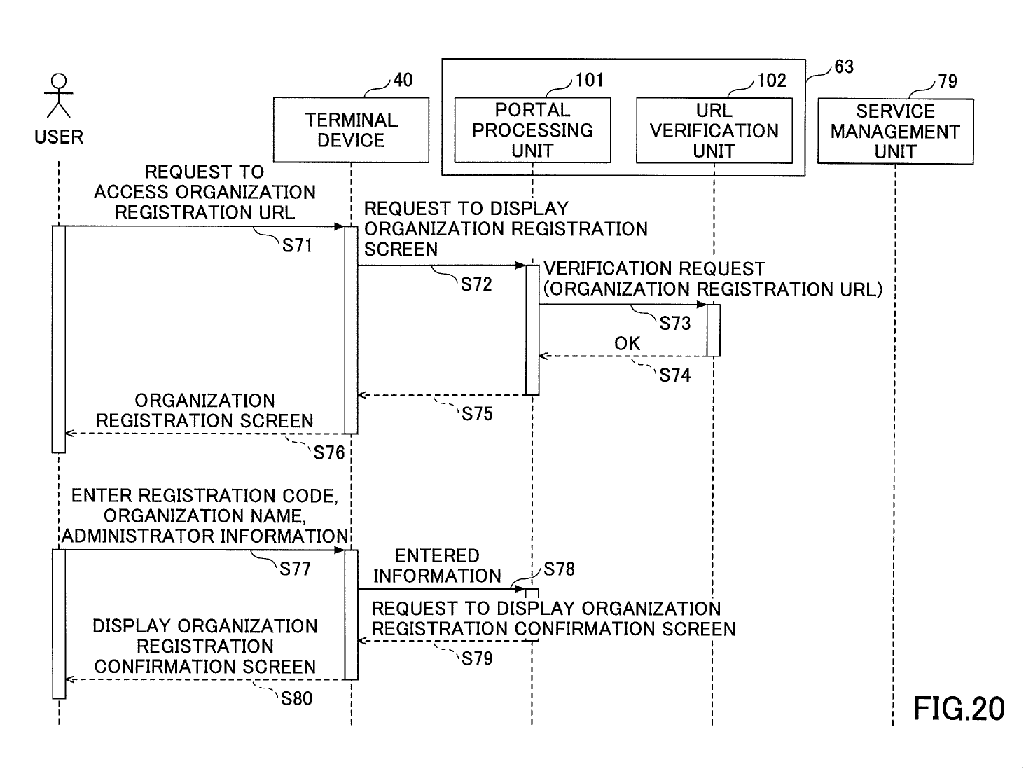

FIG. 19 is a drawing illustrating an exemplary email transmission confirmation screen. The email transmission confirmation screen 1040 includes a message indicating that the email message has been sent to the entered email address, and a message requesting the administrator to access the organization registration URL in the email message. FIG. 20 is a sequence chart (3/4) illustrating details of step S3 in FIG. 11. FIG. 20 includes a step of accessing the organization registration URL in the email message and subsequent steps.

The administrator operates the input unit 501 of the terminal device 40 to cause the email reception unit 43 to receive the email message from the service providing system 50. At step S71, the administrator operates the input unit 501 of the terminal device 40 to access the organization registration URL in the received email message. Here, it is assumed that the email message does not include at least one of the organization ID and the registration code. At step S72, the terminal device 40 accesses the organization registration URL in the email message to display an organization registration screen 1050.

At step S73, the portal processing unit 101 of the service providing system 50 requests the URL verification unit 102 to verify the accessed organization registration URL. The URL verification unit 102 determines that the organization registration URL accessed by the terminal device 40 is valid when the organization registration URL is stored in the URL information storage 103. Here, it is assumed that the accessed organization registration URL is valid.

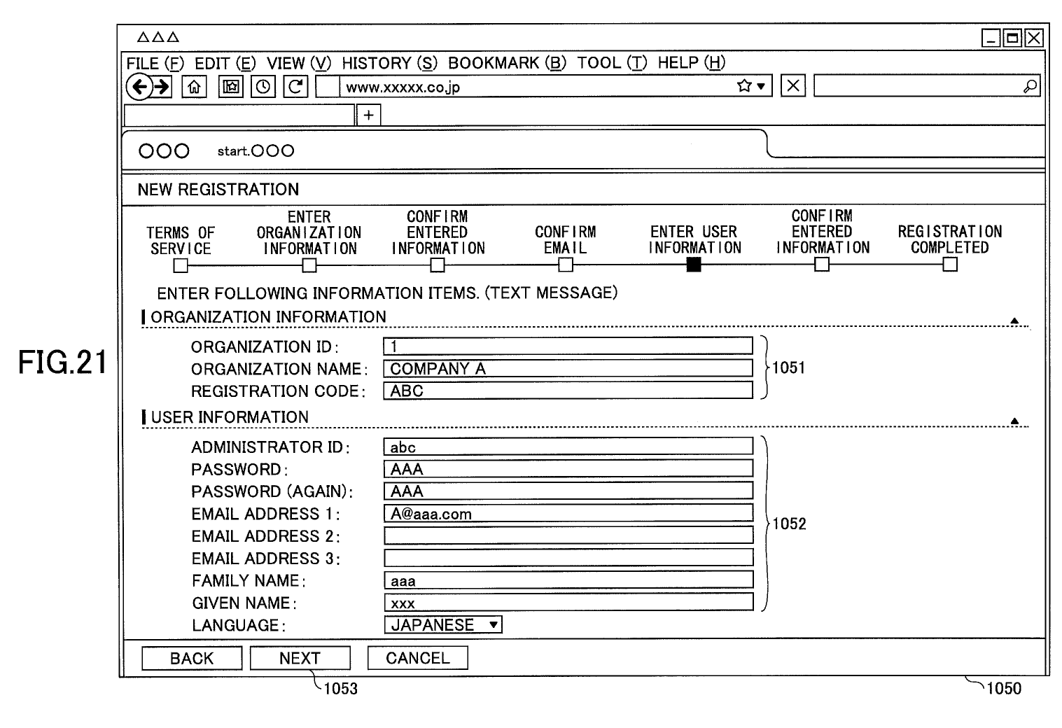

At step S74, the URL verification unit 102 reports to the portal processing unit 101 that the accessed organization registration URL is valid. At step S75, the portal processing unit 101 requests the terminal device 40 to display the organization registration screen 1050 as illustrated by FIG. 21. At step S76, the display control unit 42 of the terminal device 40 displays the organization registration screen 1050 on the display unit 502.

FIG. 21 is a drawing illustrating an exemplary organization registration screen. The organization registration screen 1050 includes an input field 1051 for entering organization information, an input field 1052 for entering user information, and a Next button 1053 to display a next screen. The input field 1051 includes input boxes for entering an organization ID, an organization name, and a registration code. The input field 1052 includes input boxes for entering an administrator ID (or user ID), a password, an email address, a family name, a given name, and a language.

The organization registration screen 1050 may be configured such that information such as an organization ID already entered by the administrator is automatically entered in the corresponding input box and displayed. Even in this case, it is preferable to make the administrator (or the user) manually enter one or both of the organization ID and the registration code not included in the received email message. This is because the combination of the organization ID and the registration code is used as authentication information to prevent unauthorized use of a license (a permit to use services).

At step S77, the administrator operates the input unit 501 of the terminal device 40 to enter organization information and user information in the input field 1051 and the input field 1052, and then presses the next button 1053 to display a next screen.

At step S78, the terminal device 40 reports the organization information and the user information entered in the input field 1051 and the input field 1052 to the portal processing unit 101 of the portal service application 63.

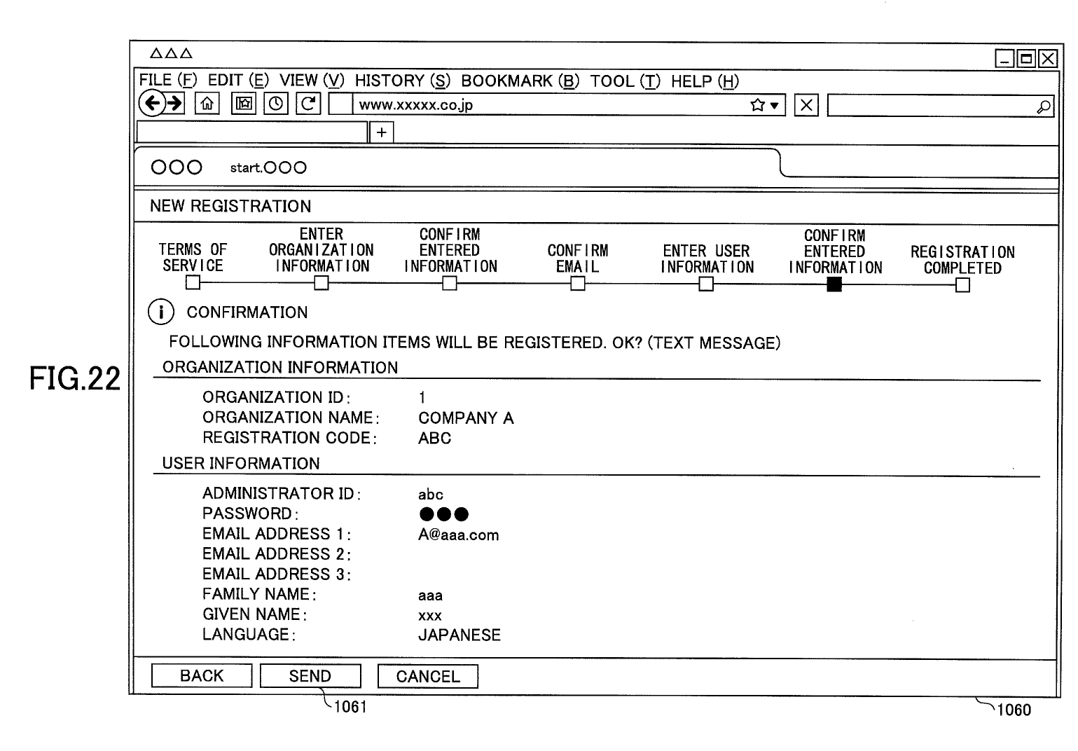

At step S79, the portal processing unit 101 requests the terminal device 40 to display an organization registration confirmation screen 1060. At step S80, the display control unit 42 of the terminal device 40 displays the organization registration confirmation screen 1060 on the display unit 502. FIG. 22 is a drawing illustrating an exemplary organization registration confirmation screen. The organization registration confirmation screen 1060 displays the organization information and the user information entered in the input field 1051 and the input field 1052 of the organization registration screen 1050 and includes a Send button 1061.

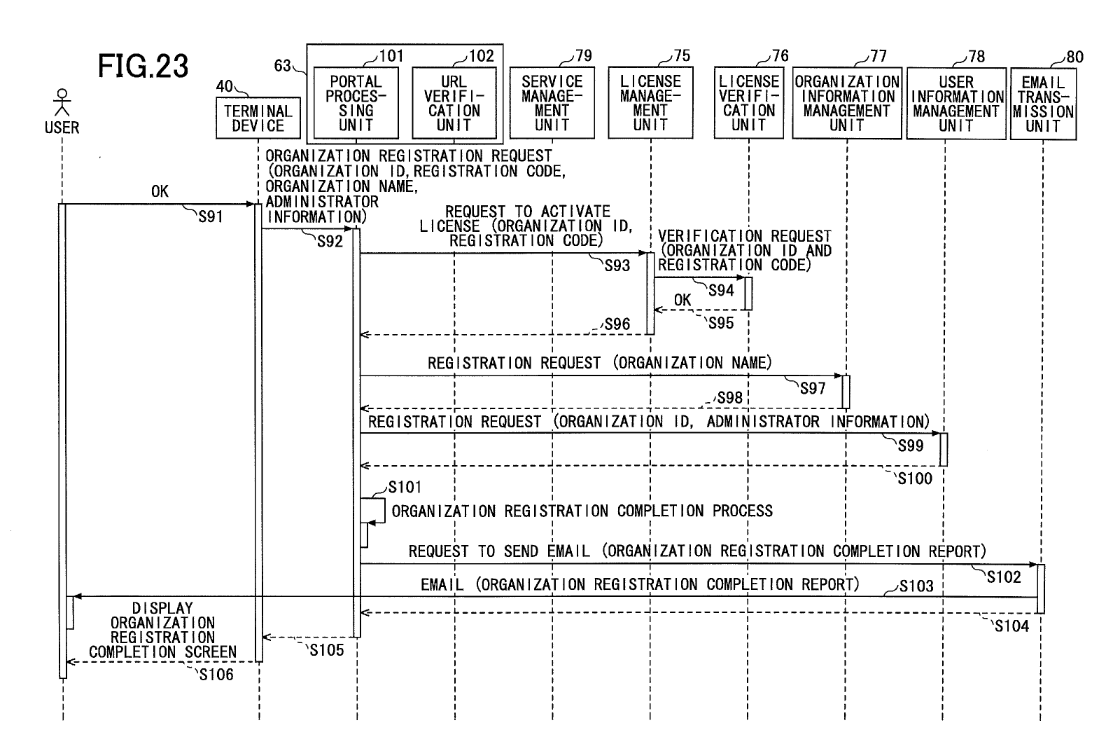

On the organization registration confirmation screen 1060, the administrator confirms the organization information and the user information entered in the input field 1051 and the input field 1052 of the organization registration screen 1050, and then presses the Send button 1061. FIG. 23 is a sequence chart (4/4) illustrating details of step S3 in FIG. 11. FIG. 23 includes a step of pressing the Send button 1061 on the organization registration confirmation screen 1060 and subsequent steps.

At step S91, on the organization registration confirmation screen 1060, the administrator confirms the organization information and the user information entered in the input field 1051 and the input field 1052 of the organization registration screen 1050, and then presses the Send button 1061.

When the Send button 1061 is pressed, the terminal device 40 reports, at step S92, the organization ID, the organization name, the registration code, and the user information (administrator information) entered on the organization registration screen 1050 to the portal processing unit 101 of the portal service application 63 to request registration of the organization. This report may be referred to as an “organization registration request”.

At step S93, the portal processing unit 101 of the portal service application 63 requests the license management unit 75 to activate a license based on the organization ID and the registration code reported from the terminal device 40. At step S94, the license management unit 75 requests the license verification unit 76 to verify the organization ID and the registration code. The license verification unit 76 determines that the organization ID and the registration code reported from the terminal device 40 are valid when the organization ID and the registration code are stored in association with each other in a record (see FIG. 7A) of the license management information storage 93 and the active/inactive field of the record is “inactive”.

Here, it is assumed that the organization ID and the registration code reported from the terminal device 40 are valid. At step S95, the license verification unit 76 reports to the license management unit 75 that the organization ID and the registration code are valid. The license management unit 75 changes the active/inactive field of the record including the organization ID and the registration code reported from the terminal device 40 to “active”, and thereby activates the license. At step S96, the license management unit 75 reports to the portal processing unit 101 that the license has been activated.

At step S97, the portal processing unit 101 requests the organization information management unit 77 to register the organization name reported from the terminal device 40. The organization information management unit 77 stores the organization name reported from the terminal device 40 in the organization management information storage 91 in association with the corresponding organization ID. At step S98, the organization information management unit 77 sends a response to the portal processing unit 101.

At step S99, the portal processing unit 101 requests the user information management unit 78 to register the organization ID and the administrator information reported from the terminal device 40. The user information management unit 78 stores the organization ID and the administrator information reported from the terminal device 40 in association with each other in the user management information storage 92. At step S100, the user information management unit 78 sends a response to the portal processing unit 101. At step S101, the portal processing unit 101 performs an organization registration completion process.

At step S102, the portal processing unit 101 generates an email message including an organization registration completion report, and requests the email transmission unit 80 of the platform 52 to send the email message. At step S103, the email transmission unit 80 sends the email message including the organization registration completion report to the email address reported from the terminal device 40. At step S104, the email transmission unit 80 sends a response to the portal processing unit 101. At step S105, the portal processing unit 101 sends a response to the terminal device 40.

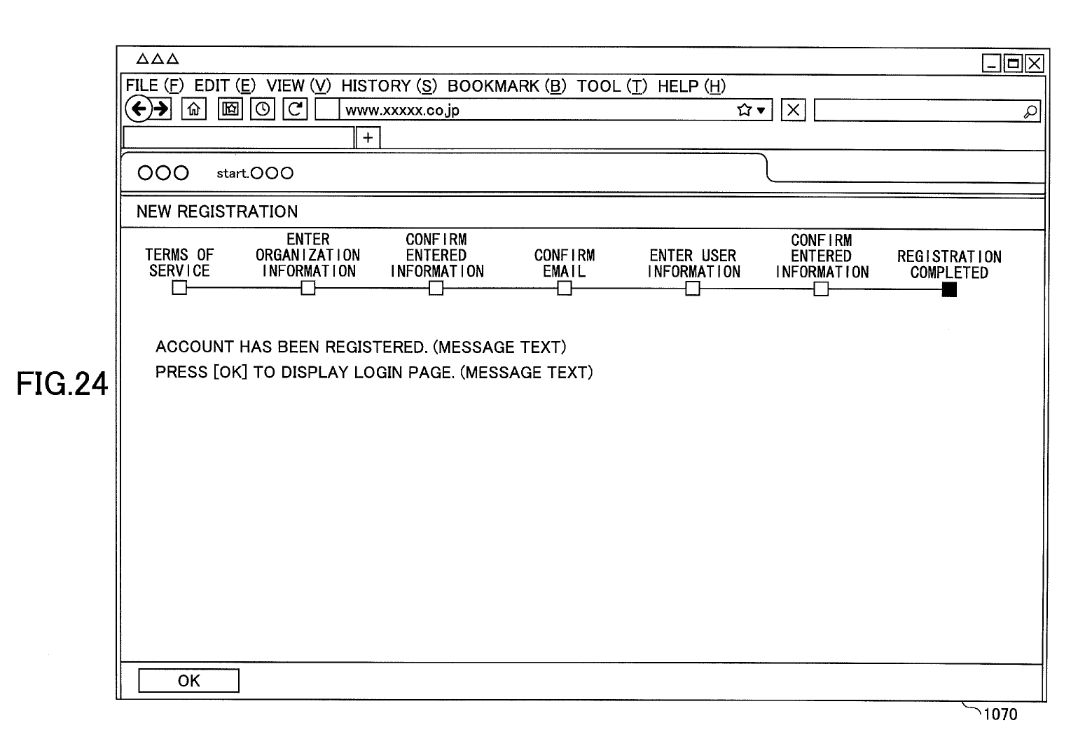

Then, at step S106, the display control unit 42 of the terminal device 40 displays an organization registration completion screen 1070 on the display unit 502, and reports to the administrator that the registration of the organization has been completed. FIG. 24 is a drawing illustrating an exemplary organization registration completion screen. The organization registration completion screen 1070 of FIG. 24 includes a message indicating that the registration of the organization has been completed and an account has been registered.

Thus, through the process illustrated by FIGS. 13, 18, 20, and 23, an administrator of an organization such as a company can register the organization at the portal service using an organization ID and a registration code received from, for example, a person at the sales company. Accordingly, the service providing system 50 of the first embodiment allows an administrator (or a user) of an organization, which has made a contract for a service(s) with a sales company, to register information necessary to use the service without requesting a person at the sales company to register the information.

According to the process illustrated by FIGS. 13, 18, 20, and 23, a temporary URL used to continue the process of step S3 is sent to an email address entered by an administrator of an organization. This makes possible to verify the entered email address and allows the administrator to enter an email address again when there is an error in the entered email address. The system 1 may be configured such that an organization registration completion report is also sent to the ID management apparatus 37.

### [Step S4]

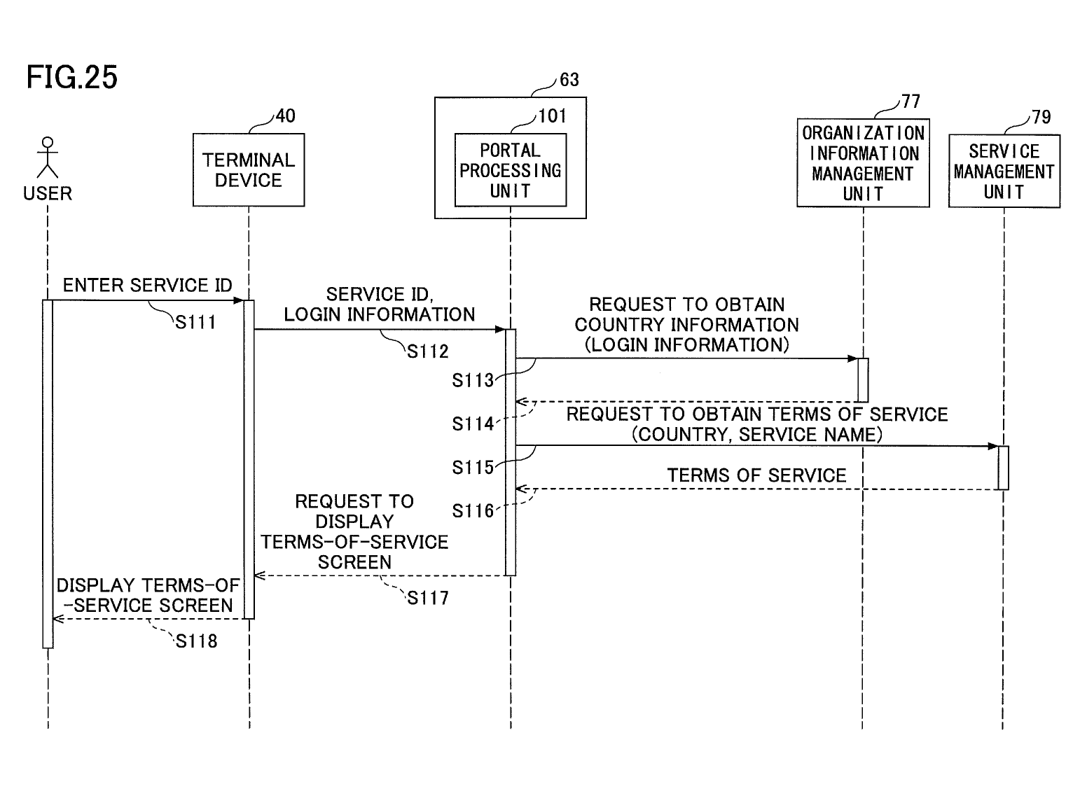

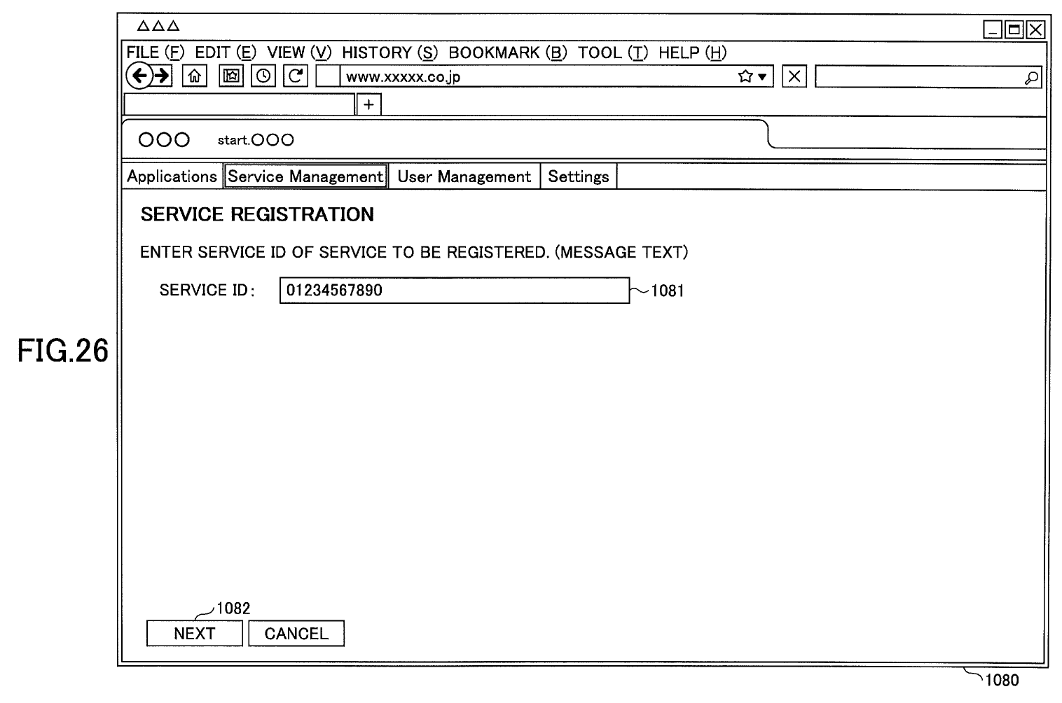

FIG. 25 is a sequence chart (1/2) illustrating details of step S4 in FIG. 11. The administrator logs into the portal site of the service providing system 50 via the top screen 1000 of FIG. 14 by using the account generated in the process of step S3. After logging into the portal site, to activate or update a contracted service(s), the administrator operates the input unit 501 of the terminal device 40 to display a contracted service registration screen 1080 as exemplified by FIG. 26.

FIG. 26 is a drawing illustrating an exemplary contracted service registration screen. The contracted service registration screen 1080 includes an input field 1081 for entering a service ID necessary to register a contracted service, and a Next button 1082 to display a next screen. The display control unit 42 of the terminal device 40 displays the contracted service registration screen 1080 on the display unit 502.

At step S111, the administrator operates the input unit 501 of the terminal device 40 to enter a service ID, which has been received, for example, from a person at the sales company, in the input field 1081, and clicks the Next button 1082.

When the Next button 1082 on the contracted service registration screen 1080 is clicked, the terminal device 40, at step S112, sends the service ID entered in the input field 1081 and the login information to the portal processing unit 101 and thereby requests the portal processing unit 101 to register a contracted service.

At step S113, the portal processing unit 101 sends the login information to the organization information management unit 77 and thereby requests the organization information management unit 77 to obtain country information. The organization information management unit 77 reads, from the organization management information of FIG. 5, a country associated with an organization ID in the login information. At step S114, the organization information management unit 77 sends the country read from the organization management information to the portal processing unit 101 as country information.

At step S115, the portal processing unit 101 sends, to the service management unit 79, a service name associated with the service ID received at step S112 from the terminal device 40 and the country information received at step 114 from the organization information management unit 77, and thereby requests the service management unit 79 to obtain terms of service.

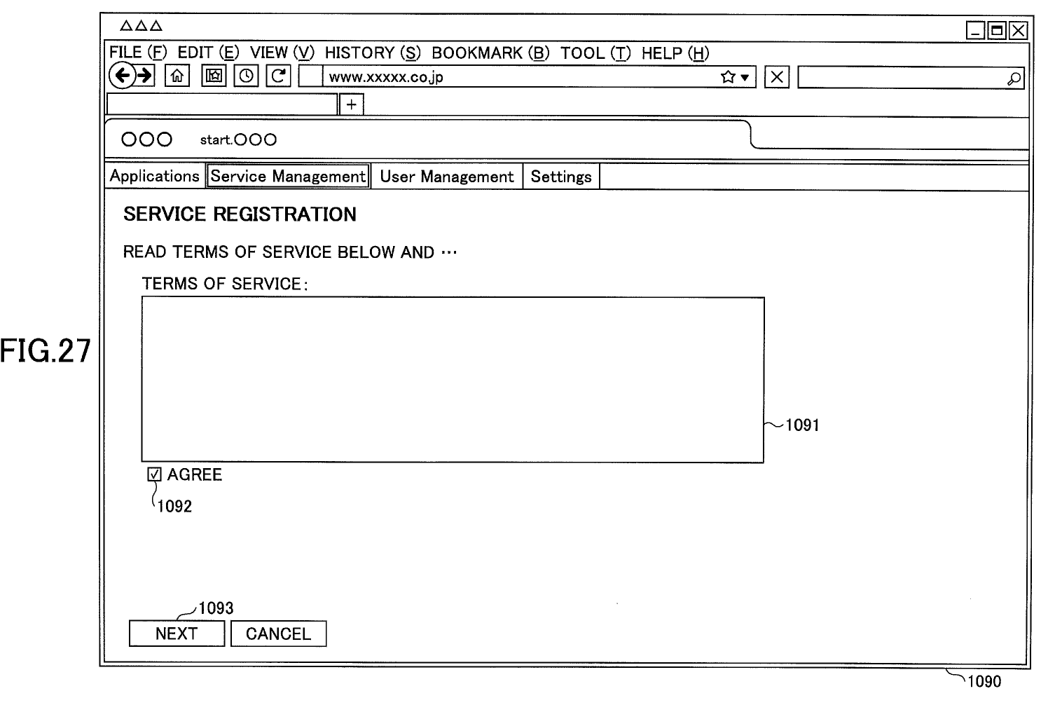

The service management unit 79 reads, from the service management information of FIG. 8, terms-of-service data associated with the service name and the country information received from the portal processing unit 101. At step S116, the service management unit 79 sends the terms-of-service data read from the service management information to the portal processing unit 101. At step S117, the portal processing unit 101 requests the terminal device 40 to display a terms-of-service screen 1090 as illustrated by FIG. 27. At step S118, the display control unit 42 of the terminal device 40 displays, on the display unit 502, the terms-of-service screen 1090 on which the terms of service corresponding to the service and the country are displayed in a terms-of-service field 1091 based on the terms-of-service data.

FIG. 27 is a drawing illustrating an exemplary terms-of-service screen. The terms-of-service screen 1090 includes the terms-of-service field 1091 for displaying terms of service, a check box 1092 used to indicate agreement to the terms of service, and a Next button 1093 to display a next screen. The administrator confirms the terms of service displayed in the terms-of-service field 1091.

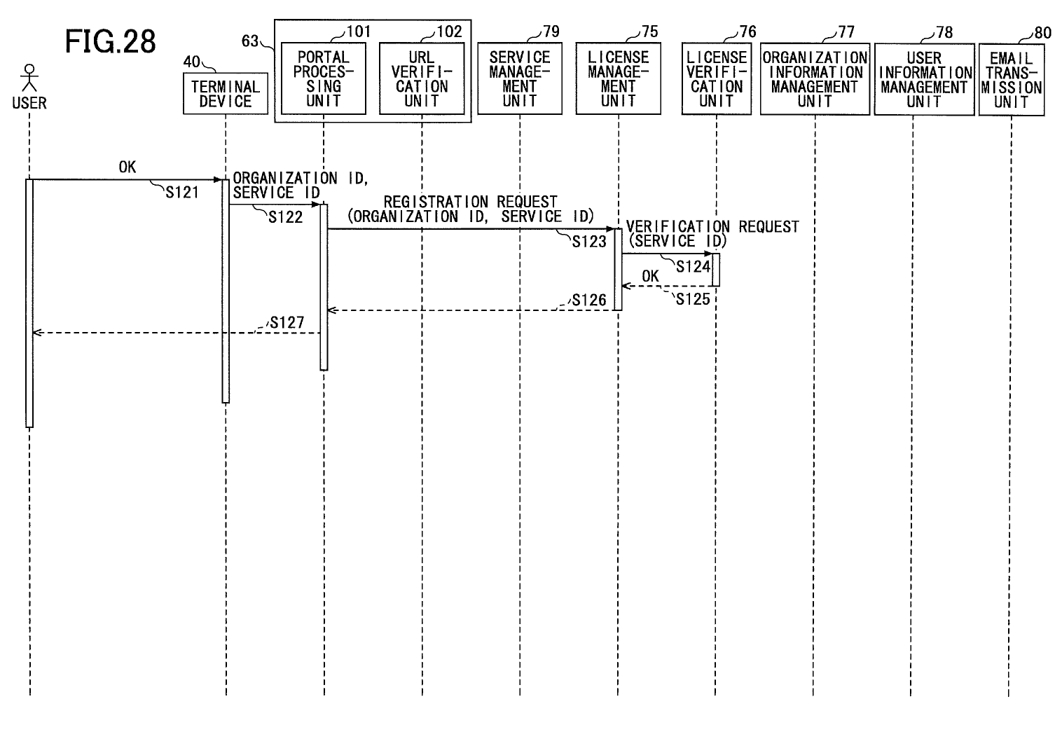

The administrator selects the check box 1092 to indicate agreement to the terms of service and presses the next button 1093 to display a next screen. FIG. 28 is a sequence chart (2/4) illustrating details of step S4 in FIG. 11. FIG. 28 includes a step of pressing the Next button 1093 and subsequent steps.

At step S121, the administrator confirms the terms-of-service corresponding to the service and the country on the terms-of-service screen 1090 and presses the Next button 1093. When the Next button 1093 is pressed, the terminal device 40 reports, at step S122, the organization ID and the service ID entered on the contracted service registration screen 1080 to the portal processing unit 101 of the portal service application 63. This report may be referred to as a “service registration request”.

At step S123, the portal processing unit 101 of the portal service application 63 sends the organization ID and the service ID reported from the terminal device 40 to the license management unit 75 and thereby requests the license management unit 75 to register the service. At step S124, the license management unit 75 requests the license verification unit 76 to verify the service ID. The license verification unit 76 determines that the service ID reported from the terminal device 40 is valid when the service ID is stored in a record (see FIG. 7B) of the license management information storage 93.

Here, it is assumed that the service ID reported from the terminal device 40 is valid. At step S125, the license verification unit 76 reports to the license management unit 75 that the service ID is valid. At step S126, the license management unit 75 registers the service ID in the license management information in association with the organization ID reported from the terminal device 40, and thereby activates the service corresponding to the service ID. The license management unit 75 may be configured to report to the ID management apparatus 37 that the service corresponding to the service ID has been activated.

Thus, with the process illustrated by FIGS. 25 and 28, it is possible to issue a license to an organization and to manage organization information and user information at a portal site that an administrator of the organization can log into. This in turn makes it possible for the administrator to activate a service by logging into the portal site and thereby eliminates the need to enter user information such as an email address each time.

Also with the process illustrated by FIGS. 25 and 28, it is possible to identify a country corresponding to an organization of a logged-in administrator, and to display terms of service corresponding to the country (i.e., to display different terms of service for different countries).

### SUMMARY

As described above, the system 1 of the first embodiment provides a mechanism that allows an administrator (or a user) of a group, which has made a contract for a service(s) with a sales company, to register information necessary to use the service in a service providing system without requesting a person at the sales company to register the information. In other words, the first embodiment makes it possible to easily register information necessary to use a service while using an existing sales channel and an existing business operation system.

That is, the system 1 of the first embodiment provides a standardized procedure that enables an administrator of an organization to easily activate a service after a contract for the service is made, and thereby makes it possible to maintain a business practice where a contract for a service to be linked with an apparatus is made between an organization that uses the apparatus and a sales company that sells the apparatus.

In the above embodiment, the organization ID is used as information (service subscriber identification information) for identifying a group of one or more users (service subscriber) to which a service is provided. In this sense, the process of registering an organization (organization registration process) is a process of registering a service subscriber. In the organization registration process, the user requests the service providing system 50 to register service subscriber identification information (e.g., organization ID). Then, a service ID of a service is registered in association with the registered service subscriber identification information to allow users identified by the service subscriber identification information to use the service.

The business operation system of the above embodiment may be referred to as a “license information issuance system”. Also, the organization ID may be referred to as “first license information”, the service ID may be referred to as “second license information”, and the organization registration URL may be referred to as “connection information”. Also, functional units or applications of the service providing system 50 that perform the process of step S3 may be collectively referred to as a “first registration unit”, and functional units or applications of the service providing system 50 that perform the process of step S4 may be collectively referred to as a “second registration unit”.

Further, the license management information storage 93 may be referred to as a “first storage”, the service management information storage 94 may be referred to as a “second storage”, and the URL information storage 103 may be referred to as a “third storage”.

An aspect of this disclosure provides a system, an information management method, and an information processing apparatus that make it possible to easily register information necessary to provide and use a service.

### Second Embodiment

### <System Configuration>

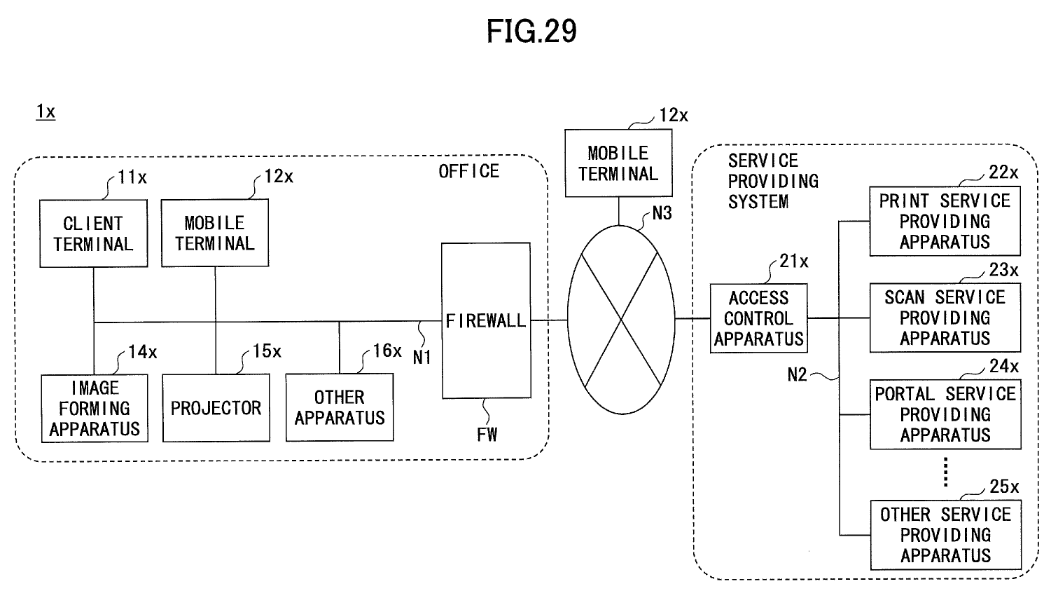

FIG. 29 is a drawing illustrating an exemplary configuration of a system 1x according to a second embodiment. As illustrated by FIG. 1, the system 1 may include a private network N1 such as an office network, a public network N2 such as a cloud service, and a network N3 such as the Internet.

The network N1 and the network N3 are connected to each other via a firewall FW provided for the network N1. The firewall FW is installed at a connecting point between the network N1 and the network N3 to relay access from the network N1 to the network N3.

The network N2 and the network N3 are connected to each other via an access control apparatus 21 provided for the network N2. The access control apparatus 21 maintains security of the network N2.

The network N1 is a private network behind the firewall FW. A client terminal 11x, a mobile terminal 12x, an image forming apparatus 14x such as a multifunction peripheral, a projector 15x, and an other apparatus 16x such as an electronic blackboard may be connected to the network N1.

The client terminal 11x is an example of a terminal device. The client terminal 11x may be implemented, for example, by an information processing apparatus (or a computer system) where a general-purpose operating system (OS) is installed. The client terminal 11x includes a wireless communication unit and/or a wired communication unit. Examples of the client terminal 11x include a tablet personal computer (PC) and a notebook PC that a user can operate.

The mobile terminal 12x is also an example of a terminal device. The mobile terminal 12x includes a wireless communication unit and/or a wired communication unit. Examples of the mobile terminal 12x include a smartphone, a cell phone, a tablet PC, and a notebook PC that a user can carry.

The image forming apparatus 14x may be any apparatus that includes an image forming function or performs an image forming process. The image forming apparatus 14x includes a wireless communication unit and/or a wired communication unit. Examples of the image forming apparatus 14x include a multifunction peripheral, a copier, a scanner, a printer, and a laser printer. The projector 15x projects an image. The projector 15x includes a wireless communication unit and/or a wired communication unit.

In the example of FIG. 29, one client terminal 11x, one mobile terminal 12x, one image forming apparatus 14x, one projector 15x, and one other apparatus 16x are connected to the network N1. However, two or more of each type of apparatus may be connected to the network N1.

The network N2 is connected via the access control apparatus 21x to the network N3 such as the Internet. The access control apparatus 21x, a print service providing apparatus 22x, a scan service providing apparatus 23x, a portal service providing apparatus 24x, and an other service providing apparatus 25x may be connected to the network N2. In the system 1x of FIG. 1, the access control apparatus 21x, the print service providing apparatus 22x, the scan service providing apparatus 23x, the portal service providing apparatus 24x, and the other service providing apparatus 25x constitute a service providing system.

The access control apparatus 21x controls processes for logging into services such as a print service provided by the print service providing apparatus 22x, a scan service provided by the scan service providing apparatus 23x, a portal service provided by the portal service providing apparatus 24x, and a service provided by the other service providing apparatus 25x.

The access control apparatus 21x, the print service providing apparatus 22x, the scan service providing apparatus 23x, the portal service providing apparatus 24x, and the other service providing apparatus 25x may be implemented by one or more information processing apparatuses (or computer systems).

In other words, the print service providing apparatus 22x, the scan service providing apparatus 23x, the portal service providing apparatus 24x, and the other service providing apparatus 25x of the system 1x of FIG. 29 may be implemented by one computer or two or more computers.

A part of the services provided by the service providing system (the network N2) may be provided by an apparatus on the network N1. Two or more mobile terminals 12x may be present in the system 1, and one or more of the mobile terminals 12x may be connected to a network other than the network N1. In the example of FIG. 29, one mobile terminal 12x is connected to the network N1 and one mobile terminal 12x is connected to the network N3 such as the Internet.

### <Hardware Configuration>

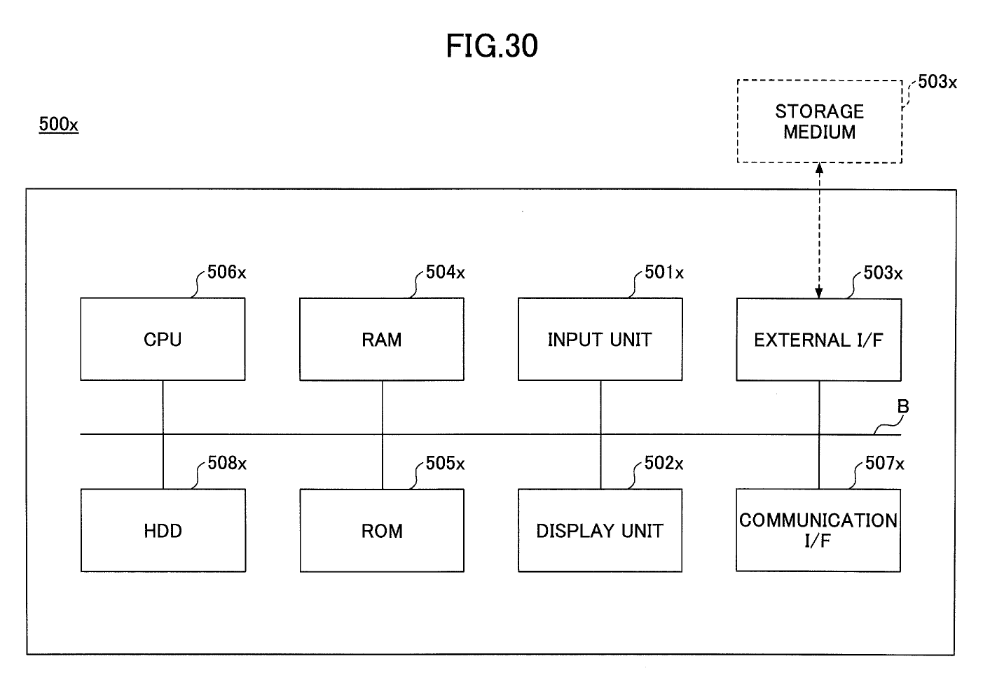

Each of the client terminal 11x, the mobile terminal 12x, the access control apparatus 21x, the print service providing apparatus 22x, the scan service providing apparatus 23x, the portal service providing apparatus 24x, and the other service providing apparatus 25x may be implemented by a computer system with a hardware configuration as described by FIG. 30. FIG. 30 is a block diagram illustrating an exemplary hardware configuration of a computer system 500x.

As illustrated by FIG. 30, the computer system 500x may include an input unit 501x, a display unit 502x, an external I/F 503x, a random access memory (RAM) 504x, a read only memory (ROM) 505x, a central processing unit (CPU) 506x, a communication I/F 507x, and a hard disk drive (HDD) 508x that are connected to each other via a bus B.

The input unit 501x includes, for example, a keyboard, a mouse, and a touch panel, and is used by a user to input instructions (or operation signals) to the computer system 500x. The display unit 502x displays, for example, processing results of the computer system 500x.

The communication I/F 507x is an interface for connecting the computer system 500x to one or more of the networks N1 through N3. The computer system 500x can perform data communications with other apparatuses via the communication I/F 507x.

The HDD 508x is a non-volatile storage device for storing various programs and data. For example, the HDD 508x stores basic software or an operating system (OS) for controlling the entire computer system 500x, and application software for providing various functions on the OS. The HDD 508x may manage the stored programs and data using a file system and/or a database (DB).

The external I/F 503x is an interface between the computer system 500x and an external device such as a storage medium 503x. The computer system 500x can read and write data from and to the storage medium 503x via the external I/F 503x. The storage medium 503x may be implemented by, for example, a flexible disk, a compact disk (CD), a digital versatile disk (DVD), a secure digital (SD) memory card, or a universal serial bus (USB) memory.

The ROM 505x is a non-volatile semiconductor memory (storage unit) that can retain programs and data even when power is turned off. For example, the ROM 505x stores programs and data such as a basic input/output system (BIOS) that is executed when the computer system 500x is turned on, and system and network settings of the computer system 500x. The RAM 504x is a volatile semiconductor memory (storage unit) for temporarily storing programs and data.

The CPU (processor) 506x loads programs and data from storage units (e.g., the HDD 508x and the ROM 505x) into the RAM 504x and executes the loaded programs to control the computer system 500x and to implement various functional units of the computer system 500x.

With the hardware configuration of the computer system 500x, the client terminal 11x, the mobile terminal 12x, the access control apparatus 21x, the print service providing apparatus 22x, the scan service providing apparatus 23x, the portal service providing apparatus 24x, and the other service providing apparatus 25x can perform various processes described later.

### <Software Configuration>

### [Terminal Device]

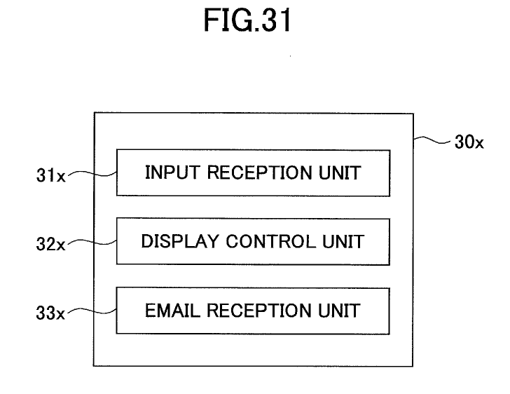

Each of terminal devices such as the client terminal 11 and the mobile terminal 12 may include functional units (or processing blocks) as described by FIG. 31. FIG. 31 is a block diagram illustrating an exemplary functional configuration of a terminal device 30x.

The terminal device 30x executes a program(s) and thereby implements an input reception unit 31x, a display control unit 32x, and an email reception unit 33x. The input reception unit 31x receives instructions and information from the user via the input unit 501x. For example, the user enters instructions and information by touching the touch panel or operating the keyboard. The display control unit 32x controls display of information on the display unit 502x. The email reception unit 33x receives email messages via the communication I/F 507x.

### [Service Providing System]

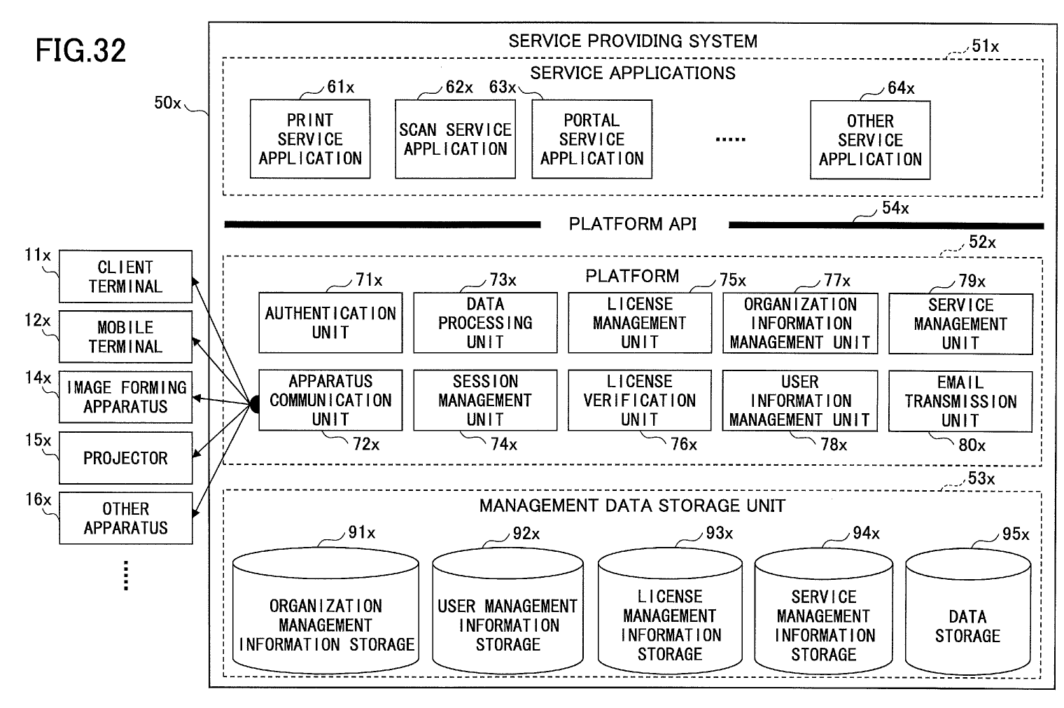

The service providing system of the second embodiment may include functional units (or processing blocks) as illustrated by FIG. 32. FIG. 32 is a block diagram illustrating an exemplary functional configuration of a service providing system 50x. The service providing system 50x of FIG. 32 implements service applications 51x, a platform 52x, a management data storage unit 53x, and a platform API (application programming interface) 54x by executing programs.

In the example of FIG. 32, the service applications 51x include a print service application 61x, a scan service application 62x, a portal service application 63x, and one or more other service applications 64x (which are hereafter expressed in the singular form for brevity). The print service application 61x provides a print service. The scan service application 62x provides a scan service. The portal service application 63x provides a portal service. The other service application 64x provides any other service.

The platform API 54x is an interface that enables the service applications 51x such as the print service application 61x, the scan service application 62x, the portal service application 63x, and the other service application 64x to use the platform 52x. In other words, the platform API 54x is a predefined interface that enables the platform 52x to receive requests from the service applications 51x, and may be implemented by functions or classes. When the service providing system 50x is implemented by (or distributed to) multiple information processing apparatuses, a Web API that is accessible via a network may be used as the platform API 154x.

In the example of FIG. 32, the platform 52 includes an authentication unit 71x, an apparatus communication unit 72x, a data processing unit 73x, session management unit 74x, a license management unit 75x, a license verification unit 76x, an organization information management unit 77x, a user information management unit 78x, a service management unit 79x, and an email transmission unit 80x.

The authentication unit 71x performs authentication in response to a login request from office equipment such as the client terminal 11x. The “office equipment” is a generic term indicating any one of the client terminal 11x, the mobile terminal 12x, the image forming apparatus 14x, the projector 15x, and the other apparatus 16x.

The apparatus communication unit 72x communicates with the office equipment. The data processing unit 73x performs data processing in response to requests from the service applications 51x. The session management unit 74x manages sessions with the office equipment.

The license management unit 75x manages license management information. The license verification unit 76x prevents unauthorized use of licenses based on the license management information. The organization information management unit 77x manages organization management information. The user information management unit 78x manages user management information. The service management unit 79x manages service management information. The email transmission unit 80x transmits email messages.

The management data storage unit 53x includes, for example, an organization management information storage 91x, a user management information storage 92x, a license management information storage 93x, a service management information storage 94x, and a data storage 95x.

The organization management information storage 91x stores organization management information. The user management information storage 92x stores user management information. The license management information storage 93x stores license management information. The service management information storage 94x stores services, countries or regions, and terms-of-service data in association with each other. The data storage 95x stores other data.

The platform 52x includes common functions or basic functions that are common to and used by the multiple service applications 51x. In the second embodiment, the authentication unit 71x, the apparatus communication unit 72x, the data processing unit 73x, the session management unit 74x, the license management unit 75x, the license verification unit 76x, the organization information management unit 77x, the user information management unit 78x, the service management unit 79x, and the email transmission unit 80x belong to the platform 52x. The functions of these units of the platform 52x are made public to the service applications 51x via the platform API 54x.

In other words, the service applications 51x can use the functions of these units that are made public by the platform API 54x. Services provided by the service providing system 50x may be used from the client terminal 11x, the mobile terminal 12x, the image forming apparatus 14x, and the projector 15x, and may also be used from other systems and apparatuses such as a conference system, an IC recorder, and a digital camera.

The classification of or the hierarchical relationship among the software components (or functional units) and the storages of the service providing system 50x illustrated by FIG. 32 is just an example, and such classification is not essential to implement the present embodiment. That is, as long as the office equipment such as the client terminal 11x, the mobile terminal 12x, the image forming apparatus 14x, and the projector 15x can be linked with the service applications 51x, the hierarchical relationship among the software components and the storages of the service providing system 50x may be determined freely.

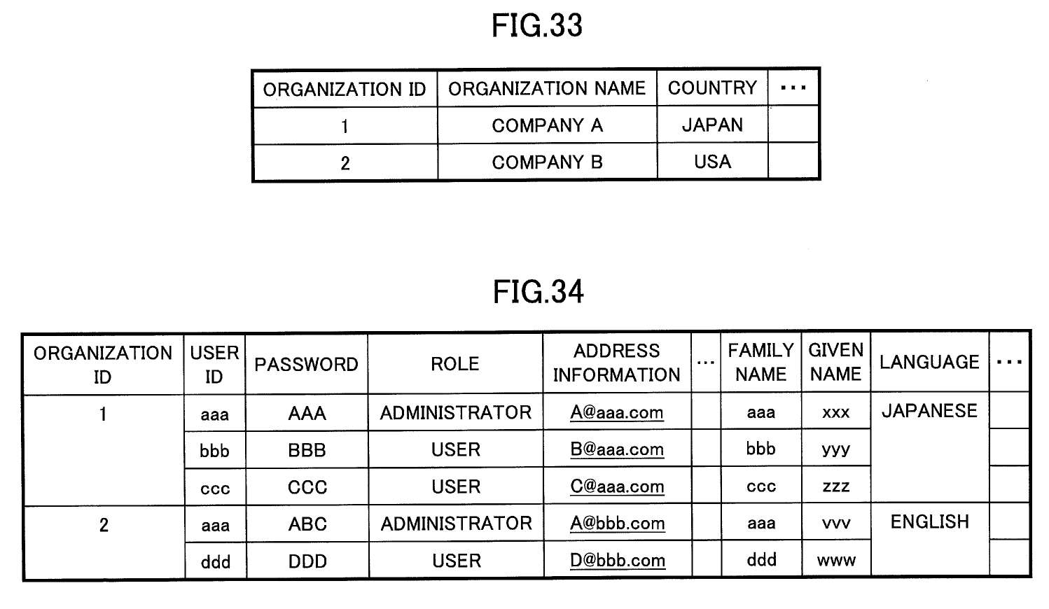

FIG. 33 is a table illustrating exemplary organization management information. The organization management information of FIG. 33 includes data items (or fields) such as an organization ID, an organization name, and a country. The organization ID is information for uniquely identifying a group such as a company or a department. The organization ID is not necessarily information for identifying an “organization”. For example, the organization ID may be information for identifying a contract. The organization name is a name of a group. The country indicates a country or a region where a service is used.

FIG. 34 is a table illustrating exemplary user management information. The user management information of FIG. 34 includes data items (or fields) such as an organization ID, a user ID, a password, a role, address information, a family name, a given name, and a language. In the user management information, records are grouped by (or associated with) organization IDs. The user ID and the password are used to identify a user at the service providing system 50x. The user ID may be represented by a user name. The password may be omitted.

Also, an electronic medium (e.g., an IC card) carried by the user may be used in place of the user ID. User IDs and passwords associated with the same organization ID are unique. On the other hand, the same user ID and password may be used for multiple users associated with different organization IDs. The role is information for identifying a “role” (e.g., administrator or end user) of the user. The address information indicates an email address of the user. One or more sets of address information may be contained in each record. The family name and the given name are those of the user. The language indicates a language used by the user.

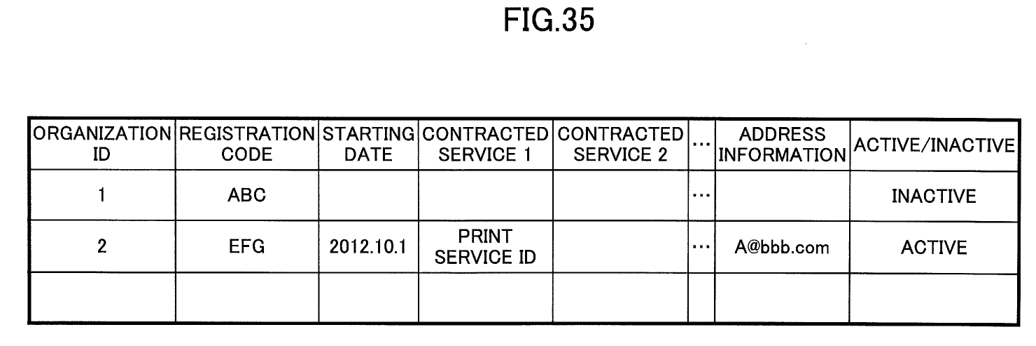

FIG. 35 is a table illustrating exemplary license management information. The license management information of FIG. 35 includes data items (or fields) such as an organization ID, a registration code, a starting date, one or more contracted services, address information, and active/inactive information.

The organization ID is provided, for example, to an administrator of an organization when a contract is made with the organization. Similarly, the registration code is provided, for example, to an administrator of an organization when a contract is made with the organization. The registration code is used to register an organization at the portal service (or to set up an account for the organization). Here, registration of an organization indicates a process of registering organization information and user information by using an organization ID and a registration code, which are provided by, for example, a sales company that has made a contract with the organization, to enable an administrator or a user of the organization to log into the service providing system 50.

The starting date indicates a date when an organization (or group) is registered by an administrator of the organization. In a record identified by an organization ID “1” in the license management information of FIG. 35, fields for the starting date and the contracted service(s) are blank because no organization has been registered in association with the organization ID “1”. The contracted service is information for identifying a service that is contracted (or subscribed) and activated by the organization. The address information indicates an email address of the administrator of the organization. The active/inactive information indicates whether the organization has been registered by the administrator (“active” indicates that the organization has been registered and “inactive” indicates that the organization has not been registered).

Thus, issued organization IDs and registration codes are registered in association with each other in the license management information. Initially, the registered organization IDs and registration codes are not associated with starting dates, contracted services, and address information. The license management unit 75x can determine whether an organization has been registered for an organization ID and a registration code by referring to the license management information.

### [Portal Service Application]

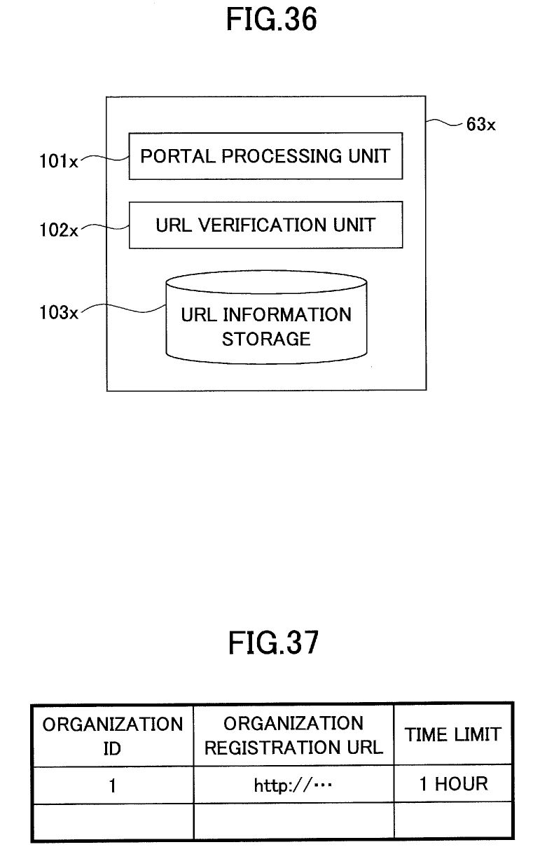

The portal service application 63x may include functional units (or processing blocks) as illustrated by FIG. 36. FIG. 36 is a block diagram illustrating an exemplary functional configuration of the portal service application 63x. The portal service application 63 causes the computer system 500x to function as a portal processing unit 101x, a URL verification unit 102x, and a URL information storage 103.

The portal processing unit 101x performs processes related to the portal service. Processes performed by the portal processing unit 101x are described later. The URL verification unit 102x generates an organization registration URL and stores the generated organization registration URL as URL information in the URL information storage 103x. When the terminal device 30x accesses an organization registration URL, the URL verification unit 102x verifies the accessed organization registration URL based on the URL information stored in the URL information storage 103x. FIG. 37 is a table illustrating exemplary URL information stored in the URL information storage 103x.

The URL information of FIG. 37 includes data items (or fields) such as an organization ID, an organization registration URL, and a time limit. The organization ID is provided, for example, to an administrator of an organization when a contract is made with the organization. The organization registration URL is used by the administrator to access an organization registration page from the terminal device 30x. The time limit indicates a period of time for which the organization registration URL is valid. The URL information of FIG. 37 associates the organization ID, the organization registration URL, and the time limit with each other.

<Processes Performed by System 1x>

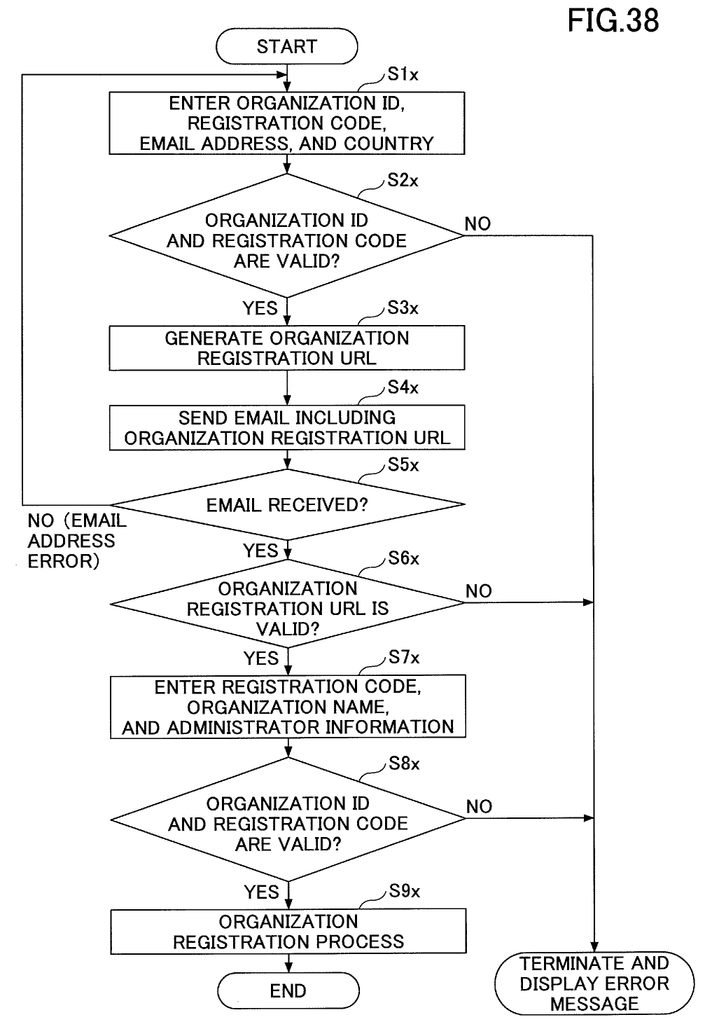

Exemplary processes performed by the system 1x are described below. Here, it is assumed that an organization has made a contract for a service with a sales company, and has received an organization ID and a registration code from the sales company. The organization ID and the registration code may be provided, for example, via mail, email, facsimile, or hand delivery to an administrator of the organization. FIG. 38 is a flowchart illustrating an exemplary process performed by the system 1x.

The administrator accesses a site of the service providing system 50x for registering the organization. Then, the portal processing unit 101x of the portal service application 63x of the service providing system 50x requests the terminal device 30x to display an initial registration screen. The initial registration screen includes, for example, fields for entering an organization ID, a registration code, an email address, and a country (or language).

At step S1x, the display control unit 32x of the terminal device 30x displays the initial registration screen on the display unit 502x. The administrator operates the input unit 501x of the terminal device 30x, and thereby enters an organization ID, a registration code, an email address, and a country on the initial registration screen. Then, the terminal device 30x reports the organization ID, the registration code, the email address, and the country entered on the initial registration screen to the portal service application 63x.

At step S2x, the portal processing unit 101x of the portal service application 63x requests the license management unit 75x to verify the organization ID and the registration code. The license management unit 75x requests the license verification unit 76x to verify the organization ID and the registration code. The license verification unit 76x determines that the organization ID and the registration code reported from the terminal device 30x are invalid when the organization ID and the registration code are not stored in association with each other in the license management information storage 93x.

When the organization ID and the registration code are invalid, the portal processing unit 101x requests the terminal device 30x to display an error message. The display control unit 32x of the terminal device 30x displays the error message and the process of FIG. 38 is terminated.

When the organization ID and the registration code are valid, the portal processing unit 101 proceeds to step S3x. At step S3x, the portal processing unit 101x requests the URL verification unit 102x to generate an organization registration URL. The URL verification unit 102x generates an organization registration URL and stores the generated organization registration URL in the URL information storage 103x.

At step S4x, the portal processing unit 101x receives the organization registration URL from the URL verification unit 102x. The portal processing unit 101x requests the email transmission unit 80x of the platform 52x to send an email message including the organization registration URL to the email address reported from the terminal device 30x at step S1x.

When the email address entered at step S1x by the administrator is correct, the email reception unit 33x of the terminal device 30x receives the email message from the service providing system 50x at step S5x. That is, the administrator can receive the email message from the service providing system 50x at step S5x when the email address entered at step S1x is correct.

One the other hand, when the email address entered at step S1x is incorrect, the administrator cannot proceed to step S6x. Thus, the service providing system 50x of the second embodiment sends the organization registration URL used to proceed to step S6x and perform the remaining process of FIG. 38 to the email address entered at step S1x. This configuration makes it possible to prevent a case where an organization registration completion report (described later) cannot be sent to the administrator due to an error in the entered email address. When there is an error in the entered email address, the administrator (or user) can restart the process from step S1x.

When the email message from the service providing system 50x is received at step S5x, the administrator proceeds to step S6x and accesses the organization registration URL written in the email message. The portal processing unit 101x of the service providing system 50x requests the URL verification unit 102x to verify the accessed organization registration URL. The URL verification unit 102x determines that the organization registration URL accessed by the terminal device 30x is invalid when the organization registration URL is not stored in the URL information storage 103x.

When the organization registration URL is invalid, the portal processing unit 101x requests the terminal device 30x to display an error message. The display control unit 32x of the terminal device 30x displays the error message and the process of FIG. 38 is terminated. Thus, the service providing system 50x is configured to verify the organization registration URL to prevent unauthorized access.

When the organization registration URL is valid, the portal processing unit 101 proceeds to step S7 and requests the terminal device 30x to display an organization registration screen. The display control unit 32x of the terminal device 30x displays the organization registration screen on the display unit 502x. The administrator operates the input unit 501x of the terminal device 30x, and thereby enters the registration code, an organization name, and administrator information (user information) on the organization registration screen. Then, the terminal device 30x reports the registration code, the organization name, and the administrator information (user information) entered on the organization registration screen to the portal service application 63x.

At step S8, the portal processing unit 101x of the portal service application 63x requests the license management unit 75x to verify the organization ID and the registration code. The license management unit 75x requests the license verification unit 76x to verify the organization ID and the registration code. The license verification unit 76x determines that the organization ID and the registration code reported from the terminal device 30x are invalid when the organization ID and the registration code are not stored in association with each other in the license management information storage 93x.

When the organization ID and the registration code are invalid, the portal processing unit 101x requests the terminal device 30x to display an error message. The display control unit 32x of the terminal device 30x displays the error message and the process of FIG. 38 is terminated. Thus, the service providing system 50x is configured to verify the organization ID and the registration code to prevent unauthorized access even when the email message is received by a malicious user.

When the organization ID and the registration code are valid, the portal processing unit 101x proceeds to step S9. At step S9, the portal processing unit 101x performs an organization registration process. In the organization registration process, the portal processing unit 101x requests the organization information management unit 77x to register organization management information, and requests the user information management unit 78x to register user management information. The organization information management unit 77x stores the organization management information in the organization management information storage 91x. The user information management unit 78x stores the user management information in the user management information storage 92x. As a result of the process from step S1 to S9, the administrator is enabled to log into the portal service application 63x of the service providing system 50x.

Users of the organization other than the administrator are registered in the user management information storage 92x of the service providing system 50x by the administrator who has logged into the portal service application 63x of the service providing system 50x, and are thereby enabled to log into the portal service application 63x of the service providing system 50x.

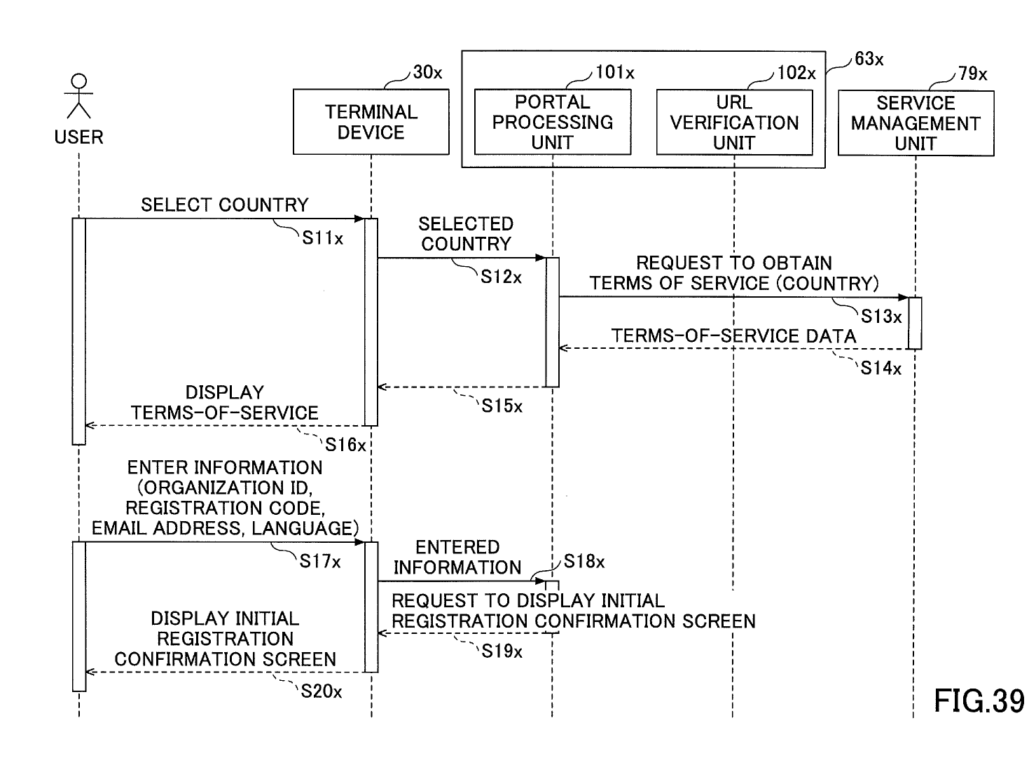

Details of steps in the flowchart of FIG. 38 are described below. FIG. 39 is a sequence chart (1/4) illustrating details of the process of FIG. 38.

After obtaining an organization ID and a registration code, the administrator accesses a site of the service providing system 50x. Then, the portal processing unit 101x of the portal service application 63x of the service providing system 50x requests the terminal device 30x to display a top screen 1000x.

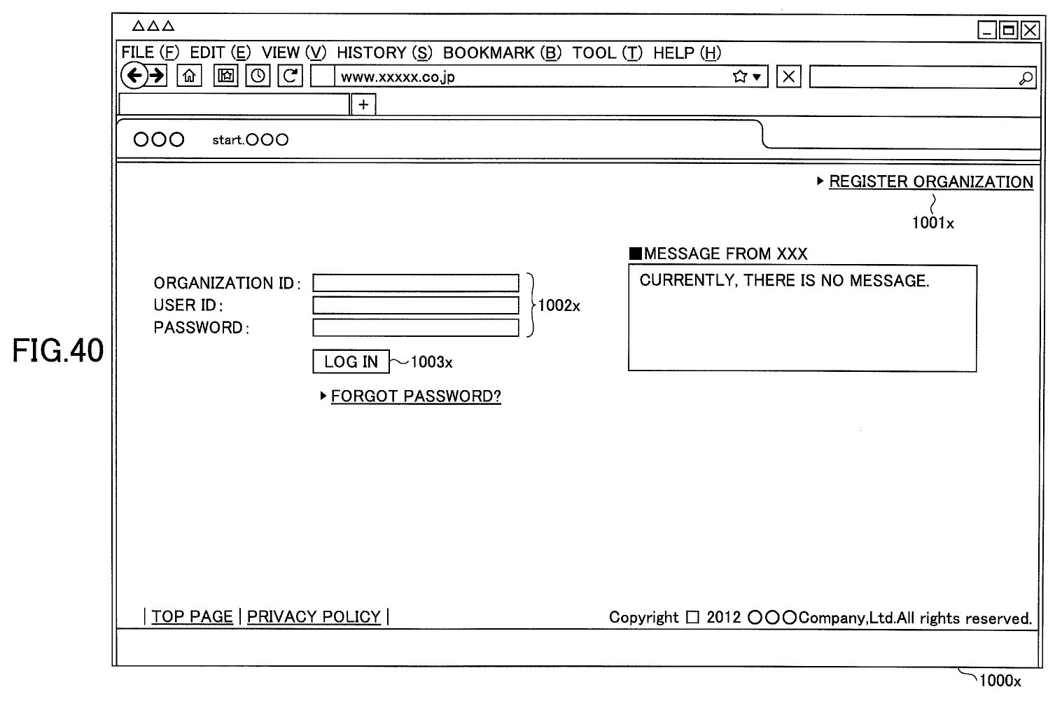

FIG. 40 is a drawing illustrating an exemplary top screen. The top screen 1000x includes a link 1001x to a site for registering an organization, an input field 1002x for entering an organization ID, a user ID, and a password used to log into the portal service application 63x, and a Login button 1003x. The display control unit 32x of the terminal device 30x displays the top screen 1000x on the display unit 502x.

The administrator operates the input unit 501x of the terminal device 30x to click (or select) the link 1001x on the top screen 1000x to move to a site for registering an organization. When the link 1001x is clicked, the portal processing unit 101x of the portal service application 63x of the service providing system 50x requests the terminal device 30x to display a terms-of-service screen 1010x.

Here, an administrator or a user registered in the user management information storage 92x can log into the portal service application 63x of the service providing system 50x by entering an organization ID, a user ID, and a password in the input field 1002x and clicking the Login button 1003x.

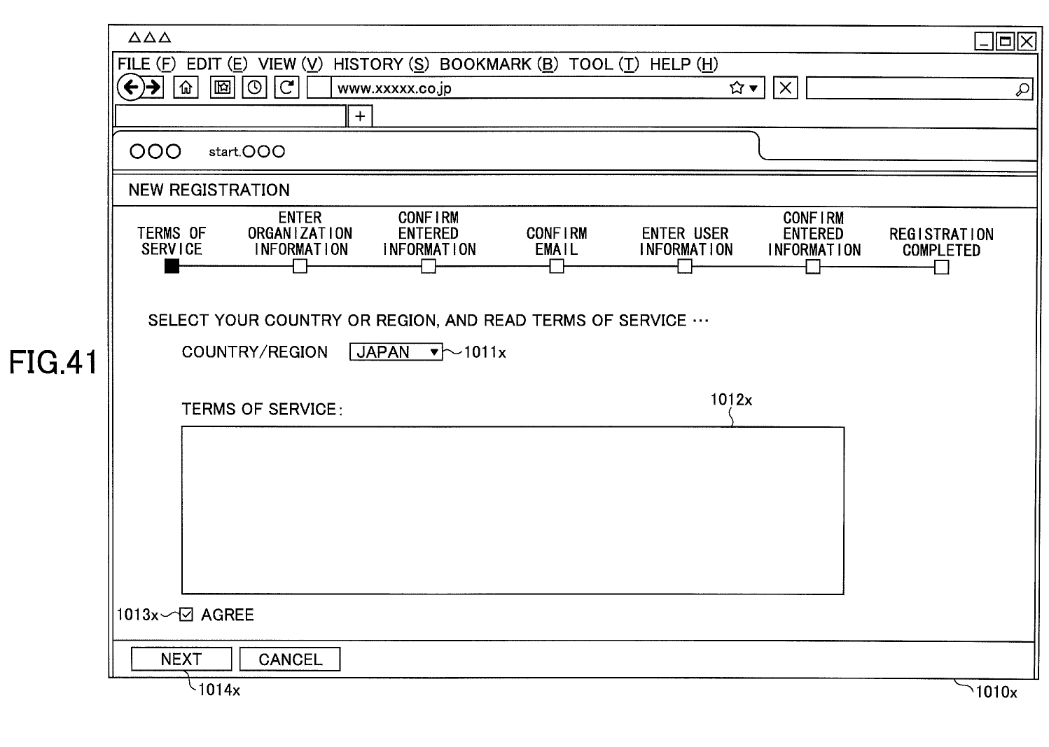

FIG. 41 is a drawing illustrating an exemplary terms-of-service screen. The terms-of-service screen 1010x includes a selection field 1011x for selecting a country or region where a service is used, a terms-of-service field 1012x for displaying terms of service, a check box 1013x used to indicate agreement to the terms of service, and a Next button 1014x to display a next screen.

At step S11x, the display control unit 32x of the terminal device 30x displays the terms-of-service screen 1010x on the display unit 502x. The administrator operates the input unit 501x of the terminal device 30x to select a country or a region (here, it is assumed that a country is selected) from the selection field 1011x on the terms-of-service screen 1010x. At step S12, the terminal device 30x reports the country selected on the terms-of-service screen 1010x to the portal processing unit 101x of the portal service application 63x.

At step S13x, the portal processing unit 101x requests the service management unit 79x to obtain terms-of-service data corresponding to the selected country. The service management unit 79x refers to the service management information stored in the service management information storage 94x and obtains terms-of-service data associated with the selected country. At step S14x, the portal processing unit 101x obtains the terms-of-service data associated with the selected country from the service management unit 79x.

At step S15x, the portal processing unit 101x requests the terminal device 30x to display the terms-of-service screen 1010x on which terms of service are displayed in the terms-of-service field 1012x based on the terms-of-service data associated with the selected country. The display control unit 32x of the terminal device 30x displays, on the display unit 502x, the terms-of-service screen 1010x on which the terms of service are displayed in the terms-of-service field 1012x based on the terms-of-service data associated with the selected country. At step S16x, the administrator checks the terms of service displayed in the terms-of-service field 1012x.

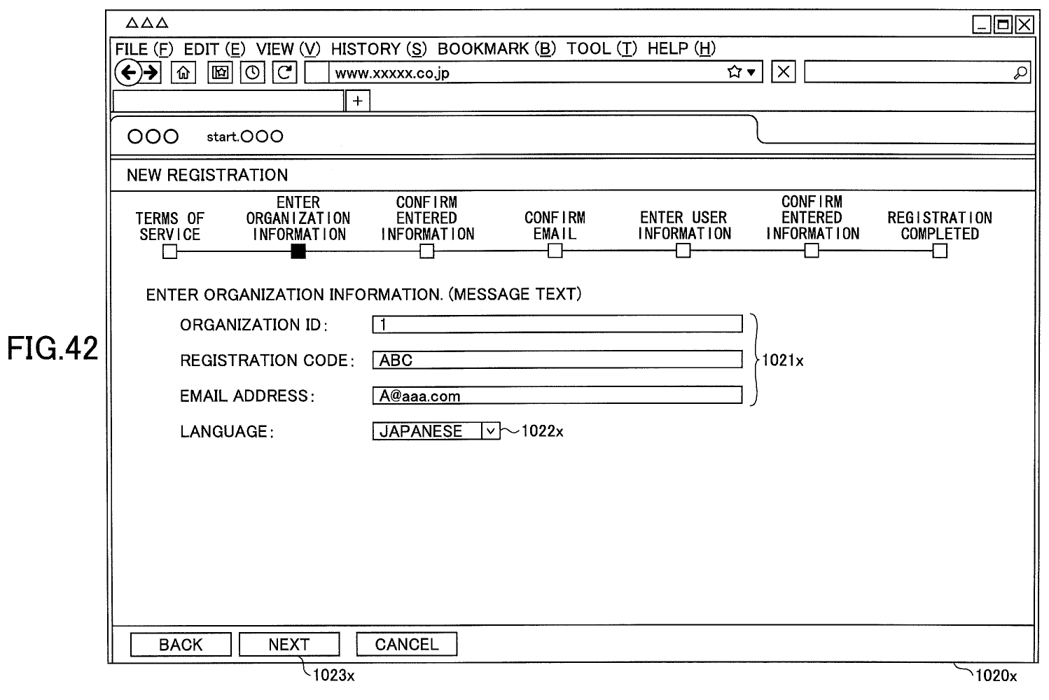

The administrator can display an initial registration screen 1020x on the display unit 502x by selecting the check box 1013x to indicate agreement to the terms of service and pressing the Next button 1014x. FIG. 42 is a drawing illustrating an exemplary initial registration screen.

The initial registration screen 1020x includes an input field 1021x for entering an organization ID, a registration code, and an email address, a selection field 1022x for selecting a language, and a Next button 1023x to display a next screen.

At step S17x, the display control unit 32x of the terminal device 30x displays the initial registration screen 1020x on the display unit 502x. The administrator operates the input unit 501x of the terminal device 30x to enter an organization ID, a registration code, and an email address in the input field 1021x on the initial registration screen 1020x and to select a language from the selection field 1022x, and then presses the Next button 1023x to display a next screen. At step S18x, the terminal device 30x reports the organization ID, the registration code, the email address, and the language entered and selected on the initial registration screen 1020x to the portal processing unit 101x of the portal service application 63x.

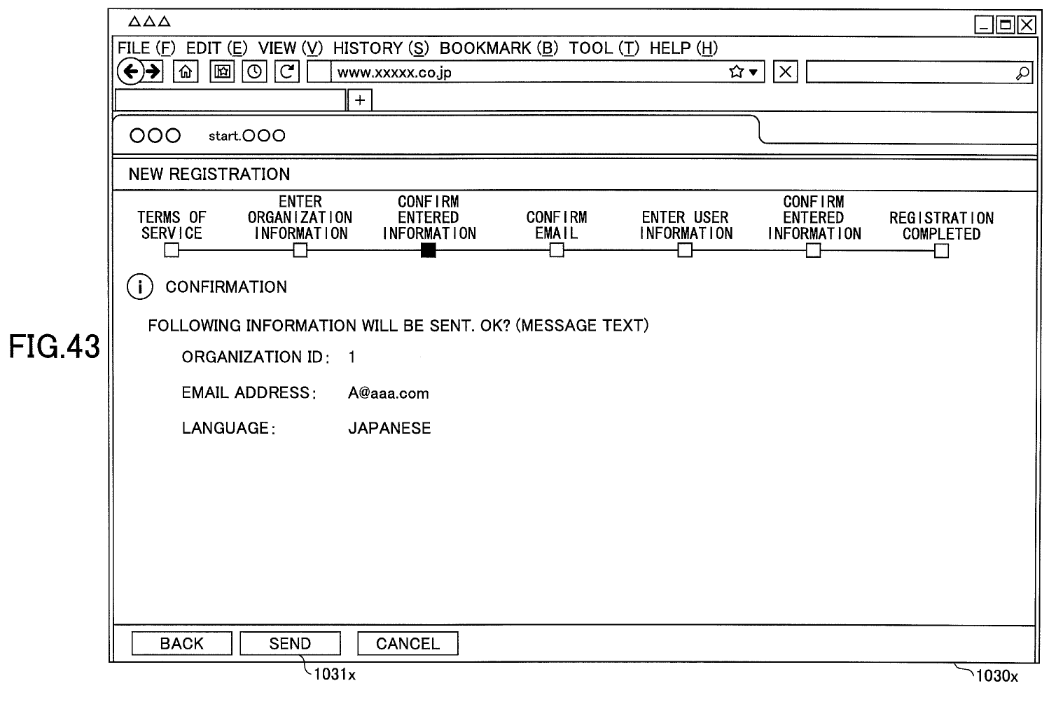

At step S19x, the portal processing unit 101x requests the terminal device 30x to display an initial registration confirmation screen 1030x. FIG. 43 is a drawing illustrating an exemplary initial registration confirmation screen. The initial registration confirmation screen 1030x displays the organization ID, the email address, and the language entered and selected on the initial registration screen 1020x of FIG. 42, and includes a Send button 1031x.

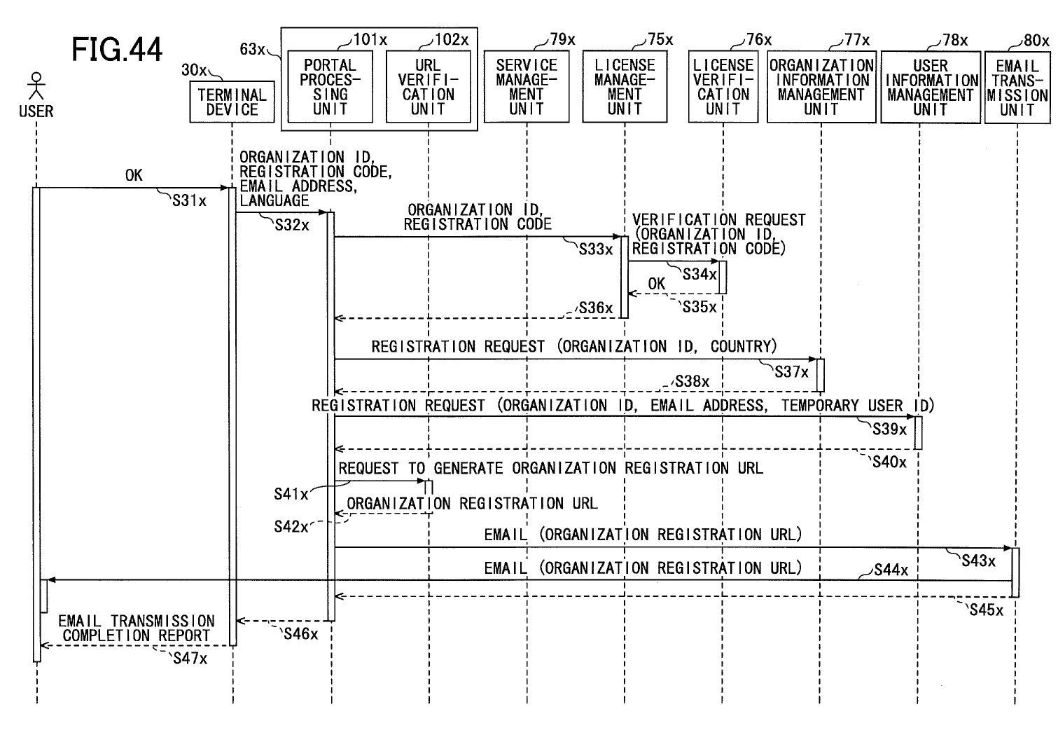

At step S20x, the display control unit 32x of the terminal device 30x displays the initial registration confirmation screen 1030x on the display unit 502x. On the initial registration confirmation screen 1030x, the administrator confirms the organization ID, the email address, and the language entered and selected on the initial registration screen 1020x, and presses the Send button 1031x. FIG. 44 is a sequence chart (2/4) illustrating details of the process of FIG. 38. FIG. 44 includes a step of pressing the Send button 1031x and subsequent steps.

At step S31x, on the initial registration confirmation screen 1030x, the administrator confirms the organization ID, the email address, and the language entered and selected on the initial registration screen 1020x, and presses the Send button 1031x.

When the Send button 1031x is pressed, the terminal device 30x reports, at step S32x, the organization ID, the registration code, the email address, and the language entered and selected on the initial registration screen 1020x to the portal processing unit 101x of the portal service application 63. This report may be referred to as an “initial registration request”.

At step S33x, the portal processing unit 101x of the portal service application 63x requests the license management unit 75x to verify the organization ID and the registration code reported from the terminal device 30x. At step S34x, the license management unit 75x requests the license verification unit 76x to verify the organization ID and the registration code. The license verification unit 76x determines that the organization ID and the registration code reported from the terminal device 30x are valid when the organization ID and the registration code are stored in association with each other in the license management information storage 93x as exemplified by FIG. 35.

Here, it is assumed that the organization ID and the registration code reported from the terminal device 30x are valid. At step S35x, the license verification unit 76x reports to the license management unit 75x that the organization ID and the registration code are valid. At step S36x, the license management unit 75 reports to the portal processing unit 101x that the organization ID and the registration code are valid.

At step S37x, the portal processing unit 101x requests the organization information management unit 77x to register the organization ID and the country reported from the terminal device 30x. The organization information management unit 77x stores the organization ID and the country reported from the terminal device 30x in association with each other in the organization management information storage 91x. At step S38x, the organization information management unit 77x sends a response to the portal processing unit 101x.

At step S39x, the portal processing unit 101x requests the user information management unit 78x to register the organization ID and the email address reported from the terminal device 30x and a temporary user ID. The user information management unit 78x stores the organization ID and the email address reported from the terminal device 30 and the temporary user ID in association with each other in the user management information storage 92x. At step S40x, the user information management unit 78x sends a response to the portal processing unit 101x.

At step S41x, the portal processing unit 101x requests the URL verification unit 102x to generate an organization registration URL. The URL verification unit 102x generates an organization registration URL and stores URL information as illustrated by FIG. 37 in the URL information storage 103x. At step S42x, the portal processing unit 101x receives the organization registration URL from the URL verification unit 102x.

At step S43x, the portal processing unit 101x generates an email message including the organization registration URL, and requests the email transmission unit 80x of the platform 52x to send the email message. At step S44x, the email transmission unit 80x sends the email message including the organization registration URL to the email address reported from the terminal device 30x. At step S45x, the email transmission unit 80x sends a response to the portal processing unit 101x. At step S46x, the portal processing unit 101x sends a response to the terminal device 30x.

Then, at step S47x, the display control unit 32x of the terminal device 30x displays an email transmission confirmation screen 1040x on the display unit 502x, and reports to the administrator that the transmission of the email message to the email address entered at step S17x has been completed.

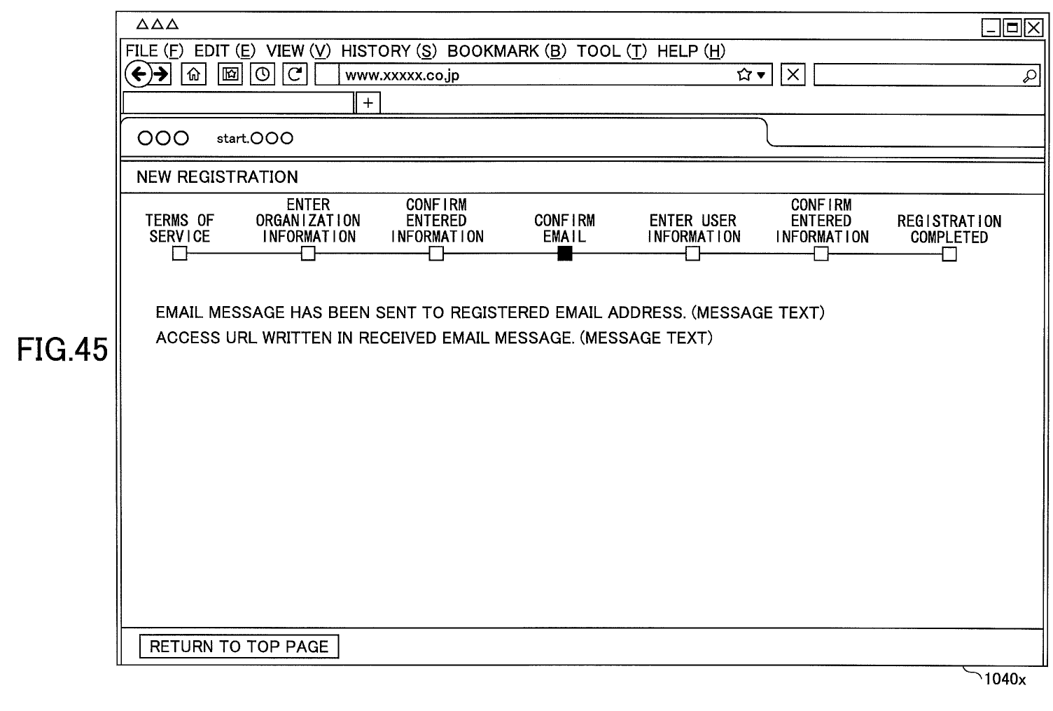

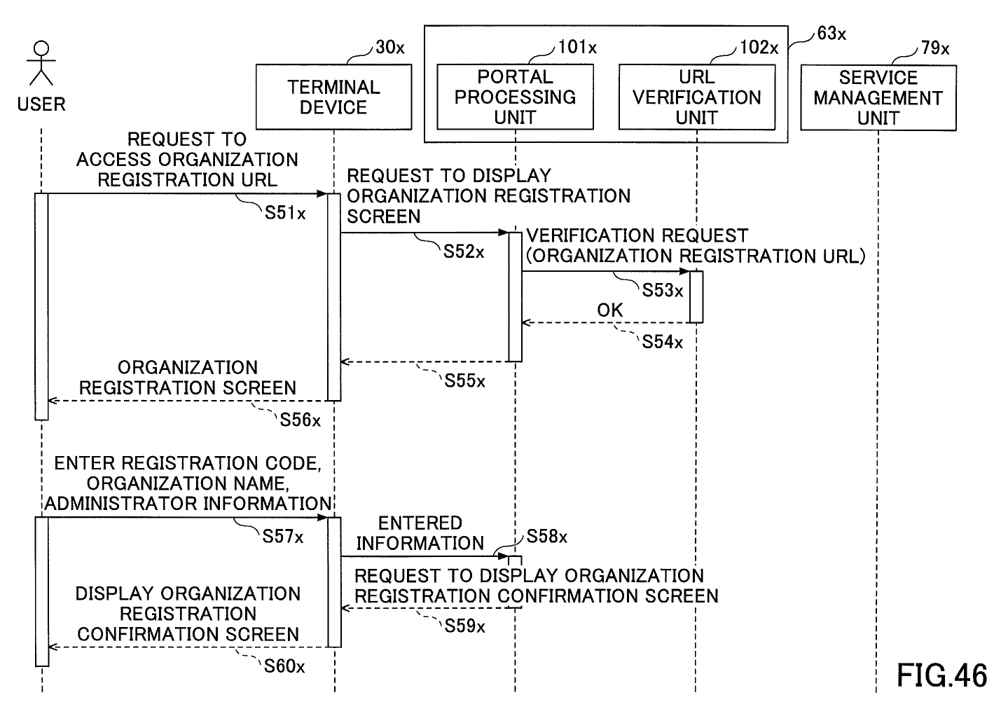

FIG. 45 is a drawing illustrating an exemplary email transmission confirmation screen. The email transmission confirmation screen 1040x includes a message indicating that the email message has been sent to the entered email address, and a message requesting the administrator to access the organization registration URL in the email message. FIG. 46 is a sequence chart (3/4) illustrating details of the process of FIG. 38. FIG. 46 includes a step of accessing the organization registration URL in the email message and subsequent steps.

The administrator operates the input unit 501x of the terminal device 30x to cause the email reception unit 33x to receive the email message from the service providing system 50x. At step S51x, the administrator operates the input unit 501x of the terminal device 30x to access the organization registration URL in the received email message. Here, it is assumed that the email message does not include at least one of the organization ID and the registration code. At step S52x, the terminal device 30x accesses the organization registration URL in the email message to display an organization registration screen 1050x.

At step S53x, the portal processing unit 101x of the service providing system 50x requests the URL verification unit 102x to verify the accessed organization registration URL. The URL verification unit 102x determines that the organization registration URL accessed by the terminal device 30x is valid when the organization registration URL is stored in the URL information storage 103x. Here, it is assumed that the accessed organization registration URL is valid.

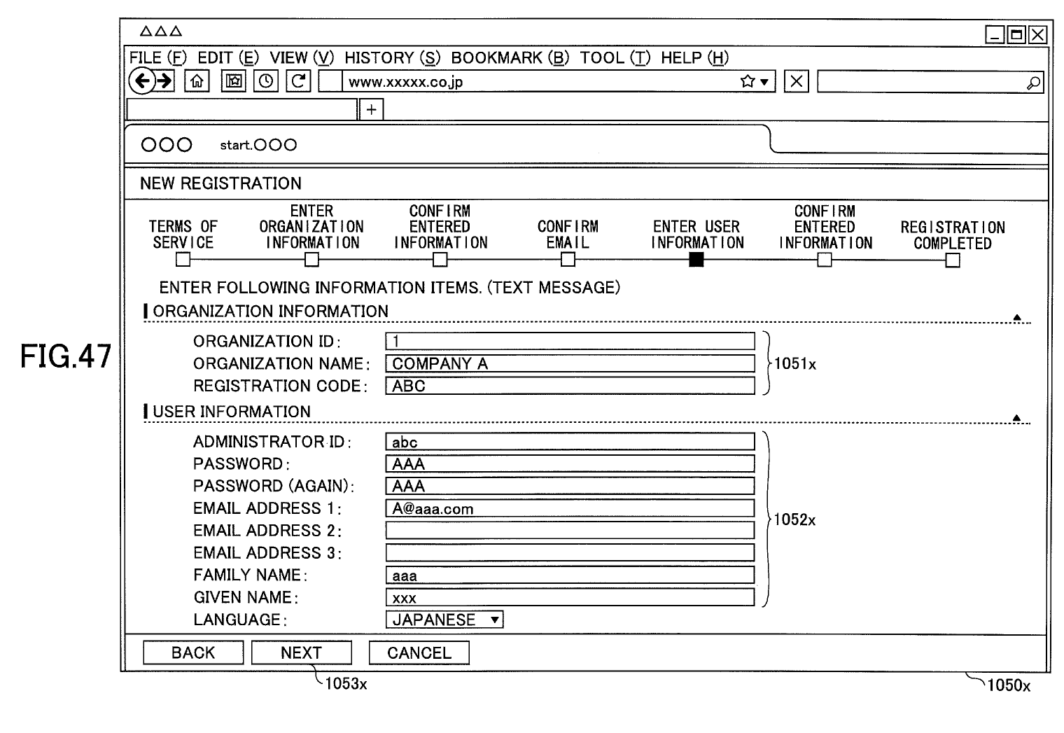

At step S54x, the URL verification unit 102x reports to the portal processing unit 101x that the accessed organization registration URL is valid. At step S55x, the portal processing unit 101x requests the terminal device 30x to display the organization registration screen 1050x as illustrated by FIG. 47. At step S56x, the display control unit 32x of the terminal device 30x displays the organization registration screen 1050x on the display unit 502x.

FIG. 47 is a drawing illustrating an exemplary organization registration screen. The organization registration screen 1050x includes an input field 1051x for entering organization information, an input field 1052x for entering user information, and a Next button 1053x to display a next screen. The input field 1051x includes input boxes for entering an organization ID, an organization name, and a registration code. The input field 1052x includes input boxes for entering an administrator ID (or user ID), a password, an email address, a family name, a given name, and a language.

The organization registration screen 1050x may be configured such that information such as an organization ID already entered by the administrator is automatically entered in the corresponding input box and displayed. Even in this case, it is preferable to make the administrator (or the user) manually enter one or both of the organization ID and the registration code not included in the received email message. This is because the combination of the organization ID and the registration code is used as authentication information to prevent unauthorized use of a license (a permit to use services).

At step S57x, the administrator operates the input unit 501x of the terminal device 30x to enter organization information and user information in the input field 1051x and the input field 1052x, and then presses the next button 1053x to display a next screen.

At step S58x, the terminal device 30x reports the organization information and the user information entered in the input field 1051x and the input field 1052x to the portal processing unit 101x of the portal service application 63x.

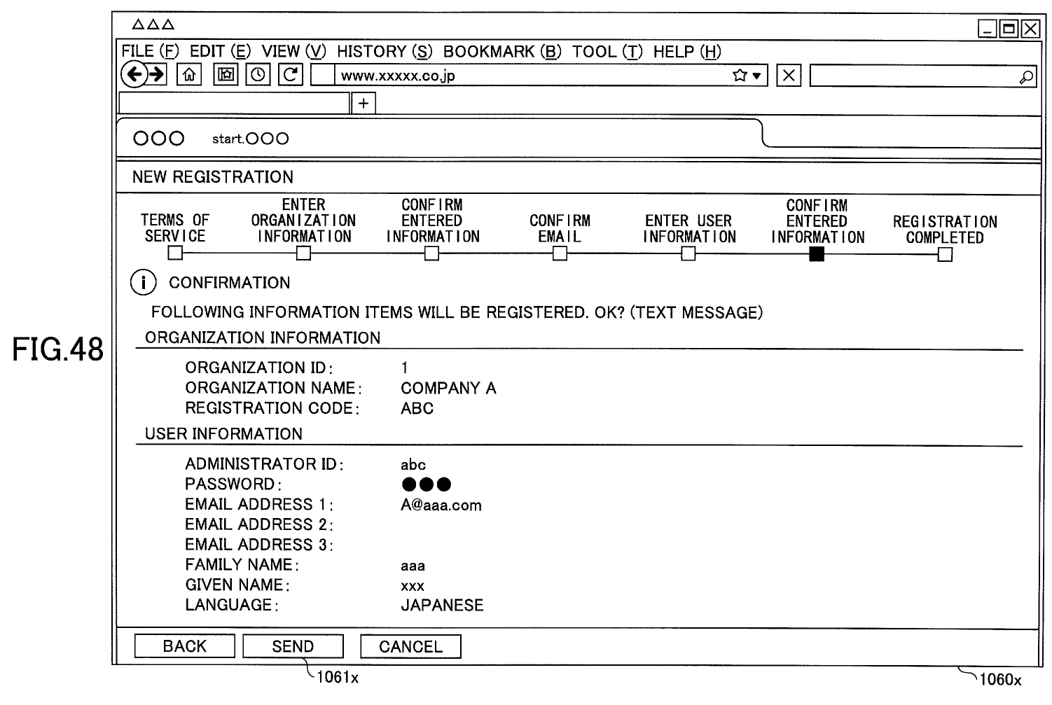

At step S59x, the portal processing unit 101x requests the terminal device 30x to display an organization registration confirmation screen 1060x. At step S60x, the display control unit 32x of the terminal device 30x displays the organization registration confirmation screen 1060x on the display unit 502x. FIG. 48 is a drawing illustrating an exemplary organization registration confirmation screen. The organization registration confirmation screen 1060x displays the organization information and the user information entered in the input field 1051x and the input field 1052x of the organization registration screen 1050x and includes a Send button 1061x.

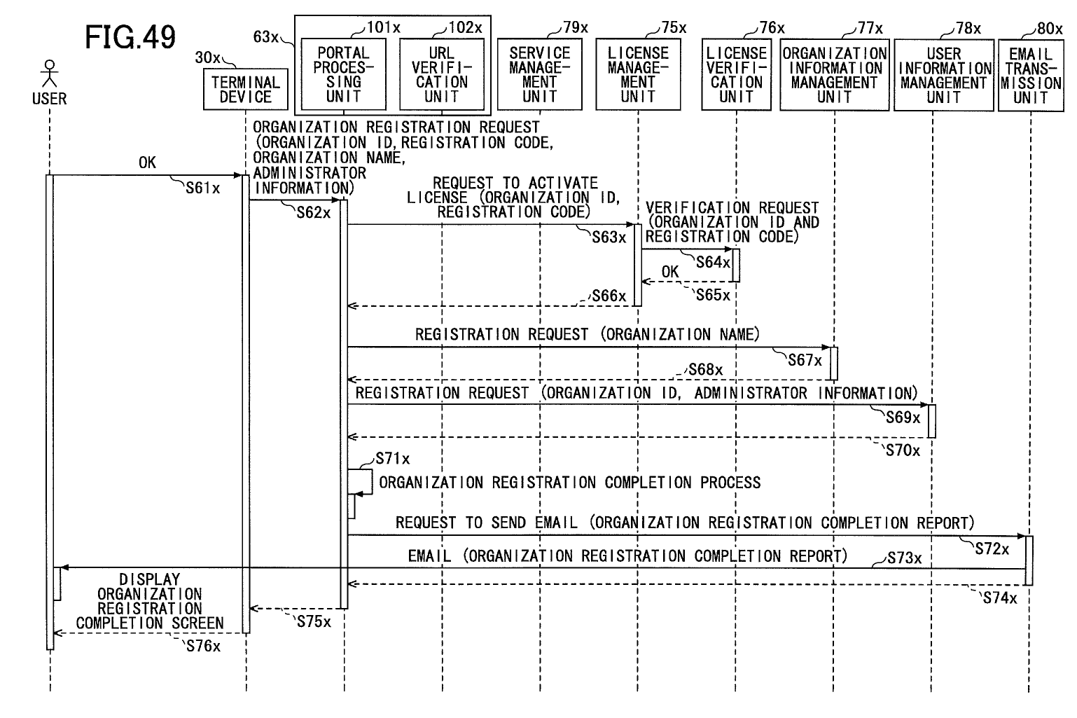

On the organization registration confirmation screen 1060x, the administrator confirms the organization information and the user information entered in the input field 1051x and the input field 1052x of the organization registration screen 1050x, and then presses the Send button 1061x. FIG. 49 is a sequence chart (4/4) illustrating details of the process of FIG. 38. FIG. 49 includes a step of pressing the Send button 1061x on the organization registration confirmation screen 1060x and subsequent steps.

At step S61x, on the organization registration confirmation screen 1060x, the administrator confirms the organization information and the user information entered in the input field 1051x and the input field 1052x of the organization registration screen 1050x, and then presses the Send button 1061x.

When the Send button 1061x is pressed, the terminal device 30x reports, at step S62x, the organization ID, the organization name, the registration code, and the user information (administrator information) entered on the organization registration screen 1050x to the portal processing unit 101x of the portal service application 63x to request registration of the organization. This report may be referred to as an “organization registration request”.

At step S63x, the portal processing unit 101x of the portal service application 63x requests the license management unit 75x to verify the organization ID and the registration code reported from the terminal device 30x. At step S64x, the license management unit 75x requests the license verification unit 76x to verify the organization ID and the registration code. The license verification unit 76x determines that the organization ID and the registration code reported from the terminal device 30x are valid when the organization ID and the registration code are stored in association with each other in the license management information storage 93x as exemplified by FIG. 35.

Here, it is assumed that the organization ID and the registration code reported from the terminal device 30x are valid. At step S65x, the license verification unit 76x reports to the license management unit 75x that the organization ID and the registration code are valid. At step S66x, the license management unit 75x reports to the portal processing unit 101x that the organization ID and the registration code are valid.

At step S67x, the portal processing unit 101x requests the organization information management unit 77x to register the organization name reported from the terminal device 30x. The organization information management unit 77x stores the organization name reported from the terminal device 30x in the organization management information storage 91x in association with the corresponding organization ID. At step S68x, the organization information management unit 77x sends a response to the portal processing unit 101x.

At step S69x, the portal processing unit 101x requests the user information management unit 78x to register the organization ID and the administrator information reported from the terminal device 30x. The user information management unit 78x stores the organization ID and the administrator information reported from the terminal device 30x in association with each other in the user management information storage 92x. At step S70x, the user information management unit 78x sends a response to the portal processing unit 101x. At step S71x, the portal processing unit 101x performs an organization registration completion process.

At step S72x, the portal processing unit 101x generates an email message including an organization registration completion report, and requests the email transmission unit 80x of the platform 52x to send the email message. At step S73x, the email transmission unit 80x sends the email message including the organization registration completion report to the email address reported from the terminal device 30x. At step S74x, the email transmission unit 80x sends a response to the portal processing unit 101x. At step S75x, the portal processing unit 101x sends a response to the terminal device 30x.

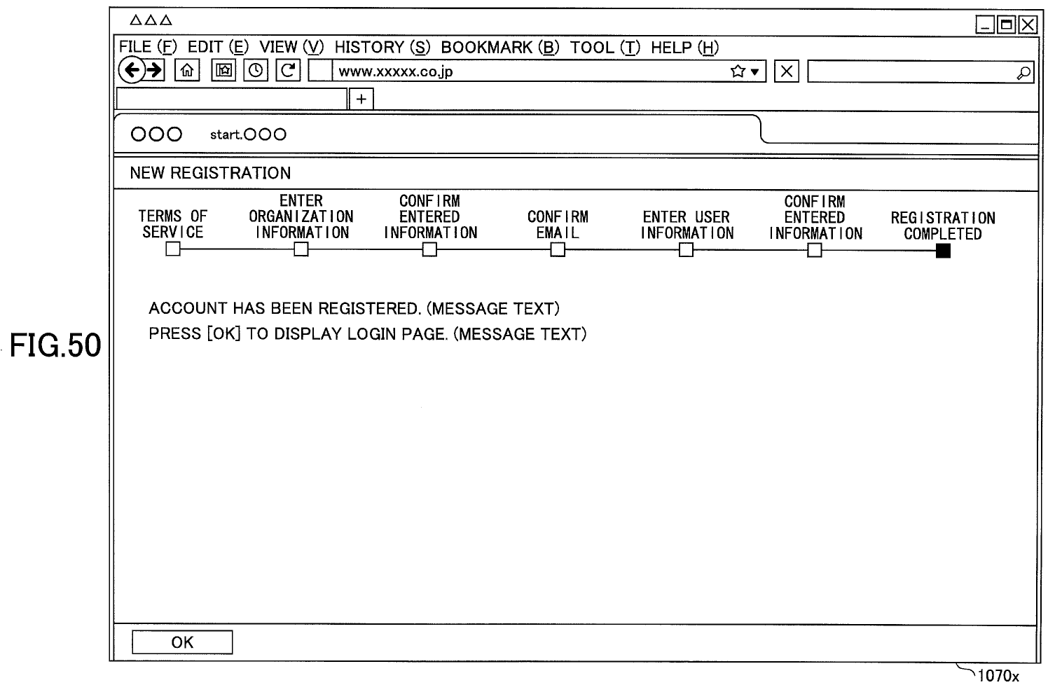

Then, at step S76x, the display control unit 32x of the terminal device 30x displays an organization registration completion screen 1070x on the display unit 502x, and reports to the administrator that the registration of the organization has been completed. FIG. 50 is a drawing illustrating an exemplary organization registration completion screen. The organization registration completion screen 1070x of FIG. 50 includes a message indicating that the registration of the organization has been completed and an account has been registered.

### SUMMARY

As described above, the system 1x of the second embodiment provides a standardized procedure that enables an administrator of an organization to easily introduce a service after a contract for the service is made, and thereby makes it possible to maintain a business practice where a contract for a service to be linked with an apparatus is made between an organization that uses the apparatus and a sales company that sells the apparatus. The system 1x of the second embodiment also enables an administrator of an organization to restart a process for introducing a service from the beginning when there is an error in an email address entered by the administrator. This mechanism also makes it possible to prevent unauthorized access.

The organization ID in the above embodiment may be referred to as “organization identification information”, the registration code may be referred to as “organization registration authentication information”, the organization registration URL may be referred to as “connection information” used to connect to an registration request screen, the user ID may be referred to as “user identification information”, and the password may be referred to as “connection authentication information”. Also, the license management information storage 93x may be referred to as a “first storage”, the service management information storage 94x may be referred to as a “second storage”, and the URL information storage 103x may be referred to as a “third storage”.

An aspect of this disclosure provides an information processing apparatus, a system, and an information registration method make it possible to efficiently provide services.

An aspect of this disclosure provides an information processing apparatus that provides a service to an apparatus connected via a network to the information processing apparatus. The information processing apparatus may include a first reception unit that receives an initial registration request including organization identification information, organization registration authentication information, and address information of a user; a connection information reporting unit that reports connection information used to connect to a registration request screen to the user based on the address information when the organization identification information and the organization registration authentication information in the initial registration request are valid are valid; a second reception unit that receives a connection request requesting to connect to the registration request screen based on the connection information, and accepts an organization registration request including the organization identification information, the organization registration authentication information, and user information when the connection information is valid; and a registration unit that registers organization management information and user management information based on the organization identification information and the user information in the organization registration request when the organization identification information and the organization registration authentication information in the organization registration request are valid.

The information processing apparatus may also include a first determination unit that determines that the organization identification information and the organization registration authentication information in the initial registration request or the organization registration request are valid when the organization identification information and the organization registration authentication information are stored in association with each other in a first storage.

The first reception unit may include a service management unit that obtains, from a second storage storing terms of service in association with countries or regions, the terms of service associated with a country or a region selected by the user; a terms-of-service display unit that causes a terminal device operated by the user to display the obtained terms of service; and an initial registration reception unit that receives, from the terminal device, the initial registration request including the organization identification information, the organization registration authentication information, the address information of the user, and information indicating the country or the region selected by the user.

The second reception unit may include a second determination unit that determines that the connection information is valid when the connection information used to connect to the registration request screen is stored in a third storage.

The third storage may store the connection information and a time limit of the connection information in association with each other.

The registration unit may be configured to register the organization management information in an organization management information storage based on the organization identification information in the organization registration request, and to register the user management information in a user management information storage based on the organization identification information and the user information in the organization registration request.

The user information may include user identification information and connection authentication information.

Another aspect of this disclosure provides a system where an apparatus that uses a service and an information processing apparatus that provides the service are connected to each other via a network. The information processing apparatus may include a first reception unit that receives an initial registration request including organization identification information, organization registration authentication information, and address information of a user; a connection information reporting unit that reports connection information used to connect to a registration request screen to the user based on the address information when the organization identification information and the organization registration authentication information in the initial registration request are valid; a second reception unit that receives a connection request requesting to connect to the registration request screen based on the connection information, and accepts an organization registration request including the organization identification information, the organization registration authentication information, and user information when the connection information is valid; and a registration unit that registers organization management information and user management information based on the organization identification information and the user information in the organization registration request when the organization identification information and the organization registration authentication information in the organization registration request are valid.

Still another aspect of this disclosure provides an information registration method performed by an information processing apparatus that provides a service to an apparatus connected to the information processing apparatus via a network. The information registration method may include receiving an initial registration request including organization identification information, organization registration authentication information, and address information of a user; reporting connection information used to connect to a registration request screen to the user based on the address information when the organization identification information and the organization registration authentication information in the initial registration request are valid; receiving a connection request requesting to connect to the registration request screen based on the connection information and accepting an organization registration request including the organization identification information, the organization registration authentication information, and user information when the connection information is valid; and registering organization management information and user management information based on the organization identification information and the user information in the organization registration request when the organization identification information and the organization registration authentication information in the organization registration request are valid.

### Third Embodiment

### <System Configuration>

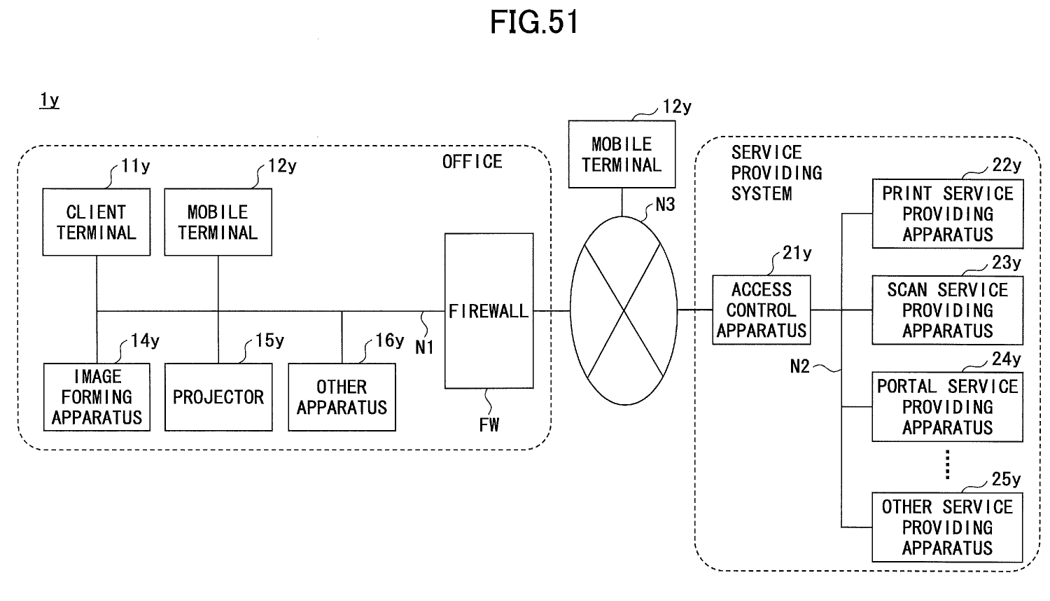

FIG. 51 is a drawing illustrating an exemplary configuration of a system 1y according to a third embodiment. As illustrated by FIG. 51, the system 1y may include a private network N1 such as an office network, a public network N2 such as a cloud service, and a network N3 such as the Internet.

The network N1 and the network N3 are connected to each other via a firewall FW provided for the network N1. The firewall FW is installed at a connecting point between the network N1 and the network N3 to relay access from the network N1 to the network N3.

The network N2 and the network N3 are connected to each other via an access control apparatus 21y provided for the network N2. The access control apparatus 21y maintains security of the network N2.

The network N1 is a private network behind the firewall FW. A client terminal 11y, a mobile terminal 12y, an image forming apparatus 14y such as a multifunction peripheral, a projector 15y, and an other apparatus 16y such as an electronic blackboard may be connected to the network N1.

The client terminal 11y is an example of a terminal device. The client terminal 11y may be implemented, for example, by an information processing apparatus (or a computer system) where a general-purpose operating system (OS) is installed. The client terminal 11y includes a wireless communication unit and/or a wired communication unit. Examples of the client terminal 11y include a tablet personal computer (PC) and a notebook PC that a user can operate.

The mobile terminal 12y is also an example of a terminal device. The mobile terminal 12y includes a wireless communication unit and/or a wired communication unit. Examples of the mobile terminal 12y include a smartphone, a cell phone, a tablet PC, and a notebook PC that a user can carry.

The image processing apparatus 14y may be any apparatus (e.g., a multifunction peripheral) that includes an image forming function or performs an image forming process. The image forming apparatus 14y includes a wireless communication unit and/or a wired communication unit. Examples of the image forming apparatus 14y include a multifunction peripheral, a copier, a scanner, a printer, and a laser printer. The projector 15 projects an image. The projector 15 includes a wireless communication unit and/or a wired communication unit.

In the example of FIG. 51, one client terminal 11y, one mobile terminal 12y, one image forming apparatus 14y, one projector 15, and one other apparatus 16y are connected to the network N1. However, two or more of each type of apparatus may be connected to the network N1.

The network N2 is connected via the access control apparatus 21y to the network N3 such as the Internet. The access control apparatus 21y, a print service providing apparatus 22y, a scan service providing apparatus 23y, a portal service providing apparatus 24y, and an other service providing apparatus 25y may be connected to the network N2. In the system 1y of FIG. 51, the access control apparatus 21y, the print service providing apparatus 22y, the scan service providing apparatus 23y, the portal service providing apparatus 24y, and the other service providing apparatus 25y constitute a service providing system.

The access control apparatus 21y controls processes for logging into services such as a print service provided by the print service providing apparatus 22y, a scan service provided by the scan service providing apparatus 23y, a portal service provided by the portal service providing apparatus 24y, and a service provided by the other service providing apparatus 25y.

The access control apparatus 21y, the print service providing apparatus 22y, the scan service providing apparatus 23y, the portal service providing apparatus 24y, and the other service providing apparatus 25y may be implemented by one or more information processing apparatuses (or computer systems).

In other words, the print service providing apparatus 22y, the scan service providing apparatus 23y, the portal service providing apparatus 24y, and the other service providing apparatus 25y of the system 1y of FIG. 51 may be implemented by one computer or two or more computers.

A part of the services provided by the service providing system (the network N2) may be provided by an apparatus on the network N1. Two or more mobile terminals 12y may be present in the system 1y, and one or more of the mobile terminals 12y may be connected to a network other than the network N1. In the example of FIG. 51, one mobile terminal 12y is connected to the network N1 and one mobile terminal 12y is connected to the network N3 such as the Internet.

### <Hardware Configuration>

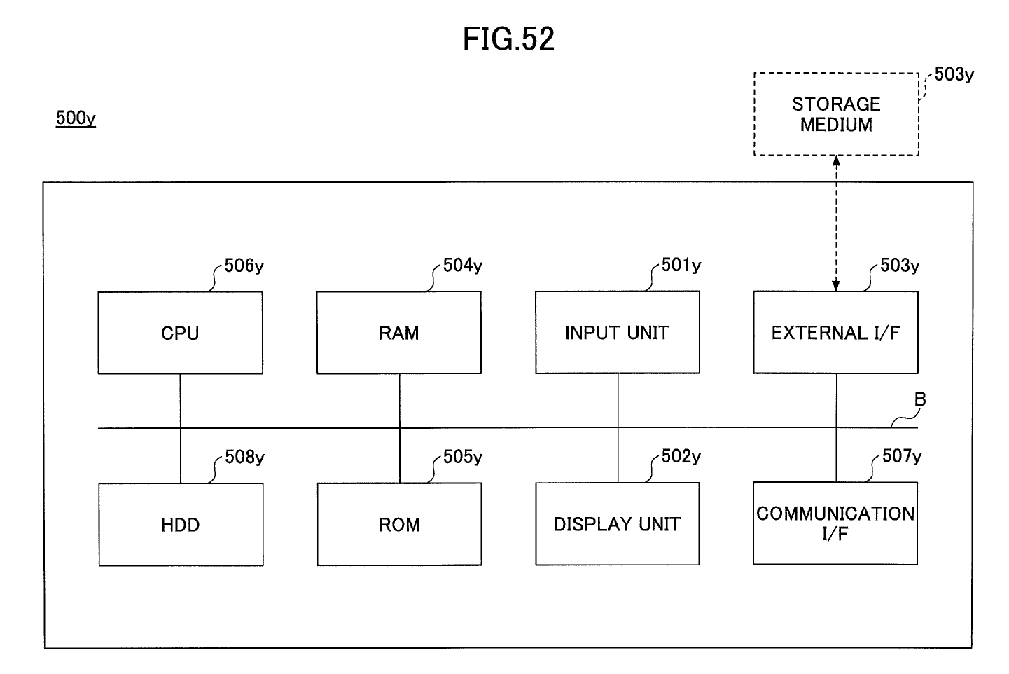

Each of the client terminal 11y, the mobile terminal 12y, the access control apparatus 21y, the print service providing apparatus 22y, the scan service providing apparatus 23y, the portal service providing apparatus 24y, and the other service providing apparatus 25y may be implemented by a computer system with a hardware configuration as described by FIG. 52. FIG. 52 is a block diagram illustrating an exemplary hardware configuration of a computer system 500y.

As illustrated by FIG. 52, the computer system 500y may include an input unit 501y, a display unit 502y, an external I/F 503y, a random access memory (RAM) 504y, a read only memory (ROM) 505y, a central processing unit (CPU) 506y, a communication I/F 507y, and a hard disk drive (HDD) 508y that are connected to each other via a bus B.

The input unit 501y includes, for example, a keyboard, a mouse, and a touch panel, and is used by a user to input instructions (or operation signals) to the computer system 500y. The display unit 502y displays, for example, processing results of the computer system 500y.

The communication I/F 507y is an interface for connecting the computer system 500y to one or more of the networks N1 through N3. The computer system 500y can perform data communications with other apparatuses via the communication I/F 507y.

The HDD 508y is a non-volatile storage device for storing various programs and data. For example, the HDD 508y stores basic software or an operating system (OS) for controlling the entire computer system 500y, and application software for providing various functions on the OS. The HDD 508y may manage the stored programs and data using a file system and/or a database (DB).

The external I/F 503y is an interface between the computer system 500y and an external device such as a storage medium 503y. The computer system 500y can read and write data from and to the storage medium 503y via the external I/F 503y. The storage medium 503y may be implemented by, for example, a flexible disk, a compact disk (CD), a digital versatile disk (DVD), a secure digital (SD) memory card, or a universal serial bus (USB) memory.

The ROM 505y is a non-volatile semiconductor memory (storage unit) that can retain programs and data even when power is turned off. For example, the ROM 505y stores programs and data such as a basic input/output system (BIOS) that is executed when the computer system 500y is turned on, and system and network settings of the computer system 500y. The RAM 504y is a volatile semiconductor memory (storage unit) for temporarily storing programs and data.

The CPU (processor) 506y loads programs and data from storage units (e.g., the HDD 508y and the ROM 505y) into the RAM 504y and executes the loaded programs to control the computer system 500y and to implement various functional units of the computer system 500y.

With the hardware configuration of the computer system 500y, the client terminal 11y, the mobile terminal 12y, the access control apparatus 21y, the print service providing apparatus 22y, the scan service providing apparatus 23y, the portal service providing apparatus 24y, and the other service providing apparatus 25y can perform various processes described later.

### <Software Configuration>

### [Terminal Device]

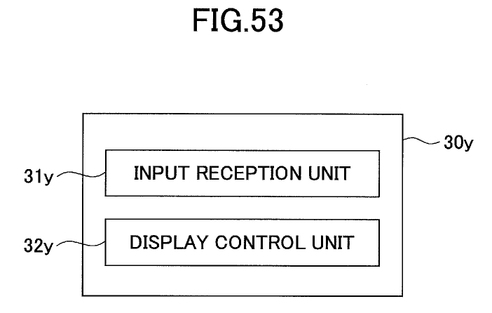

Each of terminal devices such as the client terminal 11y and the mobile terminal 12y may include functional units (or processing blocks) as described by FIG. 53. FIG. 53 is a block diagram illustrating an exemplary functional configuration of a terminal device 30y.

The terminal device 30y executes a program(s) and thereby implements an input reception unit 31y and a display control unit 32y. The input reception unit 31y receives instructions and information from the user via the input unit 501y. For example, the user enters instructions and information by touching the touch panel or operating the keyboard. The display control unit 32y controls display of information on the display unit 502y.

### [Service Providing System]

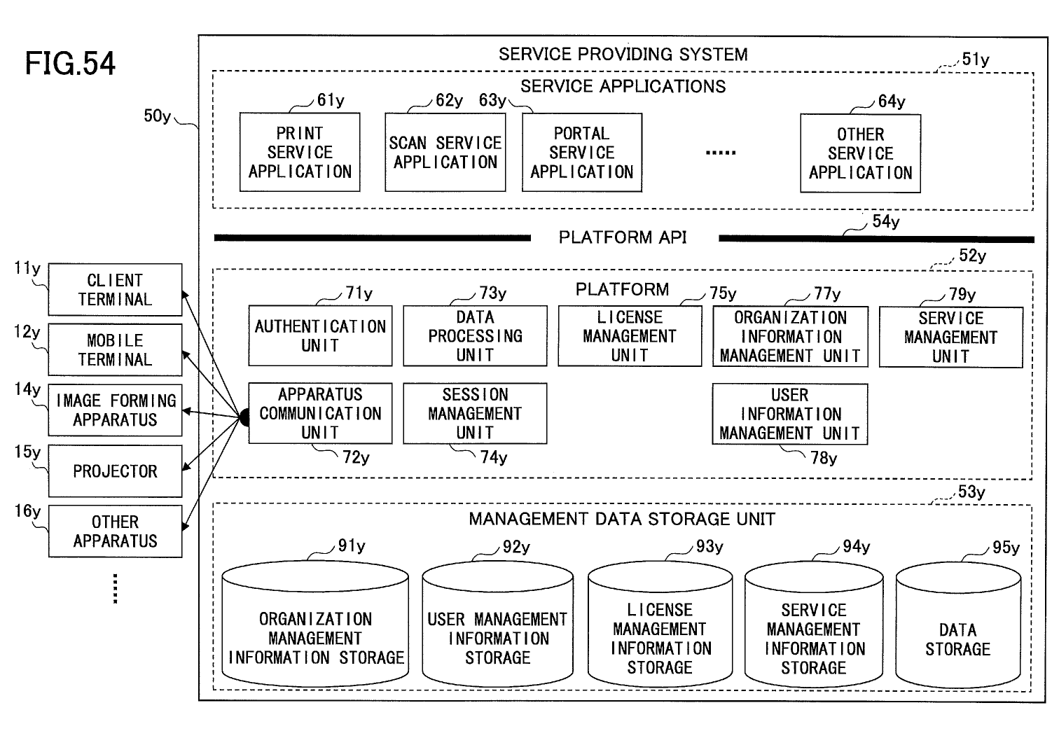

The service providing system of the third embodiment may include functional units (or processing blocks) as illustrated by FIG. 54. FIG. 54 is a block diagram illustrating an exemplary functional configuration of a service providing system 50y. The service providing system 50y of FIG. 54 implements service applications 51y, a platform 52y, a management data storage unit 53y, and a platform API (application programming interface) 54y by executing programs.

In the example of FIG. 54, the service applications 51y include a print service application 61y, a scan service application 62y, a portal service application 63y, and one or more other service applications 64y (which are hereafter expressed in the singular form for brevity). The print service application 61y provides a print service. The scan service application 62y provides a scan service. The portal service application 63y provides a portal service. The other service application 64y provides any other service.

The platform API 54y is an interface that enables the service applications 51y such as the print service application 61y, the scan service application 62y, the portal service application 63y, and the other service application 64y to use the platform 52y. In other words, the platform API 54y is a predefined interface that enables the platform 52y to receive requests from the service applications 51y, and may be implemented by functions or classes. When the service providing system 50y is implemented by (or distributed to) multiple information processing apparatuses, a Web API that is accessible via a network may be used as the platform API 154y.

In the example of FIG. 54, the platform 52y includes an authentication unit 71y, an apparatus communication unit 72y, a data processing unit 73y, a session management unit 74y, a license management unit 75y, an organization information management unit 77y, a user information management unit 78y, and a service management unit 79y.

The authentication unit 71y performs authentication in response to a login request from office equipment such as the client terminal 11y. The “office equipment” is a generic term indicating any one of the client terminal 11y, the mobile terminal 12y, the image forming apparatus 14y, the projector 15y, and the other apparatus 16y.

The apparatus communication unit 72y communicates with the office equipment. The data processing unit 73y performs data processing in response to requests from the service applications 51y. The session management unit 74y manages sessions with the office equipment.

The license management unit 75y manages license management information. The organization information management unit 77x manages organization management information. The user information management unit 78y manages user management information. The service management unit 79y manages service management information.

The management data storage unit 53y includes, for example, an organization management information storage 91y, a user management information storage 92y, a license management information storage 93y, a service management information storage 94y, and a data storage 95y.

The organization management information storage 91y stores organization management information. The user management information storage 92y stores user management information. The license management information storage 93y stores license management information. The service management information storage 94y stores service management information. The data storage 95y stores other data.

The platform 52y includes common functions or basic functions that are common to and used by the multiple service applications 51y. In the third embodiment, the authentication unit 71y, the apparatus communication unit 72y, the data processing unit 73y, the session management unit 74y, the license management unit 75y, the organization information management unit 77y, the user information management unit 78y, and the service management unit 79y belong to the platform 52y. The functions of these units of the platform 52y are made public to the service applications 51y via the platform API 54y.

In other words, the service applications 51y can use the functions of these units that are made public by the platform API 54y. Services provided by the service providing system 50y may be used from the client terminal 11y, the mobile terminal 12y, the image forming apparatus 14y, and the projector 15y, and may also be used from other systems and apparatuses such as a conference system, an IC recorder, and a digital camera.

The classification of or the hierarchical relationship among the software components (or functional units) and the storages of the service providing system 50y illustrated by FIG. 54 is just an example, and such classification is not essential to implement the present embodiment. That is, as long as the office equipment such as the client terminal 11y, the mobile terminal 12y, the image forming apparatus 14y, and the projector 15y can be linked with the service applications 51y, the hierarchical relationship among the software components and the storages of the service providing system 50y may be determined freely.

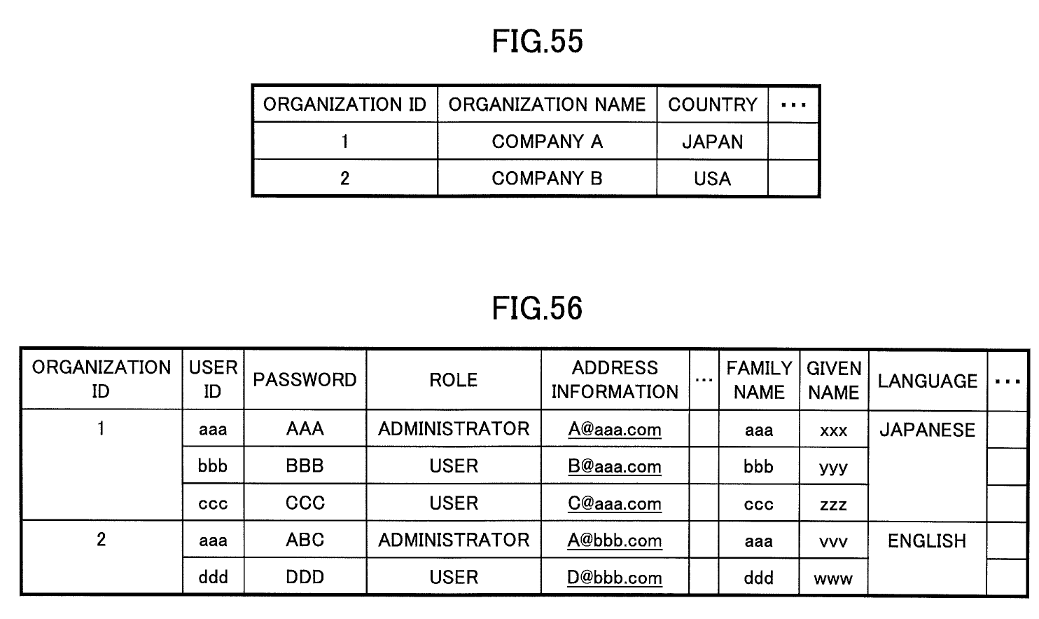

FIG. 55 is a table illustrating exemplary organization management information. The organization management information of FIG. 55 includes data items (or fields) such as an organization ID, an organization name, and a country. The organization ID is information for uniquely identifying a group such as a company or a department. The organization ID is not necessarily information for identifying an “organization”. For example, the organization ID may be information for identifying a contract. The organization name is a name of a group. The country indicates a country or a region where a service is used.

FIG. 56 is a table illustrating exemplary user management information. The user management information of FIG. 56 includes data items (or fields) such as an organization ID, a user ID, a password, a role, address information, a family name, a given name, and a language. In the user management information, records are grouped by (or associated with) organization IDs. The user ID and the password are used to identify a user at the service providing system 50y. The user ID may be represented by a user name. The password may be omitted.

Also, an electronic medium (e.g., an IC card) carried by the user may be used in place of the user ID. User IDs and passwords associated with the same organization ID are unique. On the other hand, the same user ID and password may be used for multiple users associated with different organization IDs. The role is information for identifying a “role” (e.g., administrator or end user) of the user. The address information indicates an email address of the user. One or more sets of address information may be contained in each record. The family name and the given name are those of the user. The language indicates a language used by the user.

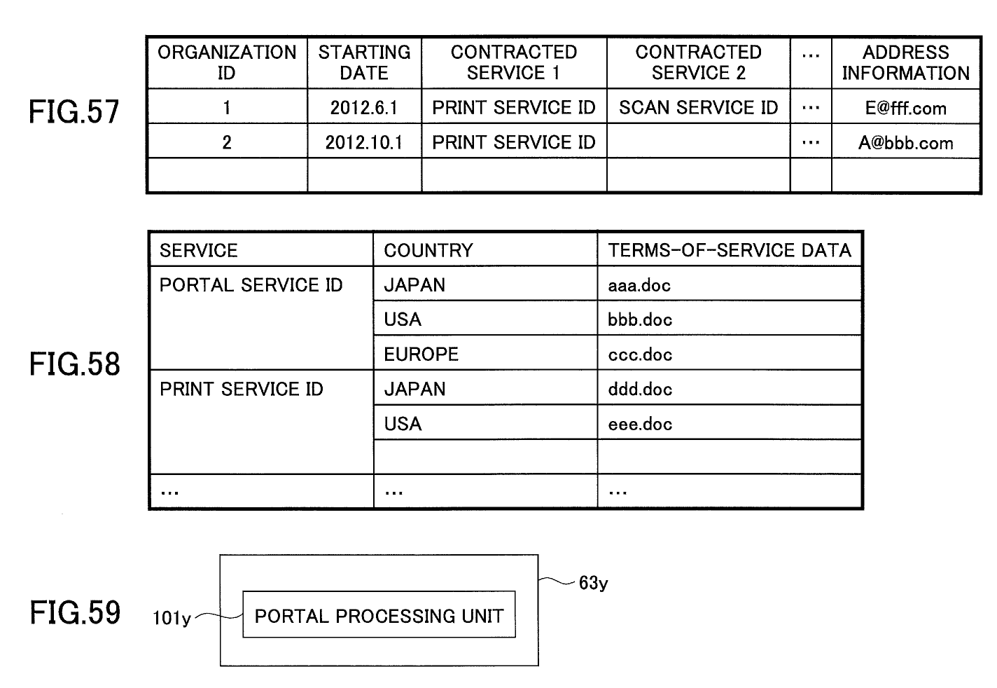

FIG. 57 is a table illustrating exemplary license management information. The license management information of FIG. 57 includes data items (or fields) such as an organization ID, a starting date, one or more contracted services, and address information.

The starting date indicates a date when use of a contracted service(s) is started. The contracted service is information for identifying a service that is contracted (or subscribed) and activated by the organization. The address information indicates an email address of the administrator of the organization.

FIG. 58 is a table illustrating exemplary service management information. The service management information of FIG. 58 includes data items (or fields) such as a service, a country, and terms-of-service data. Each record of the service management information of FIG. 58 contains a service, a country, and terms-of-service data that are associated with each other. The service field contains information such as a service ID or a service name for identifying a service. The country field contains a country or a region where a service is used. The terms-of-service data is used to display terms of service.

### [Portal Service Application]

The portal service application 63y may include a functional unit (or processing block) as illustrated by FIG. 59. FIG. 59 is a block diagram illustrating an exemplary functional configuration of the portal service application 63y. The portal service application 63y causes the computer system 500y to function as a portal processing unit 101y. The portal processing unit 101y performs processes related to the portal service. Processes performed by the portal processing unit 101x are described later.

<Processes Performed by System 1y>

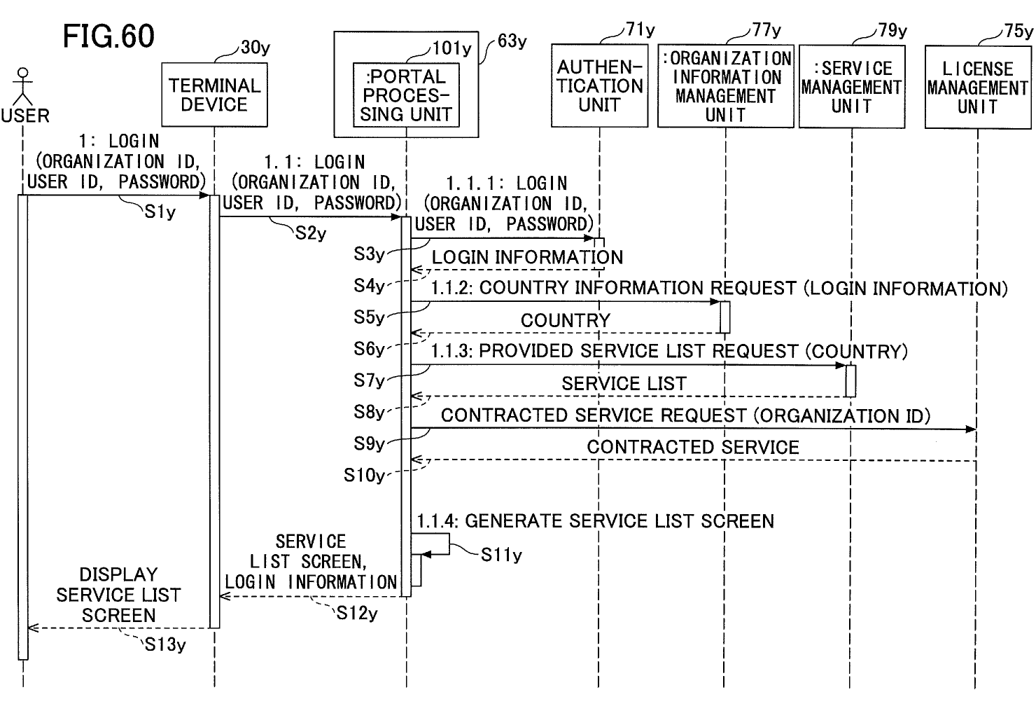

Exemplary processes performed by the system 1y are described below. Here, it is assumed that a user (e.g., administrator or end user) of an organization has made a contract with a sales company and can log into the service providing system 50. FIG. 60 is a sequence chart illustrating an exemplary process performed by the system 1y.

The user accesses a site of the service providing system 50y from the terminal device 30. Then, the portal processing unit 101y of the portal service application 63y requests the terminal device 30y to display a top screen 1000y.

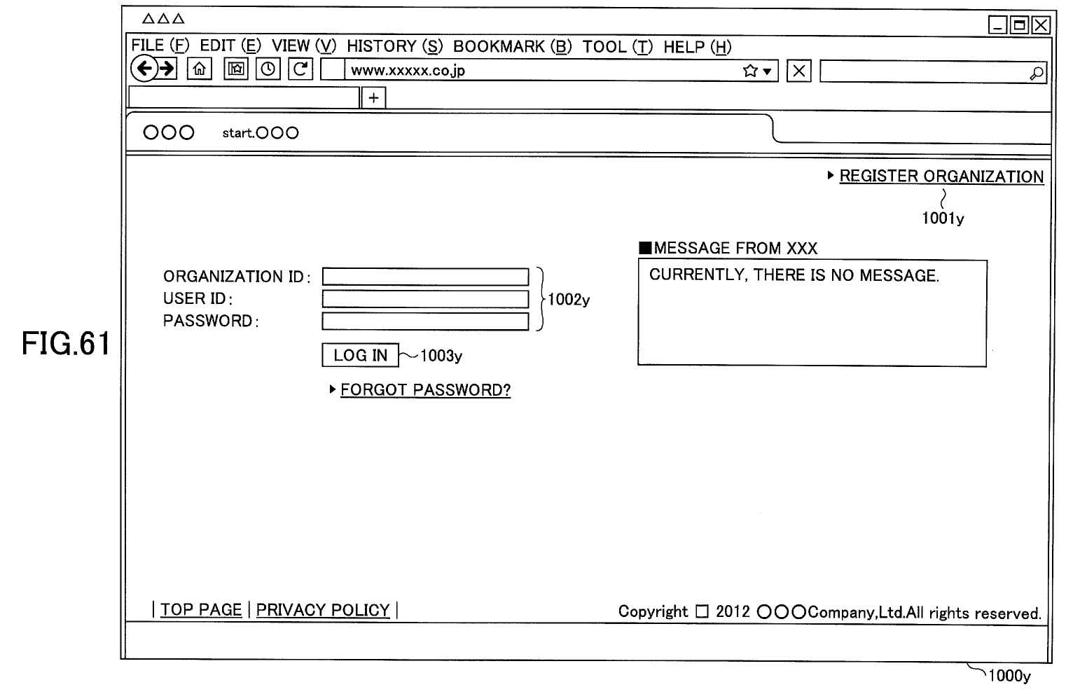

FIG. 61 is a drawing illustrating an exemplary top screen. The top screen 1000y includes an input field 1002y for entering an organization ID, a user ID, and a password used to log into the service providing system 50y (or the portal service), and a Login button 1003y. The display control unit 32y of the terminal device 30y displays the top screen 1000y on the display unit 502y.

At step S1y, the user operates the input unit 501y of the terminal device 30y to enter an organization ID, a user ID, and a password in the input field 1002y, and clicks (or selects) the Login button 1003y.

When the Login button 1003y on the top screen 1000y is clicked, the terminal device 30y, at step S2y, sends a login request including the organization ID, the user ID, and the password entered in the input field 1002y to the portal processing unit 101y of the portal service application 63y.

At step S3y, the portal processing unit 101y sends the organization ID, the user ID, and the password to the authentication unit 71y of the platform 52y to request a login process for the user. The authentication unit 71y determines that the login process is successful when the organization ID, the user ID, and the password are stored in associated with each other in the user management information of FIG. 56. Here, it is assumed that the login process has been successful, and the user who has successfully logged into the service providing system 50y is referred to as a “logged-in user”.

At step S4y, the authentication unit 71y sends login information indicating that the login process has been successful to the portal processing unit 101y of the portal service application 63y. The login information includes the organization ID, the user ID, and the password.

When the login process has been successful, the portal processing unit 101y, at step S5y, sends the login information to the organization information management unit 77y and thereby requests the organization information management unit 77y to obtain country information. The organization information management unit 77y reads, from the organization management information of FIG. 55, a country associated with the organization ID in the login information. At step S6y, the organization information management unit 77y sends the country read from the organization management information to the portal processing unit 101y as country information.

At step S7y, the portal processing unit 101y sends the country information to the service management unit 79y to request the service management unit 79y to obtain a list of services. The service management unit 79y reads, from the service management information of FIG. 58, a list of services (service list) associated with the country information received from the portal processing unit 101y. At step S8y, the service management unit 79y sends the service list read from the service management information to the portal processing unit 101y.

At step S9y, the portal processing unit 101y sends the organization ID in the login information to the license management unit 75y to request the license management unit 75y to obtain a list of contracted services. The service management unit 75y reads, from the license management information of FIG. 57, a list of contracted services (contracted service list) associated with the organization ID received from the portal processing unit 101y. At step S10y, the license management unit 75y sends the contracted service list read from the license management information to the portal processing unit 101y.

At step S11y, the portal processing unit 101y generates a service list screen including a list of services (available service list) available for the logged-in user based on the service list received from the service management unit 79y at step S8y and the contracted service list received from the license management unit 75y at step S10y.

The service list sent from the service management unit 79y indicates services provided in the country of the logged-in user. The contracted service list sent from the license management unit 75 indicates services available for the logged-in user according to a contract. With the service list received at step S8y and the contracted service list received at step S10y, the portal service processing unit 101 can generate, for example, a list of services that can be provided to the user (i.e., a list of services that are newly made available by making a contract) and a list of services that are already available for the user (i.e., a list of services for which a contract has already been made).

Services that are available for the logged-in user according to a contract may be provided for a fee or for free. For example, the available service list may include basic services that can be used for free by a user who purchased an apparatus and optional services that can be used for a fee by making a contract.

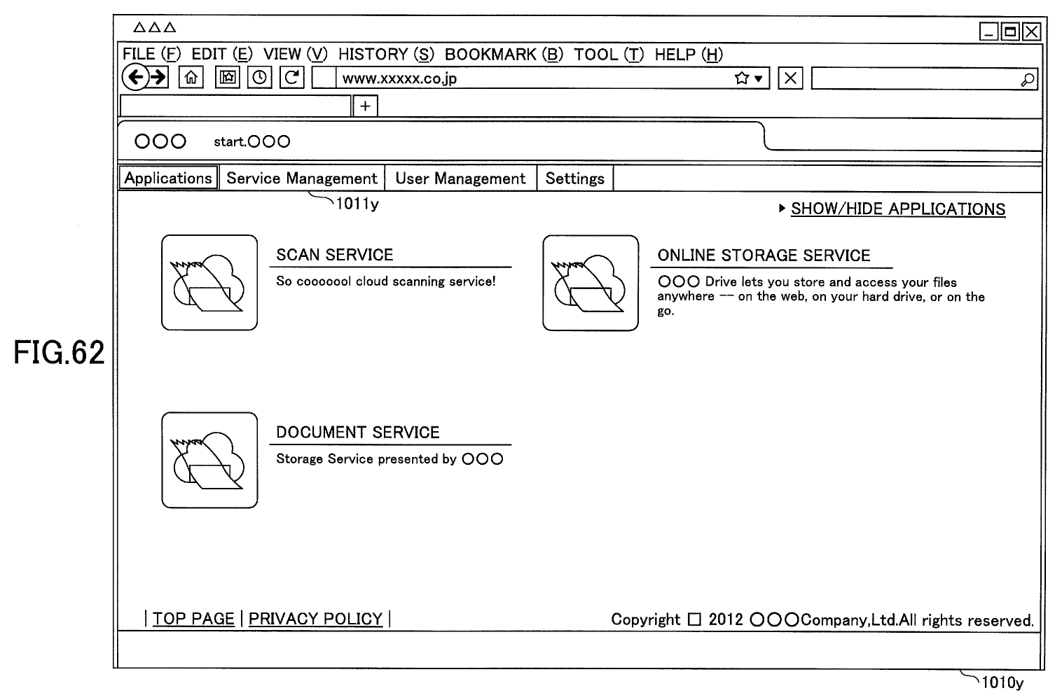

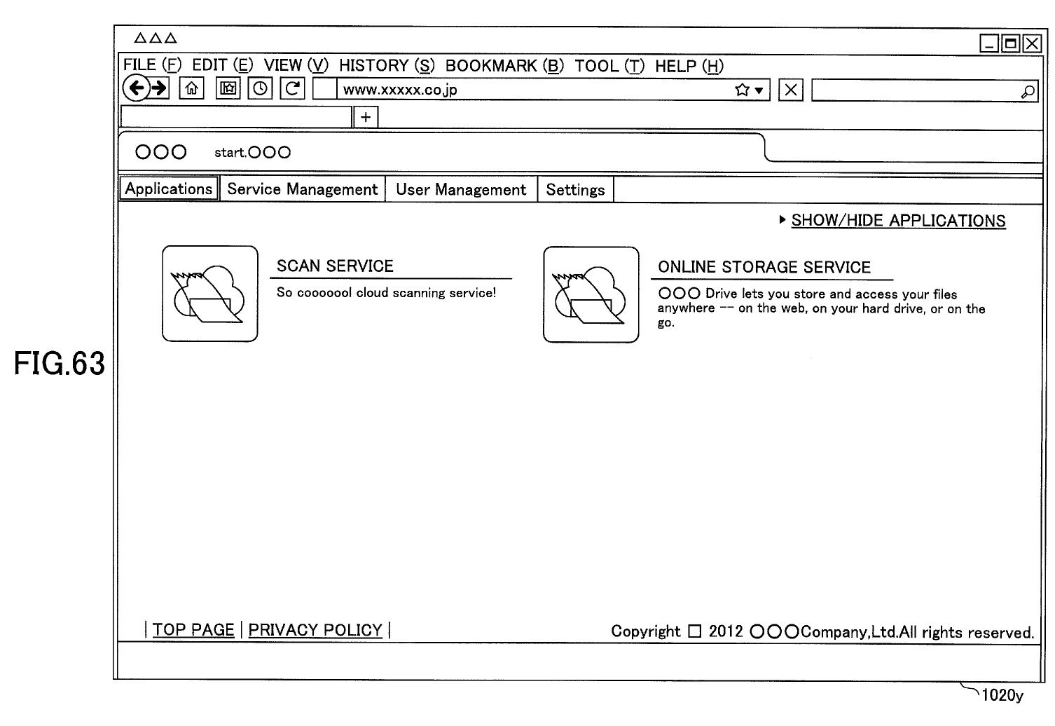

At step S12y, the portal processing unit 101y sends the login information to the terminal device 30y, and requests the terminal device 30y to display a service list screen At step S13y, the display control unit 32y of the terminal device 30y displays, for example, a service list screen 1010y illustrated by FIG. 62 or a service list screen 1020y illustrated by FIG. 63 on the display unit 502y.

FIG. 62 is a drawing illustrating an exemplary service list screen. FIG. 63 is a drawing illustrating another exemplary service list screen. The service list screen 1010y of FIG. 62 displays a scan service, an online storage service, and a document service as services available for the logged-in user. The service list screen 1020y of FIG. 63 displays a scan service and an online storage service as services available for the logged-in user. As exemplified by FIGS. 62 and 63, a service list displayed on a service list screen may vary depending on country information associated with a country of a logged-in user.

Thus, the system 1y of the third embodiment makes it possible to obtain country information associated with an organization of a logged-in user, and thereby makes it possible to provide services corresponding to the country associated with the organization. In other words, the third embodiment makes it possible to provide appropriate services to users even when different services are provided in different countries.

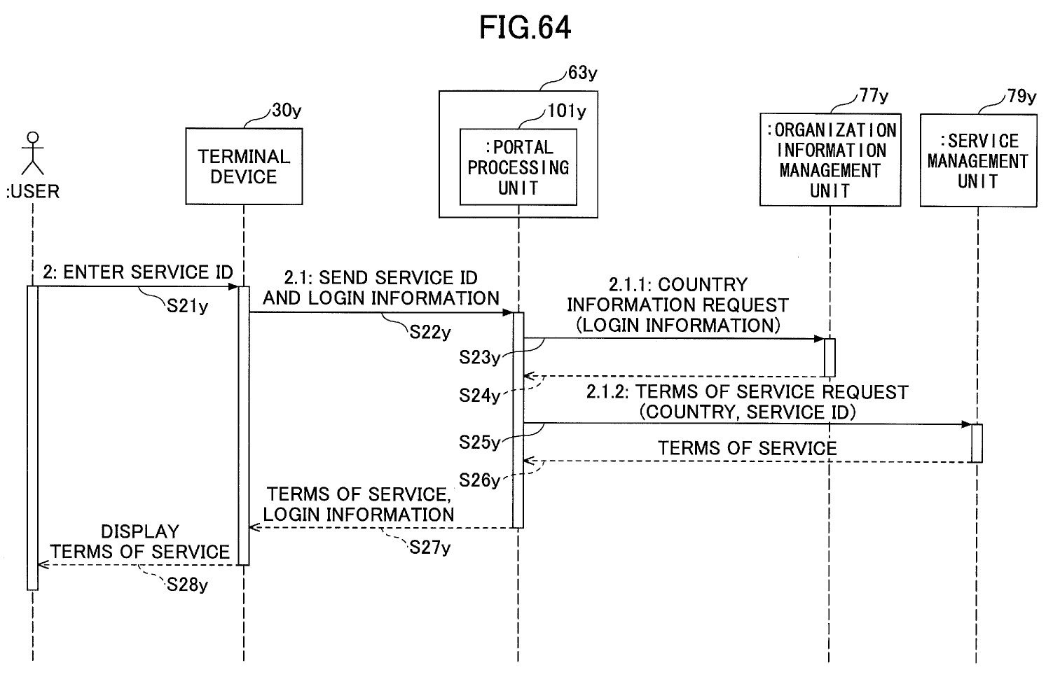

In the system 1y of the third embodiment, a contracted service is updated (e.g., extension of a contract period) as illustrated by FIG. 64. FIG. 64 is a sequence chart illustrating an exemplary process performed by the system 1y. Although a process of updating a contracted service is described below, a contracted service may be added in a similar manner.

To update a contracted service, an administrator logs into the service providing system 50y (or the portal service), and clicks a “Service Management” button 1011y on the service list screen 1010y of FIG. 62. Then, the portal processing unit 101y of the portal service application 63y requests the terminal device 30y to display a contracted service update screen 1030y.

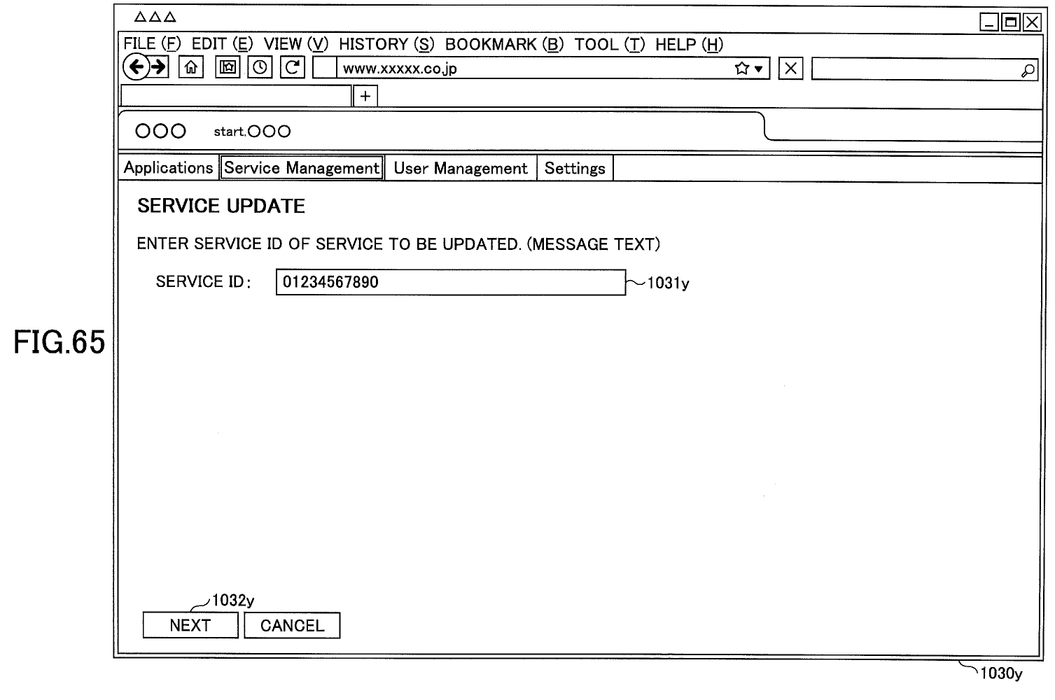

FIG. 65 is a drawing illustrating an exemplary contracted service update screen. The contracted service update screen 1030y includes an input field 1031y for entering a service ID necessary to update a contracted service. The display control unit 32y of the terminal device 30y displays the contracted service update screen 1030y on the display unit 502y.

At step S21y, the administrator operates the input unit 501y of the terminal device 30y to enter a service ID, which is necessary to update a contracted service, in the input field 1031y, and clicks a Next button 1032y. The service ID may be identification information for uniquely identifying the contracted service, or information indicating that an update contract for the contracted has been made with a sales company.

When the Next button 1032y on the contracted service update screen 1030y is clicked, the terminal device 30y, at step S22y, sends the service ID entered in the input field 1031y and the login information received at step S12y to the portal processing unit 101y of the portal service application 63y and thereby requests the portal processing unit 101y to update the contracted service.

At step S23y, the portal processing unit 101y sends the login information to the organization information management unit 77y and thereby requests the organization information management unit 77y to obtain country information. The organization information management unit 77y reads, from the organization management information of FIG. 55, a country associated with the organization ID in the login information. At step S24y, the organization information management unit 77y sends the country read from the organization management information to the portal processing unit 101y as country information.

At step S25y, the portal processing unit 101y sends, to the service management unit 79y, the service ID received at step S22y from the terminal device 30y and the country information received at step 24y from the organization information management unit 77y, and thereby requests the service management unit 79y to obtain terms of service.

The service management unit 79y reads, from the service management information of FIG. 58, terms of service (terms-of-service data) associated with the service ID (service) and the country information (country) received from the portal processing unit 101y. At step S26y, the service management unit 79y sends the terms-of-service data read from the service management information to the portal processing unit 101y.

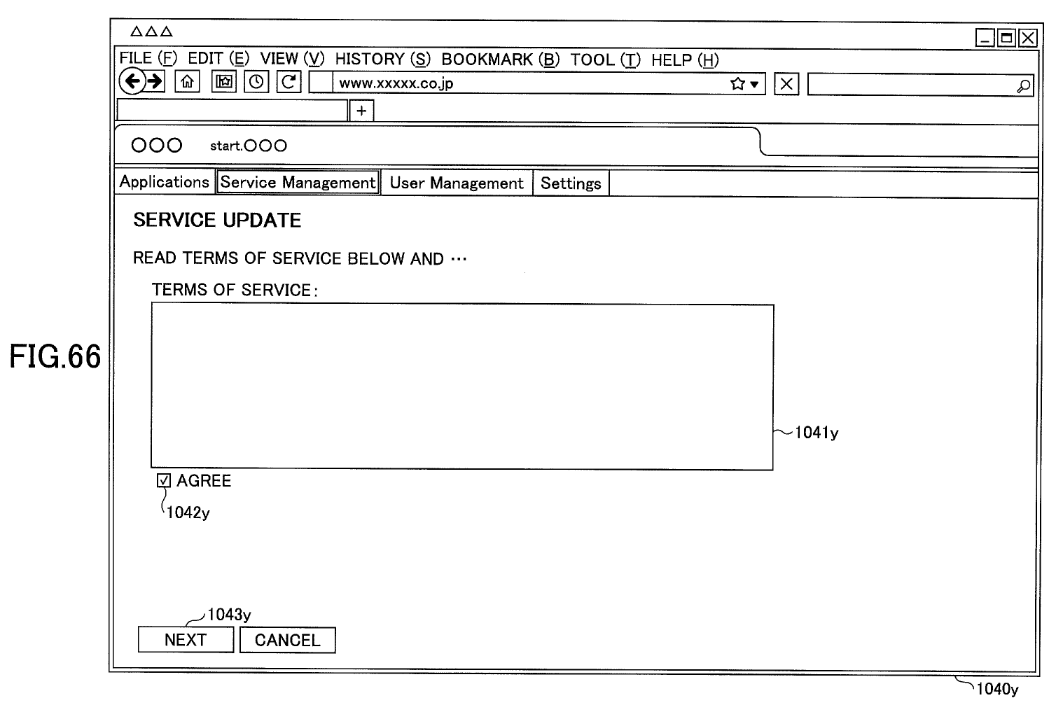

At step S27y, the portal processing unit 101y requests the terminal device 30y to display a terms-of-service screen 1040y as illustrated by FIG. 66. At step S28y, the display control unit 32y of the terminal device 30y displays, on the display unit 502y, the terms-of-service screen 1040y on which the terms of service corresponding to the service and the country are displayed in a terms-of-service field 1041y.

FIG. 66 is a drawing illustrating an exemplary terms-of-service screen. The terms-of-service screen 1040y includes the terms-of-service field 1041y for displaying terms of service, a check box 1042y used to indicate agreement to the terms of service, and a Next button 1043y to display a next screen. The administrator confirms the terms of service displayed in the terms-of-service field 1041y.

The administrator selects the check box 1042y to indicate agreement to the terms of service and presses the Next button 1043y to display a next screen. After the administrator presses the Next button 1043y on the terms-of-service screen 1040y, the license management unit 75y of the service providing system 50y activates (or validates) the contracted service by registering, in the license management information, the service ID entered on the contracted service update screen 1030y and the organization ID associated with the administrator such that they are associated with each other.

Thus, the system 1y of the third embodiment makes it possible to obtain country information associated with an organization of a logged-in user, and thereby makes it possible to display terms of service corresponding to a service to be provided and a country associated with an organization of the logged-in user. In other words, the third embodiment makes it possible to display appropriate terms of service even when different services are provided in different countries.

### SUMMARY

According to the system 1y of the third embodiment, it is possible to change services to be provided and terms of service to be displayed based on a country associated with an organization of a logged-in user. This in turn makes it possible to use the common top screen 1000y regardless of the country of a user. Thus, the system 1y of the third embodiment makes it possible to efficiently provide global services.

The organization ID is an example of organization identification information. The organization identification information may not necessarily be information for identifying an “organization”, and may be information for identifying a group such as a department or information for identifying a contract. The country information is an example of region identification information for identifying a region such as a country, a local area, or a community or union including multiple countries.

The third embodiment may be applied to a case where it is desired to provide different services to countries or regions with different legal systems. In other words, the third embodiment makes it possible to provide appropriate services to respective regions. More specifically, the third embodiment makes it possible to provide services that meet the needs of respective countries and regions, in addition to or in combination with common services (e.g., a scan service, a print service, an apparatus management service, etc.) that are provided globally.

For example, even when a “scan-to-storage” service (a variation of a scan service) for storing a scanned image in an online storage (destination storage) is commonly known in multiple countries and can be provided in those countries, types of storages that can be used as the destination storage may be limited in some countries or regions. For example, there may be a case where a storage A can be used as a destination storage in a country, but the storage A cannot be used as a destination storage in another country.

Also, the third embodiment may be applicable to a case where rules for handling personal information and protecting privacy are different in countries where contracts are made. For example, when providing a service that uses personal information to an organization or a user in a country, it is necessary to make a contract based on terms of service including rules for handling personal information that match the legal system of the country. The third embodiment makes it possible to provide (or display) appropriate terms of service and thereby makes it possible to properly make a contract.

In the present application, the organization management information storage 91y may be referred to as a “first storage”, the service management information storage 94y may be referred to as a “second storage”, and the license management information storage 93y may be referred to as a “third storage”.

An aspect of this disclosure provides an information processing apparatus, a system, and an information providing method make it possible to efficiently provide services.

An aspect of this disclosure provides an information processing apparatus for providing a service to a device connected via a network to the information processing apparatus. The information processing apparatus may include a first reception unit that receives at least organization identification information; an organization information management unit that obtains region identification information associated with the received organization identification information from a first storage storing the organization identification information and the region identification information in association with each other; a service management unit that obtains first service information indicating services associated with the obtained region identification information from a second storage storing the region identification information and the first service information in association with each other; and a providing unit that provides the obtained first service information to the device.

The information processing apparatus may also include a second reception unit that receives a request to update or add the service. The request includes the organization identification information and the service information. When the request is received, the service management unit obtains terms-of-service data associated with the obtained region identification information and the service information in the request from the second storage, and the providing unit provides the obtained terms-of-service data to the device.

The information processing apparatus may also include a license management unit that obtains second service information indicating services available for an organization corresponding to the organization identification information from a third storage storing the organization identification information and the second service information in association with each other. The providing unit provides third service information based on the first service information and the second service information to the device.

The providing unit may be configured to provide screen data for displaying a screen including the third service information to the device being operated by a user.

The providing unit may be configured to provide screen data for displaying a screen including the terms-of-service data to the device being operated by a user.

An aspect of this disclosure provides system including a device that uses a service and an information processing apparatus that is connected via a network to the device and provides the service to the device. The information processing apparatus may include a first reception unit that receives at least organization identification information; an organization information management unit that obtains region identification information associated with the received organization identification information from a first storage storing the organization identification information and the region identification information in association with each other; a service management unit that obtains first service information indicating services associated with the obtained region identification information from a second storage storing the region identification information and the first service information in association with each other; and a providing unit that provides the obtained first service information to the device. The device may include a transmission unit that transmits the organization identification information to the information processing apparatus, and a display control unit that displays the first service information provided by the information processing apparatus.

An aspect of this disclosure provides a method performed by an information processing apparatus that provides a service to a device connected via a network to the information processing apparatus. The method may include receiving at least organization identification information; obtaining region identification information associated with the received organization identification information from a first storage storing the organization identification information and the region identification information in association with each other; obtaining first service information indicating services associated with the obtained region identification information from a second storage storing the region identification information and the first service information in association with each other; and providing the obtained first service information to the device.

The present invention is not limited to the specifically disclosed embodiments, and variations and modifications may be made without departing from the scope of the present invention.

What is claimed is:

1. An information processing apparatus that provides one or more services linked with one or more apparatuses connected via a network with the information processing apparatus, the information processing apparatus comprising:
a first storage that stores region identifiers identifying regions where the one or more services are received in association with organization identifiers identifying organizations;
a second storage that stores terms-of-service data in association with respective combinations of service identifiers identifying the one or more services and the region identifiers;
a receiver that receives one of the service identifiers in response to an operation performed by a user on a screen displayed on an operation terminal; and
a transmitter that transmits, to the operation terminal, a screen that displays terms of service based on the terms-of-service data stored in the second storage in association with the one of the service identifiers received by the receiver and one of the organization identifiers identifying an organization to which the user belongs.

2. A method performed by an information processing apparatus that provides one or more services linked with one or more apparatuses connected via a network with the information processing apparatus, the method comprising:
storing, in a first storage, region identifiers identifying regions where the one or more services are received in association with organization identifiers identifying organizations;
storing, in a second storage, terms-of-service data in association with respective combinations of service identifiers identifying the one or more services and the region identifiers;
receiving one of the service identifiers in response to an operation performed by a user on a screen displayed on an operation terminal; and
transmitting, to the operation terminal, a screen that displays terms of service based on the terms-of-service data stored in the second storage in association with the received one of the service identifiers and one of the organization identifiers identifying an organization to which the user belongs.

3. A non-transitory computer-readable storage medium storing a program for causing an information processing apparatus, which provides one or more services linked with one or more apparatuses connected via a network with the information processing apparatus, to execute a process, the process comprising:
storing, in a first storage, region identifiers identifying regions where the one or more services are received in association with organization identifiers identifying organizations;
storing, in a second storage, terms-of-service data in association with respective combinations of service identifiers identifying the one or more services and the region identifiers;
receiving one of the service identifiers in response to an operation performed by a user on a screen displayed on an operation terminal; and
transmitting, to the operation terminal, a screen that displays terms of service based on the terms-of-service data stored in the second storage in association with the received one of the service identifiers and one of the organization identifiers identifying an organization to which the user belongs.
